(19) United States
(12) Patent Application Publication
(10) Pub. No.: US 2025/0226574 A1
(43) Pub. Date: Jul. 10, 2025

(54) ANTENNA ASSEMBLY FOR A VEHICLE AND A WINDOW ASSEMBLY INCLUDING THE SAME

(71) Applicant: AGC Automotive Americas Co., Alpharetta, GA (US)

(72) Inventors: Abdelhalim Mohamed, Canton, MI (US); Frederick Maurice Schaible, III, Ann Arbor, MI (US)

(21) Appl. No.: 18/404,477

(22) Filed: Jan. 4, 2024

(51) Int. Cl. H01Q 1/32; H01Q 9/04; H01Q 21/24

(52) U.S. Cl. CPC H01Q 1/325; H01Q 9/0414; H01Q 9/0428; H01Q 21/24

(57) ABSTRACT

An antenna assembly for a vehicle includes a PCB and a ground plane disposed on a top surface of the PCB. The antenna assembly further includes a patch antenna stack including a first dielectric operatively connected to the ground plane and a first patch conductor operatively connected to the first dielectric to transmit and/or receive radio frequency signals having circular polarization in a first direction. The patch antenna stack also includes a second dielectric operatively connected to the first patch conductor and a second patch conductor operatively connected to the second dielectric to transmit and/or receive radio frequency signals having circular polarization in a second direction opposite the first direction. The antenna assembly further includes a radiating element configured to be energized to transmit and/or receive radio frequency signals having linear polarization.

### TECHNICAL FIELD

The present disclosure relates generally to antenna assemblies for vehicles. More specifically, the present disclosure relates to antenna assemblies configured to transmit and/or receive radio frequency signals having circular polarization and linear polarization.

### BACKGROUND

Shark fin antenna assemblies are traditionally mounted on vehicle roofs for facilitating wireless communication via networks such as Global Positioning System (GPS), Satellite Digital Audio Radio Services (SDARS), 4G LTE, and the like. However, the demand for shark fin antenna assemblies is decreasing due to aesthetic concerns and the increasing popularity of transparent roofs in vehicles. Therefore, there is a need in the art for improved arrangements of antennas in vehicles.

### SUMMARY

One general aspect of the present disclosure includes an antenna assembly for a vehicle. The antenna assembly includes a PCB including a top surface and a bottom surface opposite the top surface. The antenna assembly also includes a ground plane disposed on the top surface of the PCB. The antenna assembly further includes a patch antenna stack. The patch antenna stack includes a first dielectric extending between a first dielectric surface operatively connected to the ground plane and a second dielectric surface opposite the first dielectric surface, and a first patch conductor operatively connected to the second dielectric surface of the first dielectric. The first patch conductor is configured to be energized to transmit and/or receive radio frequency signals having a first frequency with a first wavelength λ₁ and having circular polarization in a first direction. The patch antenna stack also includes a second dielectric extending between a third dielectric surface operatively connected to the first patch conductor and a fourth dielectric surface opposite the third dielectric surface, and a second patch conductor operatively connected to fourth dielectric surface of the second dielectric. The second patch conductor is configured to be energized to transmit and/or receive radio frequency signals having a second frequency with a second wavelength λ₂, higher than the first frequency, and having circular polarization in a second direction opposite the first direction. The antenna assembly further includes a monopole radiating element including a first portion extending perpendicularly from the ground plane. The monopole radiating element is configured to be energized to transmit and/or receive radio frequency signals having linear polarization. The antenna assembly additionally includes a first feeding assembly operatively connected to the first patch conductor at a first feeding point and the second patch conductor at a second feeding point for energizing the first patch conductor and the second patch conductor to transmit and/or receive radio frequency signals. The antenna assembly also includes a second feeding assembly operatively connected to the monopole radiating element at a third feeding point for energizing the monopole radiating element to transmit and/or receive radio frequency signals. The second feeding point is spaced from the third feeding point by at least λ₂/2.

Another general aspect of the present disclosure includes an antenna assembly for a vehicle. The antenna assembly includes a PCB including a top surface and a bottom surface opposite the top surface. The antenna assembly also includes a ground plane disposed on the top surface of the PCB and having a width W and a length L. The antenna assembly further includes a patch antenna stack. The patch antenna stack includes a first dielectric extending between a first dielectric surface operatively connected to the ground plane and a second dielectric surface opposite the first dielectric surface, and a first patch conductor operatively connected to the second dielectric surface of the first dielectric. The first patch conductor is configured to be energized to transmit and/or receive radio frequency signals having a first frequency with a first wavelength λ₁ and having a circular polarization in a first direction. The patch antenna stack also includes a second dielectric extending between a third dielectric surface operatively connected to the first patch conductor and a fourth dielectric surface opposite the third dielectric surface, and a second patch conductor operatively connected to fourth dielectric surface of the second dielectric. The second patch conductor is configured to be energized to transmit and/or receive radio frequency signals having a second frequency with a second wavelength λ₂, higher than the first frequency, and having a circular polarization in a second direction opposite the first direction. The antenna assembly additionally includes a monopole radiating element including a first portion extending perpendicularly from the ground plane. The monopole radiating element configured to be energized to transmit and/or receive radio frequency signals having a linear polarization. The width W and the length L of the ground plane are each independently at least λ₁/2.

Yet another general aspect of the present disclosure includes an antenna assembly for a vehicle. The antenna assembly includes a PCB including a top surface and a bottom surface opposite the top surface. The antenna assembly also includes a ground plane disposed on the top surface of the PCB. The antenna assembly further includes a patch antenna stack. The patch antenna stack includes a first dielectric extending between a first dielectric surface operatively connected to the ground plane and a second dielectric surface opposite the first dielectric surface, and a first patch conductor operatively connected to the second dielectric surface of the first dielectric. The first patch conductor is configured to be energized to transmit and/or receive radio frequency signals having a first frequency and having a circular polarization in a first direction. The patch antenna stack also includes a second dielectric extending between a third dielectric surface operatively connected to the first patch conductor and a fourth dielectric surface opposite the third dielectric surface, and a second patch conductor operatively connected to fourth dielectric surface of the second dielectric. The second patch conductor is configured to be energized to transmit and/or receive radio frequency signals having a second frequency, higher than the first frequency, and having a circular polarization in a second direction opposite the first direction. The antenna assembly additionally includes a monopole radiating element including a first portion extending perpendicularly from the ground plane and a second portion coupled to and extending from the first portion and spaced from the ground plane. The monopole radiating element is configured to be energized to transmit and/or receive radio frequency signals having a linear polarization.

A further general aspect of the present disclosure includes a window assembly for a vehicle. The window assembly includes a nonconductive pane and an antenna assembly. The antenna assembly includes a PCB spaced from the nonconductive pane and including a top surface at least partially facing the nonconductive pane and a bottom surface opposite the top surface. The antenna assembly also includes a ground plane disposed on the top surface of the PCB. The antenna assembly further includes a patch antenna stack. The patch antenna stack includes a first dielectric extending between a first dielectric surface operatively connected to the ground plane and a second dielectric surface opposite the first dielectric surface, and a first patch conductor operatively connected to the second dielectric surface of the first dielectric. The first patch conductor is configured to be energized to transmit and/or receive radio frequency signals having a first frequency and having a circular polarization in a first direction. The patch antenna stack also includes a second dielectric extending between a third dielectric surface operatively connected to the first patch conductor and a fourth dielectric surface opposite the third dielectric surface, and a second patch conductor operatively connected to fourth dielectric surface of the second dielectric. The second patch conductor is configured to be energized to transmit and/or receive radio frequency signals having a second frequency, higher than the first frequency, and having a circular polarization in a second direction opposite the first direction. The antenna assembly additionally includes a monopole radiating element including a first portion extending perpendicularly from the ground plane toward the nonconductive pane. The monopole radiating element is configured to be energized to transmit and/or receive radio frequency signals having a linear polarization.

A further general aspect of the present disclosure includes an antenna assembly for a vehicle. The antenna assembly includes a housing defining a housing interior bounded by a bottom wall, a top wall parallel to and spaced from the bottom wall, and a plurality of side walls extending between the bottom wall and the top wall. The assembly also includes a PCB disposed within the housing interior and including a top surface at least partially facing the top wall of the housing and a bottom surface opposite the top surface. The antenna assembly also includes a ground plane disposed on the top surface of the PCB. The antenna assembly further includes a patch antenna stack. The patch antenna stack includes a first dielectric extending between a first dielectric surface operatively connected to the ground plane and a second dielectric surface opposite the first dielectric surface, and a first patch conductor operatively connected to the second dielectric surface of the first dielectric. The first patch conductor is configured to be energized to transmit and/or receive radio frequency signals having a first frequency with a first wavelength λ₁ and having a circular polarization in a first direction. The patch antenna stack also includes a second dielectric extending between a third dielectric surface operatively connected to the first patch conductor and a fourth dielectric surface opposite the third dielectric surface, and a second patch conductor operatively connected to fourth dielectric surface of the second dielectric. The second patch conductor is configured to be energized to transmit and/or receive radio frequency signals having a second frequency with a second wavelength λ₂, higher than the first frequency, and having a circular polarization in a second direction opposite the first direction. The antenna assembly additionally includes a dipole antenna element coupled to one of the side walls of the housing such that the dipole antenna element is arranged perpendicular to the ground plane. The dipole antenna element is configured to be energized to transmit and/or receive radio frequency signals having a linear polarization.

### BRIEF DESCRIPTION OF THE DRAWINGS

Advantages of the present disclosure will be readily appreciated as the same becomes better understood by reference to the following detailed description when considered in connection with the accompanying drawings.

FIG. 1 is a top perspective view of an antenna assembly according to a first embodiment of the present disclosure including a patch antenna stack and a monopole radiating element.

FIG. 2 is an exploded view of the antenna assembly of FIG. 1.

FIG. 3 is a top view of the antenna assembly of FIG. 1.

FIG. 4 is a partial cross-sectional view of the antenna assembly taken along line A-A of FIG. 3 illustrating a first feeding assembly for energizing the patch antenna stack.

FIG. 5 is an exploded view of the antenna assembly according to the first embodiment further including a spacer.

FIG. 6 is a partial cross-sectional view of the antenna assembly of FIG. 5 taken along line A-A of FIG. 3.

FIG. 7 is a top perspective view of an antenna assembly according to the first embodiment of the present disclosure where the monopole radiating element includes a second portion.

FIG. 8 is a partial cross-sectional view of the antenna assembly including a second feeding assembly for energizing the monopole radiating element.

FIG. 9 is a top perspective view of a housing for accommodating the antenna assembly according to the first embodiment of the present disclosure.

FIG. 10 is an exploded view of the housing and antenna assembly of FIG. 9.

FIG. 11 is a top view of the housing and antenna assembly of FIG. 9.

FIG. 12 is a cross-sectional view of the housing and antenna assembly taken along line B-B of FIG. 11.

FIG. 13 is a top schematic representation of a vehicle with the antenna assembly according to the first embodiment coupled to a nonconductive pane of the vehicle.

FIG. 14 is a partial schematic cross-sectional view taken along line C-C of FIG. 13, illustrating the antenna assembly coupled to the nonconductive pane of the vehicle.

FIG. 15 is a top schematic representation of a vehicle with the antenna assembly according to the first embodiment arranged below another nonconductive pane of the vehicle.

FIG. 16 is a partial schematic cross-sectional view taken along line D-D of FIG. 15, illustrating the antenna assembly arranged below a nonconductive pane of the vehicle.

FIG. 17 is a top perspective view of an antenna assembly according to a second embodiment of the present disclosure including a patch antenna stack and a monopole radiating element.

FIG. 18 is an exploded view of the antenna assembly of FIG. 17.

FIG. 19 is a top view of the antenna assembly of FIG. 17.

FIG. 20 is a partial cross-sectional view of the antenna assembly taken along line A-A of FIG. 19 illustrating a first feeding assembly for energizing the patch antenna stack.

FIG. 21 is an exploded view of the antenna assembly according to the second embodiment further including a spacer.

FIG. 22 is a partial cross-sectional view of the antenna assembly of FIG. 21 taken along line A-A of FIG. 19.

FIG. 23 is a top perspective view of an antenna assembly according to the second embodiment of the present disclosure where the monopole radiating element includes a second portion.

FIG. 24 is a partial cross-sectional view of the antenna assembly including a second feeding assembly for energizing the monopole radiating element.

FIG. 25 is a top perspective view of a housing for accommodating the antenna assembly according to the first embodiment of the present disclosure.

FIG. 26 is an exploded view of the housing and antenna assembly of FIG. 25.

FIG. 27 is a top view of the housing and antenna assembly of FIG. 25.

FIG. 28 is a cross-sectional view of the housing and antenna assembly taken along line B-B of FIG. 27.

FIG. 29 is a top schematic representation of a vehicle with the antenna assembly according to the second embodiment coupled to a nonconductive pane of the vehicle.

FIG. 30 is a partial schematic cross-sectional view taken along line C-C of FIG. 29, illustrating the antenna assembly coupled to the nonconductive pane of the vehicle.

FIG. 31 is a top schematic representation of a vehicle with the antenna assembly according to the second embodiment arranged below another nonconductive pane of the vehicle.

FIG. 32 is a partial schematic cross-sectional view taken along line D-D of FIG. 32, illustrating the antenna assembly arranged below a nonconductive pane of the vehicle.

FIG. 33 is a top perspective view of an antenna assembly according to a third embodiment of the present disclosure including a patch antenna stack and a monopole radiating element.

FIG. 34 is an exploded view of the antenna assembly of FIG. 33.

FIG. 35 is a top view of the antenna assembly of FIG. 33.

FIG. 36 is a partial cross-sectional view of the antenna assembly taken along line A-A of FIG. 35 illustrating a first feeding assembly for energizing the patch antenna stack.

FIG. 37 is an exploded view of the antenna assembly according to the third embodiment further including a spacer.

FIG. 38 is a partial cross-sectional view of the antenna assembly of FIG. 37 taken along line A-A of FIG. 35.

FIG. 39 is a partial cross-sectional view of the antenna assembly including a second feeding assembly for energizing the monopole radiating element.

FIG. 40 is a top perspective view of a housing for accommodating the antenna assembly according to the third embodiment of the present disclosure.

FIG. 41 is an exploded view of the housing and antenna assembly of FIG. 40.

FIG. 42 is a top view of the housing and antenna assembly of FIG. 40.

FIG. 43 is a cross-sectional view of the housing and antenna assembly taken along line B-B of FIG. 42.

FIG. 44 is a top schematic representation of a vehicle with the antenna assembly according to the third embodiment coupled to a nonconductive pane of the vehicle.

FIG. 45 is a partial schematic cross-sectional view taken along line C-C of FIG. 44, illustrating the antenna assembly coupled to the nonconductive pane of the vehicle.

FIG. 46 is a top schematic representation of a vehicle with the antenna assembly according to the third embodiment arranged below another nonconductive pane of the vehicle.

FIG. 47 is a partial schematic cross-sectional view taken along line D-D of FIG. 46, illustrating the antenna assembly arranged below a nonconductive pane of the vehicle.

FIG. 48 is a partially schematic cross-sectional view of a window assembly according to a fourth embodiment of the present disclosure, illustrating an antenna assembly arranged parallel to a nonconductive pane.

FIG. 49 is a partially schematic cross-sectional view of another window assembly according to the fourth embodiment of the present disclosure, illustrating an antenna assembly arranged non-parallel to a nonconductive pane.

FIG. 50 is a top perspective view of the antenna assembly according to the fourth embodiment of the present disclosure including a patch antenna stack and a monopole radiating element.

FIG. 51 is an exploded view of the antenna assembly of FIG. 50.

FIG. 52 is a top view of the antenna assembly of FIG. 50.

FIG. 53 is a partial cross-sectional view of the antenna assembly taken along line A-A of FIG. 52 illustrating a first feeding assembly for energizing the patch antenna stack.

FIG. 54 is an exploded view of the antenna assembly according to the fourth embodiment further including a spacer.

FIG. 55 is a partial cross-sectional view of the antenna assembly of FIG. 54 taken along line A-A of FIG. 52.

FIG. 56 is a top perspective view of an antenna assembly according to the fourth embodiment of the present disclosure where the monopole radiating element includes a second portion.

FIG. 57 is a partial cross-sectional view of the antenna assembly including a second feeding assembly for energizing the monopole radiating element.

FIG. 58 is a top perspective view of a housing for accommodating the antenna assembly according to the fourth embodiment of the present disclosure.

FIG. 59 is an exploded view of the housing and antenna assembly of FIG. 58.

FIG. 60 is a top view of the housing and antenna assembly of FIG. 58.

FIG. 61 is a cross-sectional view of the housing and antenna assembly taken along line B-B of FIG. 60.

FIG. 62 is a top schematic representation of a vehicle with the antenna assembly according to the fourth embodiment coupled to a nonconductive pane of the vehicle.

FIG. 63 is a partial schematic cross-sectional view taken along line C-C of FIG. 62, illustrating the antenna assembly coupled to the nonconductive pane of the vehicle.

FIG. 64 is a top schematic representation of a vehicle with the antenna assembly according to the fourth embodiment arranged below another nonconductive pane of the vehicle.

FIG. 65 is a partial schematic cross-sectional view taken along line D-D of FIG. 64, illustrating the antenna assembly arranged below a nonconductive pane of the vehicle.

FIG. 66 is a top perspective view of an antenna assembly according to a fifth embodiment of the present disclosure and including a housing, a patch antenna stack disposed within a housing interior, and a dipole radiating element disposed on one of the side walls of the housing.

FIG. 67 is a top view of the antenna assembly of FIG. 66.

FIG. 68 is a cross-sectional view of the antenna assembly according to the fifth embodiment of the present disclosure taken along line A-A of FIG. 67.

FIG. 69 is an exploded view of the antenna assembly according to the fifth embodiment of the present disclosure.

FIG. 70 is an exploded view of a PCB and patch antenna stack according to the fifth embodiment of the present disclosure.

FIG. 71 is a top view of the PCB and patch antenna stack according to the fifth embodiment of the present disclosure.

FIG. 72 is a partial cross-sectional view of the PCB and patch antenna stack of FIG. 71 taken along line B-B of FIG. 71.

FIG. 73 is an exploded view of the PCB and patch antenna stack according to the fifth embodiment further including a spacer.

FIG. 74 is a partial cross-sectional view of the PCB and patch antenna stack of FIG. 73 taken along line B-B of FIG. 71.

FIG. 75 is a top schematic representation of a vehicle with the antenna assembly according to the fifth embodiment coupled to a nonconductive pane of the vehicle.

FIG. 76 is a partial schematic cross-sectional view taken along line C-C of FIG. 75, illustrating the antenna assembly coupled to the nonconductive pane of the vehicle.

FIG. 77 is a top schematic representation of a vehicle with the antenna assembly according to the fifth embodiment arranged below another nonconductive pane of the vehicle.

FIG. 78 is a partial schematic cross-sectional view taken along line D-D of FIG. 77, illustrating the antenna assembly arranged below a nonconductive pane of the vehicle.

FIG. 79 is a graph illustrating gain performance over an exemplary frequency range of a first patch conductor according to representative embodiments of the present disclosure as compared with the performance of an industry standard shark fin antenna assembly.

FIG. 80 is a graph illustrating gain performance over an exemplary frequency range of a second patch conductor according to representative embodiments of the present disclosure as compared with the performance of an industry standard shark fin antenna assembly.

FIG. 81 is a graph illustrating gain performance over an exemplary frequency range of a radiating element according to representative embodiments of the present disclosure as compared with the performance of an industry standard shark fin antenna assembly.

### DETAILED DESCRIPTION

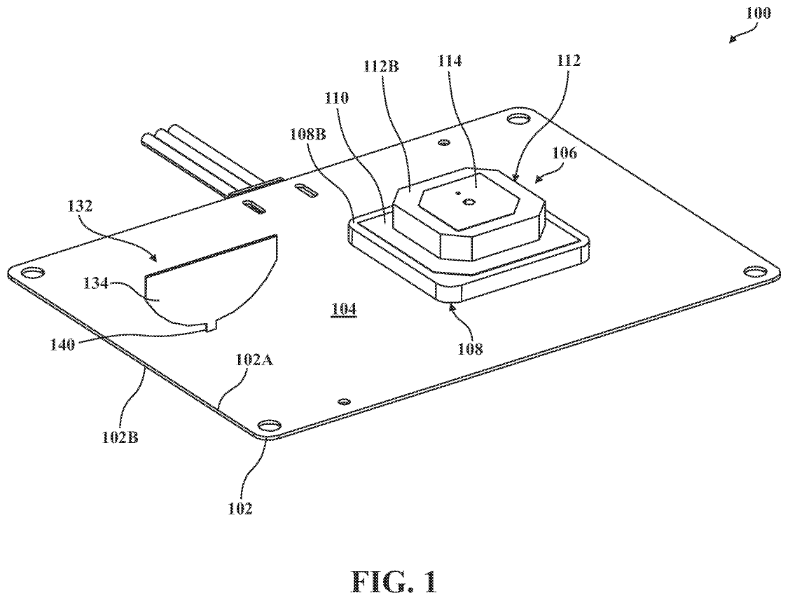

Referring to the drawings, wherein like reference numerals are used to identify like or identical components in the various views, FIGS. 1-78 illustrate various embodiments of antenna assemblies 100, 200, 300, 401, 500. The antenna assemblies 100, 200, 300, 401, 500 according to the present disclosure include a printed circuit board (hereinafter referred to as PCB 102, 202, 302, 402, 502) and a ground plane 104, 204, 304, 404, 504 disposed on a top surface of the PCB 102, 202, 302, 402, 502. The antenna assemblies 100, 200, 300, 401, 500 according to the present disclosure further include a patch antenna stack 106, 206, 306, 406, 506 including a first dielectric 108, 208, 308, 408, 508 operatively connected to the ground plane 104, 204, 304, 404, 504 and a first patch conductor 110, 210, 310, 410, 510 operatively connected to the first dielectric 108, 208, 308, 408, 508 to transmit and/or receive radio frequency signals having circular polarization in a first direction. The patch antenna stack 106, 206, 306, 406, 506 also includes a second dielectric 112, 212, 312, 412, 512 operatively connected to the first patch conductor 110, 210, 310, 410, 510 and a second patch conductor 114, 214, 314, 414, 514 operatively connected to the second dielectric 112, 212, 312, 412, 512 to transmit and/or receive radio frequency signals having circular polarization in a second direction opposite the first direction. The antenna assemblies 100, 200, 300, 401, 500 according to the present disclosure further include a radiating element 132, 232, 332, 432, 532 configured to be energized to transmit and/or receive radio frequency signals having linear polarization.

### First Embodiment

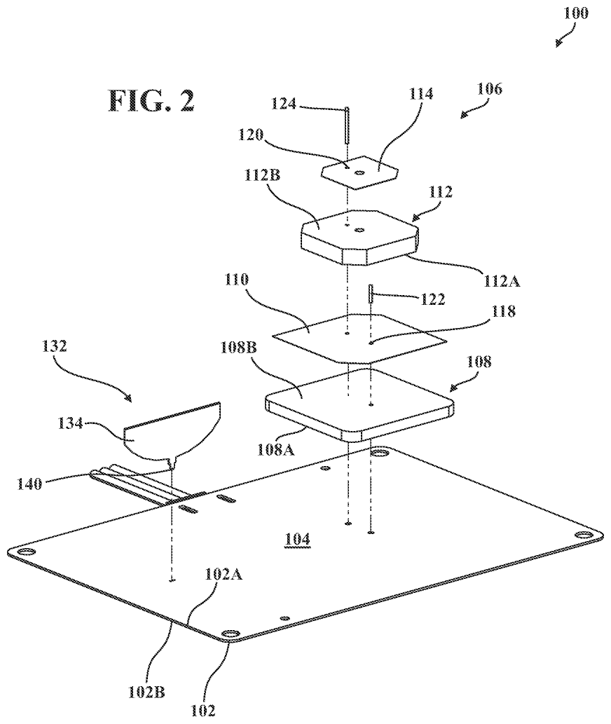

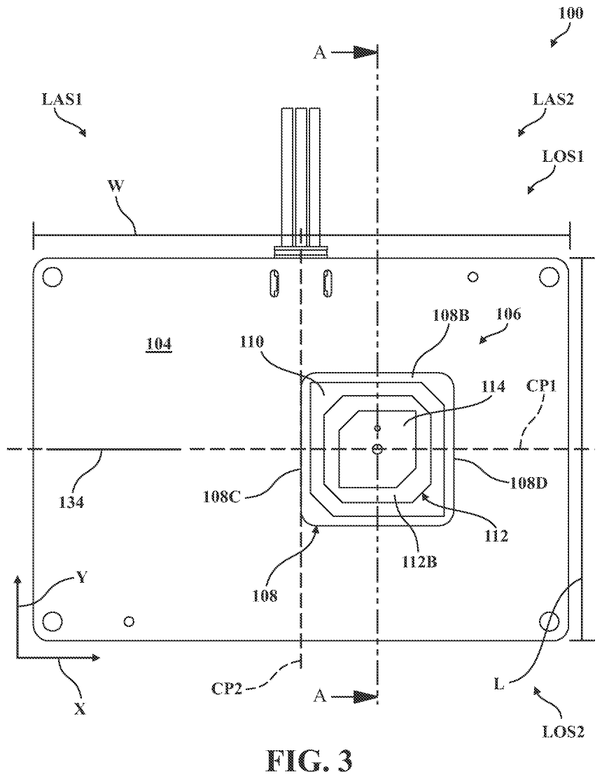

FIGS. 1-16 illustrate one embodiment of an antenna assembly 100 for a vehicle according to the present disclosure. Referring first to FIGS. 1-3, the antenna assembly 100 includes a PCB 102 including a top surface 102A and a bottom surface 102B opposite the top surface 102A. The PCB 102 typically includes one or more circuits configured to be arranged in electrical communication with the antenna assembly 100 to operate the antenna assembly 100 to transmit and/or receive radio frequency signals. The antenna assembly 100 also includes a ground plane 104 disposed on the top surface 102A of the PCB 102. Although not required, the ground plane 104 may comprise a metallization layer formed or disposed on the top surface 102A of the PCB 102. The metallization layer may comprise a copper foil or the like. The ground plane 104 may be generally rectangular in shape and have a width W in a lateral direction (X), and a length L in a longitudinal direction (Y) transverse to the lateral direction (X). Additionally, as best shown in FIG. 3, the ground plane 104 may define a first center plane CP1 bisecting the ground plane 104 in the lateral direction (X) and a second center plane CP2 bisecting the ground plane 104 in the longitudinal direction (Y).

As best shown in FIGS. 1-4, the antenna assembly 100 further includes a patch antenna stack 106. The patch antenna stack 106 includes a first dielectric 108 extending between a first dielectric surface 108A and a second dielectric surface 108B opposite the first dielectric surface 108A. The first dielectric surface 108A is operatively connected to the ground plane 104. For example, the first dielectric surface 108A may be operatively connected to the ground plane 104 by being directly or indirectly adhered or otherwise fixed to the ground plane 104. The first dielectric 108 may comprise a suitable dielectric material such as a ceramic material. The patch antenna stack 106 also includes a first patch conductor 110 operatively connected to the second dielectric surface 108B of the first dielectric 108. For example, first patch conductor 110 may be operatively connected to the second dielectric surface 108B by being directly or indirectly adhered or otherwise fixed to the second dielectric surface 108B. The first patch conductor 110 is configured to be energized to transmit and/or receive radio frequency signals having a first frequency with a first wavelength λ₁ and having circular polarization in a first direction. The first patch conductor 110 may comprise a conductive layer formed or disposed on the second dielectric surface 108B of the first dielectric 108. For example, the first patch conductor 110 may comprise a conductive foil. The first patch conductor 110 may be generally rectangular in shape with opposing corners cut to effect circular polarization, but other configurations are contemplated.

In some examples, the first frequency is from 1500 megahertz to 1650 megahertz. More specifically, the first frequency may be from 1550 megahertz to 1625 megahertz. Additionally, the first direction may be right-handed circular polarization (RHCP). Accordingly, the first patch conductor 110 may be configured to transmit and/or receive radio frequency signals on one or more Global Navigation Satellite Systems (GNSS) including, but not limited to, the United States's Global Positioning System (GPS), Russia's Global Navigation Satellite System (GLONASS), China's BeiDou Navigation Satellite System, the European Union's Galileo Satellite System, and Japan's Quasi-Zenith Satellite System (QZSS). Of course, left-handed circular polarization and/or other frequencies are contemplated.

With continued reference to FIGS. 1-4, the patch antenna stack 106 further includes a second dielectric 112 extending between a third dielectric surface 112A and a fourth dielectric surface 112B opposite the third dielectric surface 112A. The third dielectric surface 112A is operatively connected to the first patch conductor 110. For example, the third dielectric surface 112A may be operatively connected to the first patch conductor 110 by being directly or indirectly adhered or otherwise fixed to the first patch conductor 110. The second dielectric 112 may comprise a suitable dielectric material such as a ceramic material. The patch antenna stack 106 further includes a second patch conductor 114 operatively connected to the fourth dielectric surface 112B of the second dielectric 112. For example, the second patch conductor 114 may be operatively connected to the fourth dielectric surface 112B by being directly or indirectly adhered or otherwise fixed to the fourth dielectric surface 112B. The second patch conductor 114 is configured to be energized to transmit and/or receive radio frequency signals having a second frequency with a second wavelength λ₂, higher than the first frequency, and having circular polarization in a second direction opposite the first direction. The second patch conductor 114 may comprise a conductive layer formed or disposed on the fourth dielectric surface 112B of the second dielectric 112. For example, the second patch conductor 114 may comprise a conductive foil. The second patch conductor 114 may be generally rectangular in shape with opposing corners cut to effect circular polarization, but other configurations are contemplated.

In some examples, the second frequency is from 2250 megahertz to 2400 megahertz. More specifically, the second frequency may be from 2310 megahertz to 2360 megahertz. Even more specifically, the second frequency may be from 2320 megahertz to 2345 megahertz. Additionally, the first direction may be left-handed circular polarization (LHCP). Accordingly, the second patch conductor 114 may be configured to transmit and/or receive radio frequency signals on Satellite Digital Audio Radio Services (SDARS) including, but not limited to, Sirius Satellite Radio and XM Satellite Radio. Of course, right-handed circular polarization and/or other frequencies are contemplated.

Still referring to FIGS. 1-4, the antenna assembly 100 additionally includes a first feeding assembly 116 for energizing the first patch conductor 110 and the second patch conductor 114 to transmit and/or receive radio frequency signals. For example, the first feeding assembly 116 may arrange the first patch conductor 110 and the second patch conductor 114 in electrical communication with the one or more circuits of the PCB 102 to energize the first patch conductor 110 and the second patch conductor 114 to transmit and/or receive radio frequency signals. It should be appreciated that in other configurations the first feeding assembly 116 is arranged such that the first patch conductor 110 and the second patch conductor 114 are in electrical communication with other circuitry outside of the antenna assembly 100 to energize the first patch conductor 110 and the second patch conductor 114 to transmit and/or receive radio frequency signals. For example, each of the first patch conductor 110 and the second patch conductor 114 may be arranged in electrical communication with a central conductor of a respective coaxial cable, and a ground shield of each respective coaxial cable may be arranged in electrical communication with the ground plane 104.

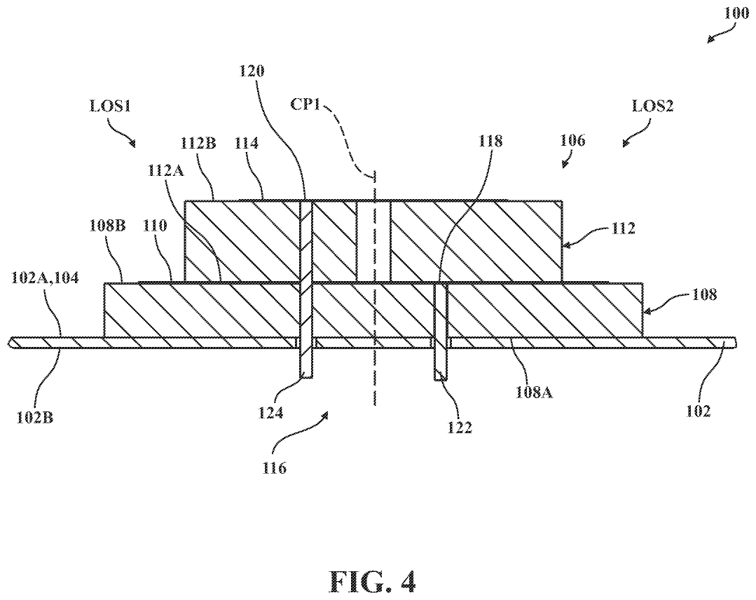

As best shown in FIG. 4, the first feeding assembly 116 is operatively connected to the first patch conductor 110 at a first feeding point 118 and to the second patch conductor 114 at a second feeding point 120. In some examples, such as shown in FIG. 4, the first feeding point 118 is arranged on a first longitudinal side LOS1 of the first center plane CP1, and the second feeding point 120 is arranged on a second longitudinal side LOS2 of the first center plane CP1, opposite the first longitudinal side LOS1. In this configuration, the first feeding assembly 116 includes a first feeding member 122 extending through the ground plane 104 and the first dielectric 108 such that the first feeding member 122 is coupled to the first patch conductor 110 at the first feeding point 118 to energize the first patch conductor 110 to transmit and/or receive radio frequency signals having the first frequency and having circular polarization in the first direction. Additionally, this configuration also includes a second feeding member 124 extending through the ground plane 104, the first dielectric 108, the first patch conductor 110, and the second dielectric 112 such that the second feeding member 124 is coupled to the second patch conductor 114 at the second feeding point 120 point to energize the second patch conductor 114 to transmit and/or receive radio frequency signals having the second frequency and having circular polarization in the second direction. Other configurations of operatively connecting the first feeding assembly 116 to the first patch conductor 110 at the first feeding point 118 and the second patch conductor 114 at the second feeding point 120 to energize the first patch conductor 110 and the second patch conductor 114 to transmit and/or receive radio frequency signals are contemplated.

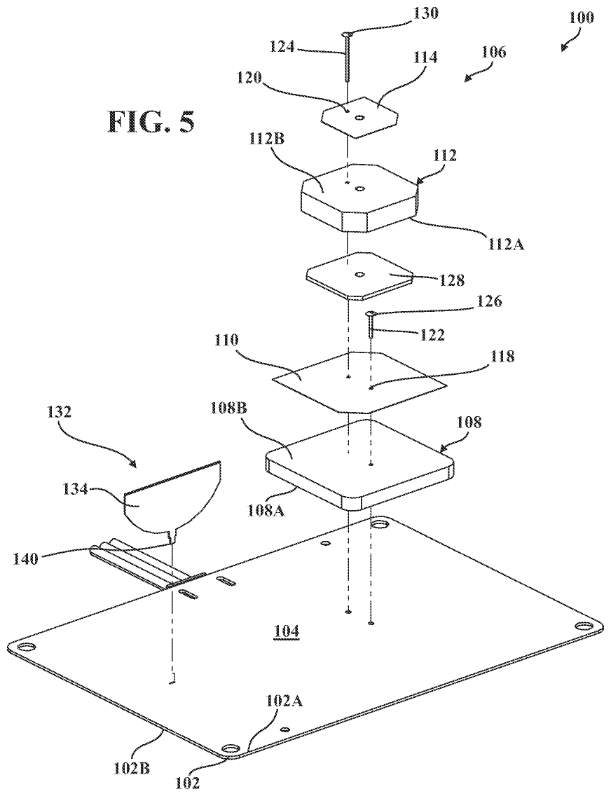

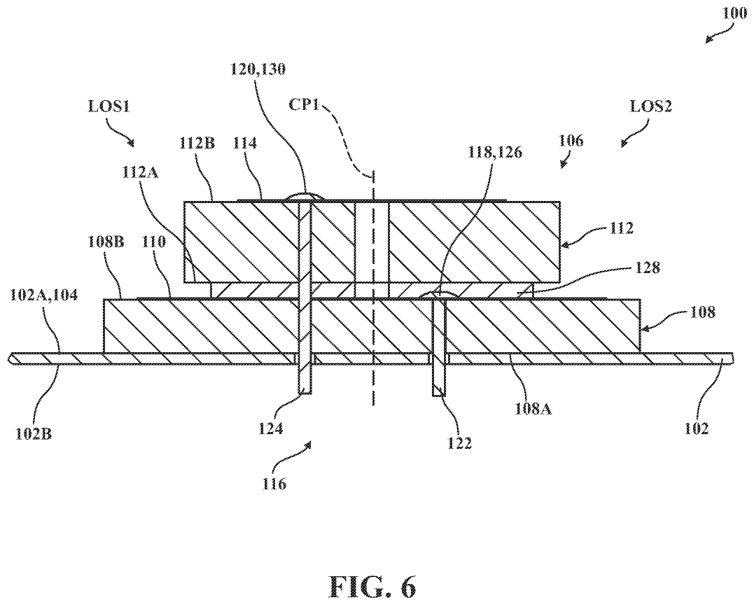

Referring to FIGS. 5 and 6, in some examples, the first feeding point 118 extends beyond the first patch conductor 110. For example, the first feeding point 118 as illustrated includes a first solder joint 126 operatively connecting the first feeding member 122 to the first patch conductor 110. In these examples, especially where the second dielectric 112 is a rigid material such as the ceramic material, the first solder joint 126 may cause the second dielectric 112 to be misaligned (i.e., not parallel) with the first patch conductor 110. Accordingly, the patch antenna stack 106 may further include a spacer 128 interposed between the first patch conductor 110 and the second dielectric 112. The spacer 128 is configured to deform (i.e., deflect) where the first feeding point 118 (particularly, the first solder joint 126) extends beyond the first patch conductor 110 such that the second dielectric 112 is arranged parallel to the first patch conductor 110. The spacer 128 may be comprised of a nonconductive material such as foam. The second feeding point 120 may similarly comprise a second solder joint 130 operatively connecting the second feeding member 124 to the second patch conductor 114. Other configurations of operatively connecting the first feeding member 122 to the first patch conductor 110 and the second feeding member 124 to the second patch conductor 114 are contemplated.

The antenna assembly 100 further includes a monopole radiating element 132 including a first portion 134 extending perpendicularly from the ground plane 104. The monopole radiating element 132 is configured to be energized to transmit and/or receive radio frequency signals having linear polarization. The monopole radiating element 132 may be configured to transmit and/or receive radio frequency signals having a frequency of from 600 megahertz to 6 gigahertz. Accordingly, the monopole radiating element 132 may be configured to transmit and/or receive radio frequency signals on 4G LTE, 5G sub-6 GHz networks, and any other current and future cellular networks falling within the 600 megahertz to 6 gigahertz frequency range. Other networks falling within the 600 megahertz to 6 gigahertz frequency range are also contemplated, such as V2X networks and Wi-Fi. The operative frequency of the monopole radiating element 132 may also be expressed as a third wavelength λ₃. In some examples, the monopole radiating element 132 has a height and/or width of less than of λ₃/4. To accommodate the large range of frequencies, the monopole radiating element 132 generally comprises a wideband monopole, such as a partially circular monopole. Other geometrical shapes of the monopole radiating element 132 are contemplated. Additionally, it is also contemplated that the monopole radiating element 132 may include additional projections and/or define slots to achieve desired tuning.

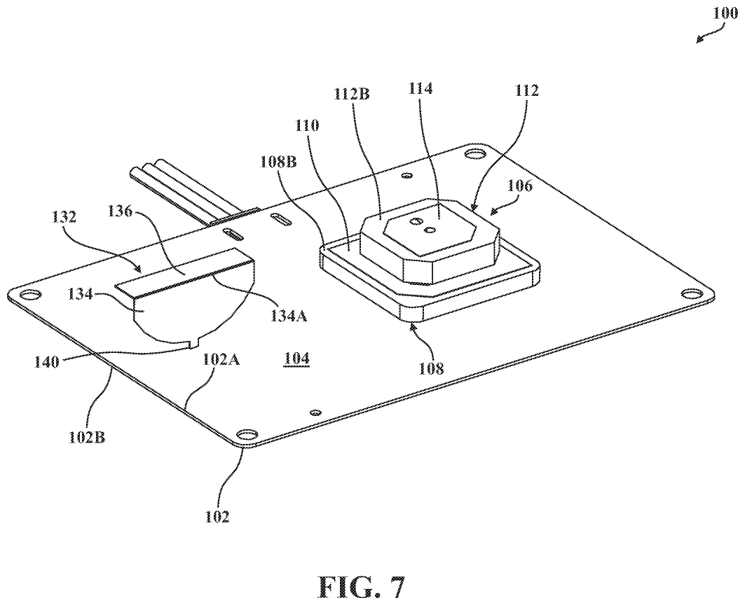

In one example, referring to FIG. 7, the monopole radiating element 132 further includes a second portion 136. If included, the second portion 136 is typically coupled to and extends from the first portion 134. For example, the second portion 136 may extend perpendicularly from the first portion 134, but other configurations are contemplated. The second portion 136 may be spaced from the ground plane 104. For example, the second portion may be coupled to a top edge 134A of the first portion 134 and extend parallel to the ground plane 104. Here, the second portion 136 may function to reduce the height of the monopole radiating element 132 and/or alter the radiation pattern of monopole radiating element 132 such that the monopole radiating element 132 has different linear polarization components (i.e., horizontal polarization components and vertical polarization components) and/or increased directionality. Other arrangements and configurations of the monopole radiating element 132 are contemplated.

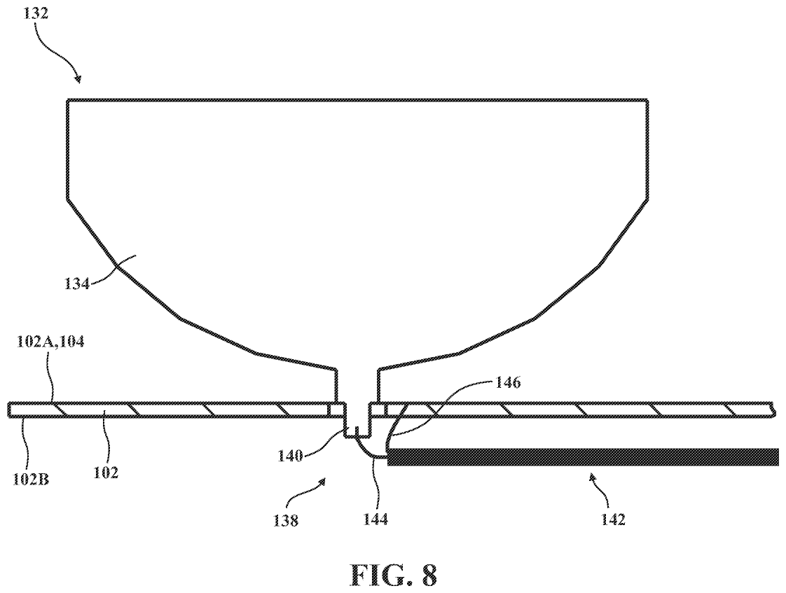

The antenna assembly 100 also includes a second feeding assembly 138 operatively connected to the monopole radiating element 132 at a third feeding point 140 for energizing the monopole radiating element 132 to transmit and/or receive radio frequency signals. In one example, referring to FIG. 8, the second feeding assembly 138 includes a coaxial cable 142. The coaxial cable 142 may include a central conductor 144 arranged in electrical communication with the monopole radiating element 132 at the third feeding point 140 and a ground shield 146 arranged in electrical communication with the ground plane 104 to energize the monopole radiating element 132 to transmit and/or receive radio frequency signals. Other configurations of the second feeding assembly 138 are contemplated. For example, the third feeding point 140 may be arranged in electrical communication with the one or more circuits of the PCB 102 to energize the monopole radiating element 132 to transmit and/or receive radio frequency signals. It is also contemplated that the second feeding assembly 138 may include capacitive coupling elements to energize the monopole radiating element 132 to transmit and/or receive radio frequency signals. It is further contemplated that the second feeding assembly 138 may include microstrip-type or lump-type impedance matching elements.

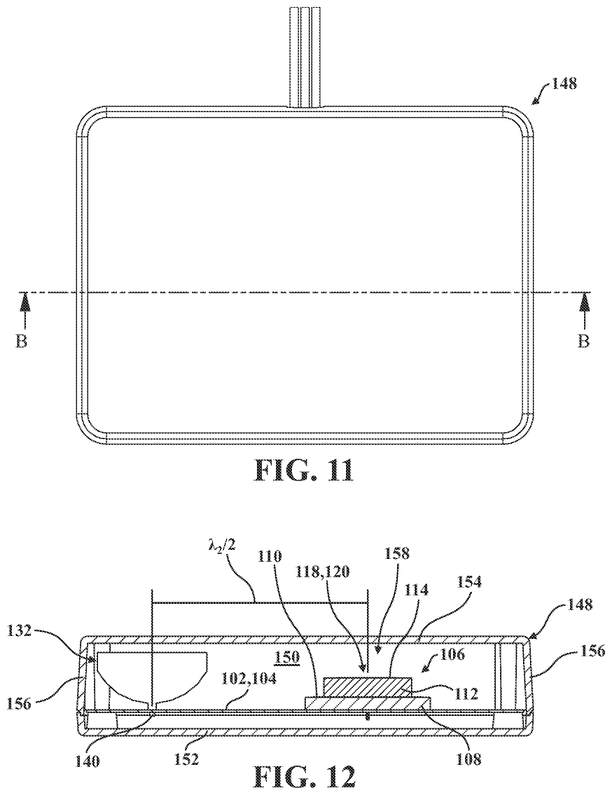

As best shown in FIG. 3, the patch antenna stack 106 and the monopole radiating element 132 may be arranged relative to each other on their common ground plane 104 such that there is minimal interference with each other. It should be appreciated that the width W and the length L of the ground plane 104 may each independently be at least λ₁/2 to ensure adequate gain and/or directionality of the first patch conductor 110 and the second patch conductor 114. In some examples, the width W and the length L may each independently be greater than 70 mm, greater than 75 mm, greater than 80 mm, greater than 85 mm, greater than 90 mm, greater than 100 mm, greater than 105 mm, greater than 110 mm, greater than 115 mm, greater than 120 mm, or even greater than 125 mm. Additionally, in some configurations the patch antenna stack 106 is centered on the ground plane 104 in the lateral direction X such that the patch antenna stack 106 is arranged such that the first center plane CP1 bisects the patch antenna stack 106. Additionally, the first dielectric 108 may define a first longitudinal surface 108C transverse to the ground plane 104, and a second longitudinal surface 108D opposite the first longitudinal surface 108C. Here, the first longitudinal surface 108C may be coplanar with the second center plane CP2. To space the patch antenna stack 106 and the monopole radiating element 132 from each other, the monopole radiating element 132 may be arranged on a first lateral side LAS1 of the second center plane CP2, and the patch antenna stack 106 may be arranged on a second lateral side LAS2 of the second center plane CP2 opposite the first lateral side LAS1. In any event, at a minimum, as best shown in FIG. 12, the second feeding point 120 is spaced from the third feeding point 140 by at least λ₂/2 to ensure adequate isolation between the monopole radiating element 132 and the patch antenna stack 106. Also, in some examples, the monopole radiating element 132 is coplanar with the first center plane CP1.

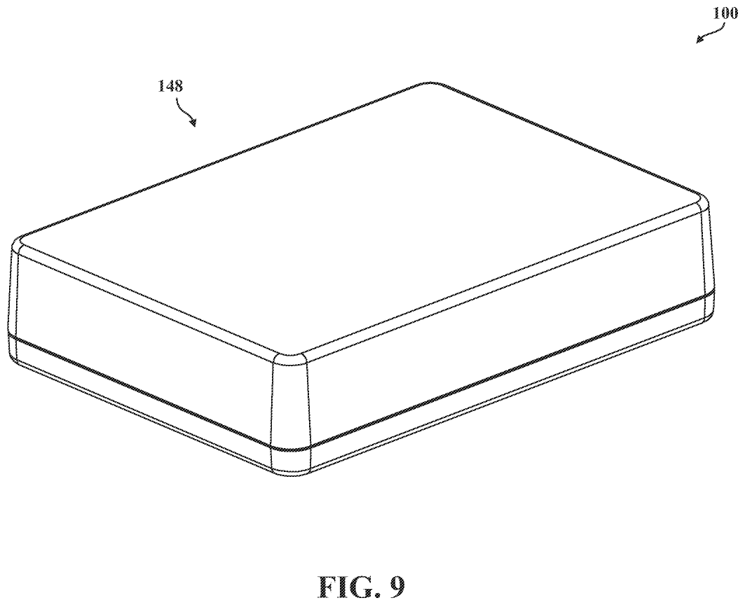

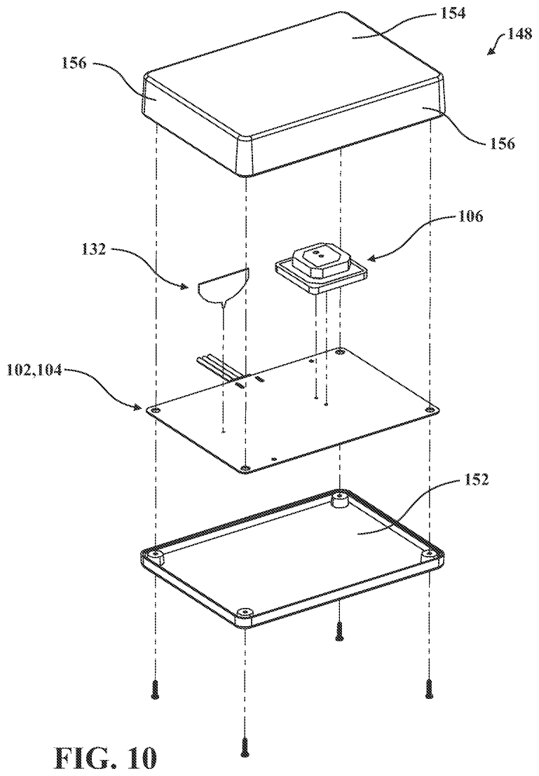

Referring to FIGS. 9-16, the antenna assembly 100 may further comprise a housing 148. The housing 148 defines a housing interior 150 bounded by a bottom wall 152, a top wall 154 parallel to and spaced from the bottom wall 152, and a plurality of side walls 156 extending between the bottom wall 152 and the top wall 154. As best shown in FIGS. 10 and 12, the antenna assembly 100 may be disposed within the housing interior 150 such that the top surface 102A of the PCB 102 faces the top wall 154 of the housing 148. The antenna assembly 100 may also be arranged within the housing interior 150 such that the second patch conductor 114 is spaced from the top wall 154 to define a gap 158 therebetween. The gap 158 may be filled with air or another dielectric material. The housing 148 may be made of a material having a low permittivity (ϵr). For example, the permittivity (ϵr) may range from greater than 1 to less than 4. Exemplary materials having low permittivity (ϵr) include, but are not limited to, plastics such as acrylonitrile styrene acrylate (ASA) and acrylonitrile butadiene styrene (ABS).

The housing 148 may be configured to be coupled to a vehicle 98. If included, the housing 148 should generally be arranged in a manner that a conductive member of a vehicle (e.g. a metal body panel) does not obstruct radio frequency signals from emanating upwards toward the sky. In one example, the housing 148 may be configured to be coupled to a nonconductive pane 160 of a vehicle 98. The term “nonconductive” refers to a material, such as an insulator or dielectric, that when placed between conductors at different potentials, permits only a small or negligible current in phase with the applied voltage to flow through material. Typically, nonconductive materials have conductivities on the order of nanosiemens/meter. In some examples, the nonconductive pane 160 is implemented as at least one pane of glass. Where the nonconductive pane 160 is implemented as glass, the nonconductive pane 160 may be comprised of any suitable glass composition including, but not limited to, soda-lime glass, aluminosilicate glass, borosilicate glass, boro-aluminosilicate glass, and the like. Of course, the nonconductive pane 160 may include more than one pane of glass. Those skilled in the art, however, realize that the nonconductive pane 160 may be formed from plastic, fiberglass, or other suitable nonconductive materials.

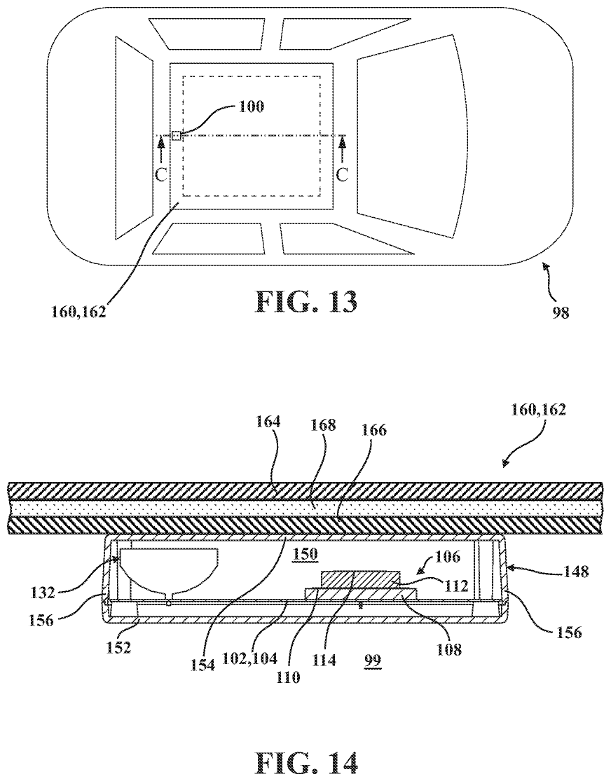

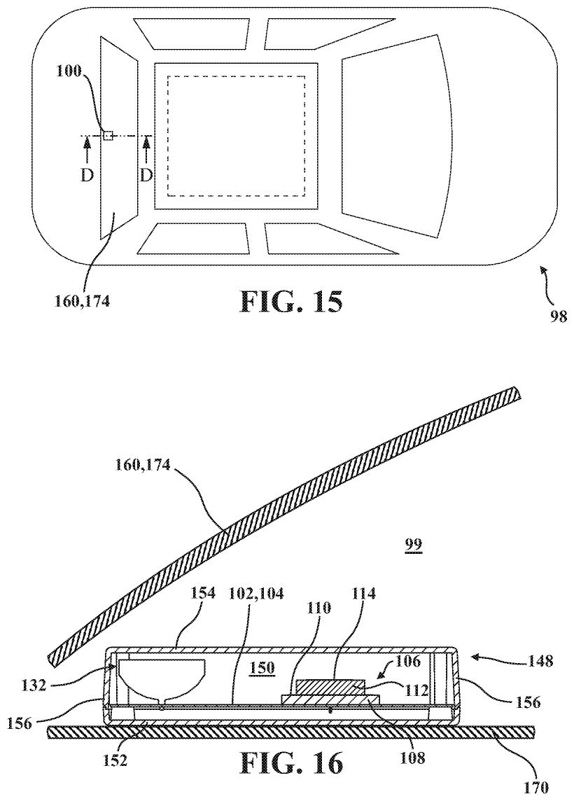

FIGS. 13 and 14 show the top wall 154 of the housing 148 coupled to a roof glass 162 of a vehicle 98 such that the antenna assembly 100 is arranged substantially horizontal (and thus facing the sky). Here, the roof glass 162 is a laminated glazing including an outer glass substrate 164 having an outer surface (P1) and an opposing inner surface (P2), an inner glass substrate 166 having an inner surface (P3) and an opposing outer surface (P4), and a polymeric interlayer 168 disposed between the P2 surface of the outer glass substrate 164 and the P3 surface of the inner glass substrate 166. In this case, the top wall 154 of the housing 148 is coupled (either directly or indirectly) to the P4 surface. It is also contemplated that the nonconductive pane 160 may be a single pane of glass (rather than a laminated glazing) such as a side window or a rear window of a vehicle. In these cases, the housing 148 may be configured to be coupled to the nonconductive pane 160 at an angle such that the antenna assembly 100 is still arranged substantially horizontal (and thus facing the sky). It is further contemplated that the housing 148 may be coupled to nonconductive panes other than glass, such as fiberglass or composite body panels (e.g. a trunk lids, mirror housings, fenders, quarter panels, spoilers, etc.). The housing 148 may also be configured to be arranged within an interior compartment 99 of a vehicle 98. Referring to FIGS. 15 and 16, in one example, the housing 148 may be arranged on a luggage rack 170 below the rear window 174 of the vehicle such that the antenna assembly 100 is arranged substantially horizontal (and thus facing the sky). Of course, other locations for arranging the housing 148 (and, thus the antenna assembly 100) within an interior compartment 99 of a vehicle 98 are contemplated.

### Second Embodiment

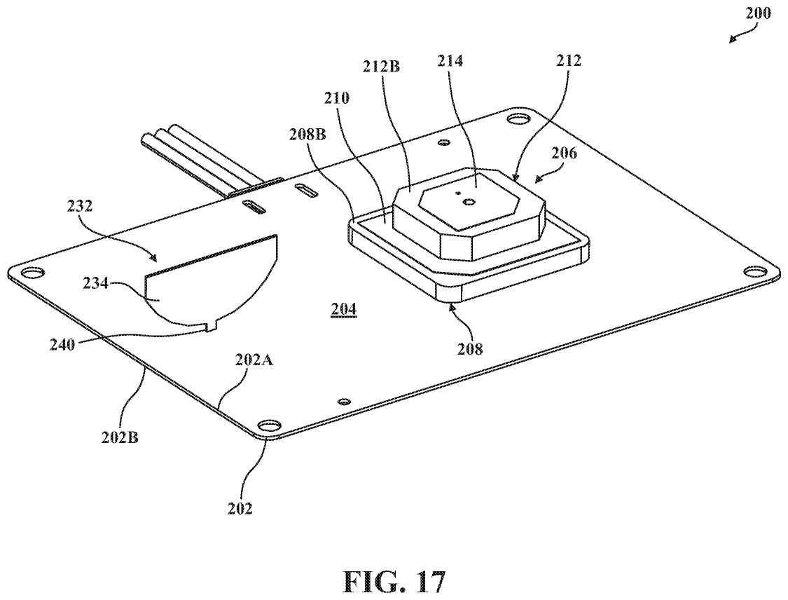

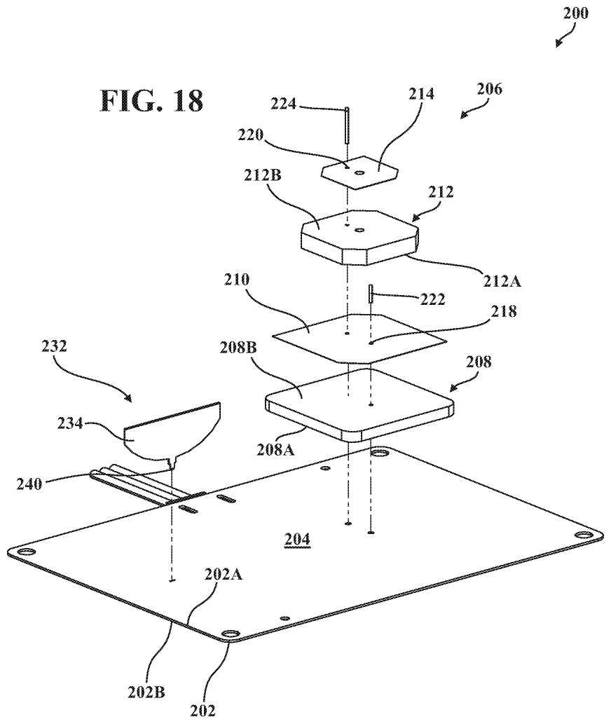

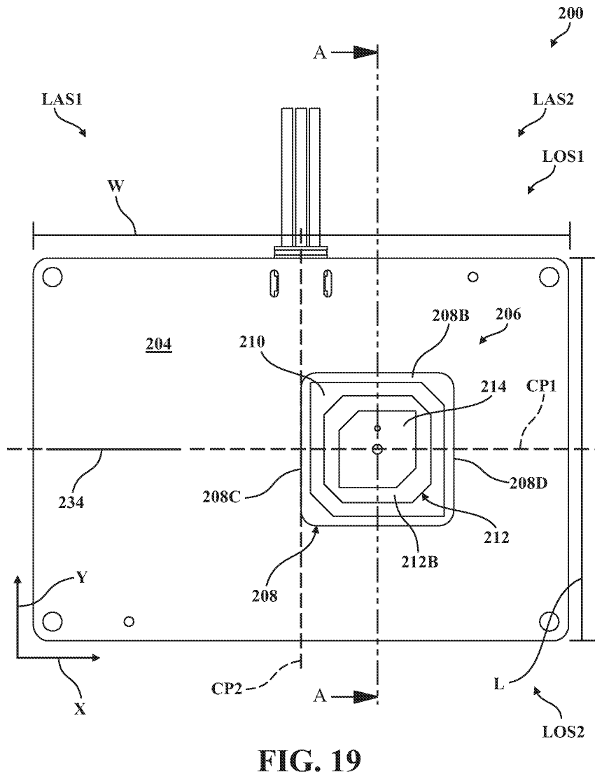

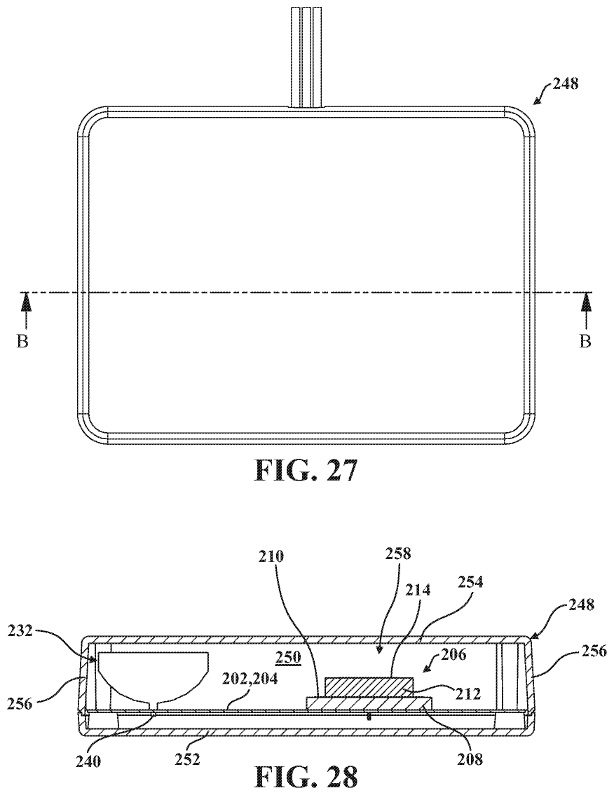

FIGS. 17-32 illustrate another embodiment of an antenna assembly 200 for a vehicle according to the present disclosure. Referring first to FIGS. 17-19, the antenna assembly 200 includes a PCB 202 including a top surface 202A and a bottom surface 202B opposite the top surface 202A. The PCB 202 typically includes one or more circuits configured to be arranged in electrical communication with the antenna assembly 200 to operate the antenna assembly 200 to transmit and/or receive radio frequency signals. The antenna assembly 200 also includes a ground plane 204 disposed on the top surface 202A of the PCB 202. Although not required, the ground plane 204 may comprise a metallization layer formed or disposed on the top surface 202A of the PCB 202. The metallization layer may comprise a copper foil or the like. The ground plane 204 has a width W and a length L. The width W may extend in a lateral direction (X), and the length L may extend in a longitudinal direction (Y) transverse to the lateral direction (X). Additionally, as best shown in FIG. 19, the ground plane 204 may define a first center plane CP1 bisecting the ground plane 204 in the lateral direction (X) and a second center plane CP2 bisecting the ground plane 204 in the longitudinal direction (Y).

As best shown in FIGS. 17-20, the antenna assembly 200 further includes a patch antenna stack 206. The patch antenna stack 206 includes a first dielectric 208 extending between a first dielectric surface 208A and a second dielectric surface 208B opposite the first dielectric surface 208A. The first dielectric surface 208A is operatively connected to the ground plane 204. For example, the first dielectric surface 208A may be operatively connected to the ground plane 204 by being directly or indirectly adhered or otherwise fixed to the ground plane 204. The first dielectric 208 may comprise a suitable dielectric material such as a ceramic material. The patch antenna stack 206 also includes a first patch conductor 210 operatively connected to the second dielectric surface 208B of the first dielectric 208. For example, first patch conductor 210 may be operatively connected to the second dielectric surface 208B by being directly or indirectly adhered or otherwise fixed to the second dielectric surface 208B. The first patch conductor 210 is configured to be energized to transmit and/or receive radio frequency signals having a first frequency with a first wavelength λ₁ and having circular polarization in a first direction. The first patch conductor 210 may comprise a conductive layer formed or disposed on the second dielectric surface 208B of the first dielectric 208. For example, the first patch conductor 210 may comprise a conductive foil. The first patch conductor 210 may be generally rectangular in shape with opposing corners cut to effect circular polarization, but other configurations are contemplated.

In some examples, the first frequency is from 1500 megahertz to 1650 megahertz. More specifically, the first frequency may be from 1550 megahertz to 1625 megahertz. Additionally, the first direction may be right-handed circular polarization (RHCP). Accordingly, the first patch conductor 210 may be configured to transmit and/or receive radio frequency signals on one or more Global Navigation Satellite Systems (GNSS) including, but not limited to, the United States's Global Positioning System (GPS), Russia's Global Navigation Satellite System (GLONASS), China's BeiDou Navigation Satellite System, the European Union's Galileo Satellite System, and Japan's Quasi-Zenith Satellite System (QZSS). Of course, left-handed circular polarization and/or other frequencies are contemplated.

With continued reference to FIGS. 17-20, the patch antenna stack 206 further includes a second dielectric 212 extending between a third dielectric surface 212A and a fourth dielectric surface 212B opposite the third dielectric surface 212A. The third dielectric surface 212A is operatively connected to the first patch conductor 210. For example, the third dielectric surface 212A may be operatively connected to the first patch conductor 210 by being directly or indirectly adhered or otherwise fixed to the first patch conductor 210. The second dielectric 212 may comprise a suitable dielectric material such as a ceramic material. The patch antenna stack 206 further includes a second patch conductor 214 operatively connected to the fourth dielectric surface 212B of the second dielectric 212. For example, the second patch conductor 214 may be operatively connected to the fourth dielectric surface 212B by being directly or indirectly adhered or otherwise fixed to the fourth dielectric surface 212B. The second patch conductor 214 is configured to be energized to transmit and/or receive radio frequency signals having a second frequency with a second wavelength λ₂, higher than the first frequency, and having circular polarization in a second direction opposite the first direction. The second patch conductor 214 may comprise a conductive layer formed or disposed on the fourth dielectric surface 212B of the second dielectric 212. For example, the second patch conductor 214 may comprise a conductive foil. The second patch conductor 214 may be generally rectangular in shape with opposing corners cut to effect circular polarization, but other configurations are contemplated.

In some examples, the second frequency is from 2250 megahertz to 2400 megahertz. More specifically, the second frequency may be from 2310 megahertz to 2360 megahertz. Even more specifically, the second frequency may be from 2320 megahertz to 2345 megahertz. Additionally, the first direction may be left-handed circular polarization (LHCP). Accordingly, the second patch conductor 214 may be configured to transmit and/or receive radio frequency signals on Satellite Digital Audio Radio Services (SDARS) including, but not limited to, Sirius Satellite Radio and XM Satellite Radio. Of course, right-handed circular polarization and/or other frequencies are contemplated.

Still referring to FIGS. 17-20, the antenna assembly 200 may additionally include a first feeding assembly 216 for energizing the first patch conductor 210 and the second patch conductor 214 to transmit and/or receive radio frequency signals. For example, the first feeding assembly 216 may arrange the first patch conductor 210 and the second patch conductor 214 in electrical communication with the one or more circuits of the PCB 202 to energize the first patch conductor 210 and the second patch conductor 214 to transmit and/or receive radio frequency signals. It should be appreciated that in other configurations the first feeding assembly 216 is arranged such that the first patch conductor 210 and the second patch conductor 214 are in electrical communication with other circuitry outside of the antenna assembly 200 to energize the first patch conductor 210 and the second patch conductor 214 to transmit and/or receive radio frequency signals. For example, each of the first patch conductor 210 and the second patch conductor 214 may be arranged in electrical communication with a central conductor of a respective coaxial cable, and a ground shield of each respective coaxial cable may be arranged in electrical communication with the ground plane 204. It is also contemplated that the first feeding assembly 216 may include capacitive coupling elements to energize the first patch conductor 210 and/or the second patch conductor 214. It is further contemplated that the first feeding assembly 216 may include microstrip-type or lump-type impedance matching elements.

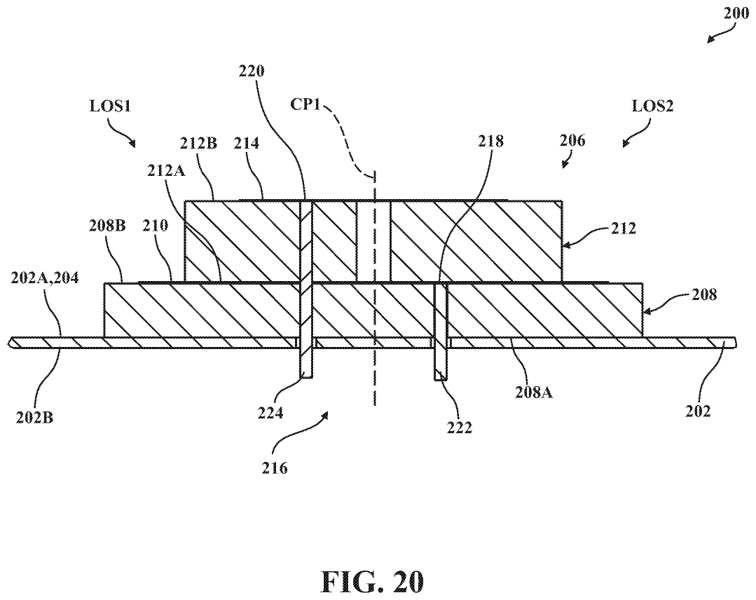

As best shown in FIG. 20, the first feeding assembly 216 may be operatively connected to the first patch conductor 210 at a first feeding point 218 and to the second patch conductor 214 at a second feeding point 220. In some examples, such as shown in FIG. 20, the first feeding point 218 is arranged on a first longitudinal side LOS1 of the first center plane CP1, and the second feeding point 220 is arranged on a second longitudinal side LOS2 of the first center plane CP1, opposite the first longitudinal side LOS1. In this configuration, the first feeding assembly 216 includes a first feeding member 222 extending through the ground plane 204 and the first dielectric 208 such that the first feeding member 222 is coupled to the first patch conductor 210 at the first feeding point 218 to energize the first patch conductor 210 to transmit and/or receive radio frequency signals having the first frequency and having circular polarization in the first direction. Additionally, this configuration also includes a second feeding member 224 extending through the ground plane 204, the first dielectric 208, the first patch conductor 210, and the second dielectric 212 such that the second feeding member 224 is coupled to the second patch conductor 214 at the second feeding point 220 point to energize the second patch conductor 214 to transmit and/or receive radio frequency signals having the second frequency and having circular polarization in the second direction. Other configurations of operatively connecting the first feeding assembly 216 to the first patch conductor 210 at the first feeding point 218 and the second patch conductor 214 at the second feeding point 220 to energize the first patch conductor 210 and the second patch conductor 214 to transmit and/or receive radio frequency signals are contemplated.

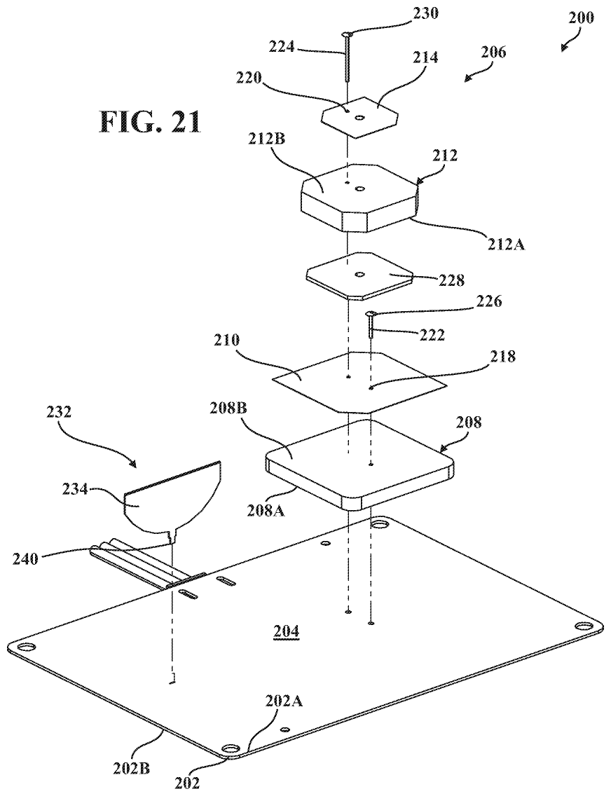

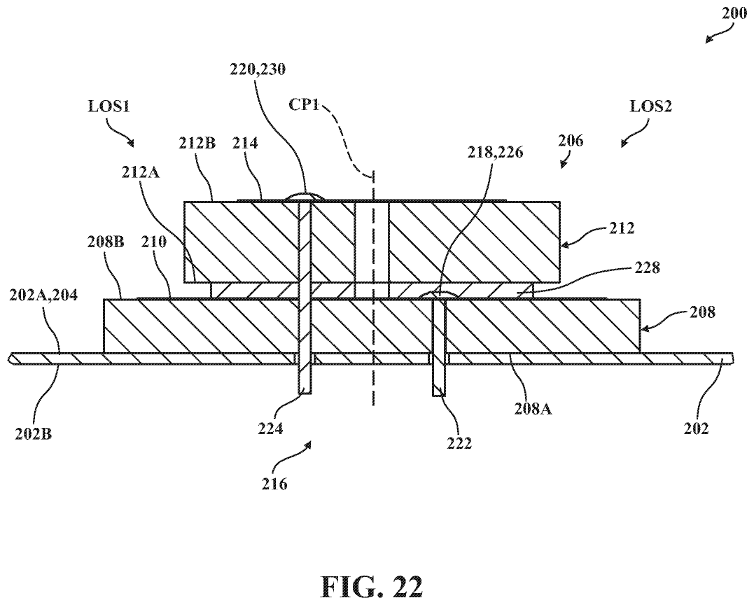

Referring to FIGS. 21 and 22, in some examples, the first feeding point 218 extends beyond the first patch conductor 210. For example, the first feeding point 218 as illustrated includes a first solder joint 226 operatively connecting the first feeding member 222 to the first patch conductor 210. In these examples, especially where the second dielectric 212 is a rigid material such as the ceramic material, the first solder joint 226 may cause the second dielectric 212 to be misaligned (i.e., not parallel) with the first patch conductor 210. Accordingly, the patch antenna stack 206 may further include a spacer 228 interposed between the first patch conductor 210 and the second dielectric 212. The spacer 228 is configured to deform (i.e., deflect) where the first feeding point 218 (particularly, the first solder joint 226) extends beyond the first patch conductor 210 such that the second dielectric 212 is arranged parallel to the first patch conductor 210. The spacer 228 may be comprised of a nonconductive material such as foam. The second feeding point 220 may similarly comprise a second solder joint 230 operatively connecting the second feeding member 224 to the second patch conductor 214. Other configurations of operatively connecting the first feeding member 222 to the first patch conductor 210 and the second feeding member 224 to the second patch conductor 214 are contemplated.

The antenna assembly 200 further includes a monopole radiating element 232 including a first portion 234 extending perpendicularly from the ground plane 204. The monopole radiating element 232 is configured to be energized to transmit and/or receive radio frequency signals having linear polarization. The monopole radiating element 232 may be configured to transmit and/or receive radio frequency signals having a frequency of from 600 megahertz to 6 gigahertz. Accordingly, the monopole radiating element 232 may be configured to transmit and/or receive radio frequency signals on 4G LTE, 5G sub-6 GHz networks, and any other current and future cellular networks falling within the 600 megahertz to 6 gigahertz frequency range. Other networks falling within the 600 megahertz to 6 gigahertz frequency range are also contemplated, such as V2X networks and Wi-Fi. The operative frequency of the monopole radiating element 232 may also be expressed as a third wavelength λ₃. In some examples, the monopole radiating element 232 has a height and/or width of less than of λ₃/4. To accommodate the large range of frequencies, the monopole radiating element 232 generally comprises a wideband monopole, such as a partially circular monopole. Other geometrical shapes of the monopole radiating element 232 are contemplated. Additionally, it is also contemplated that the monopole radiating element 232 may include additional projections and/or define slots to achieve desired tuning.

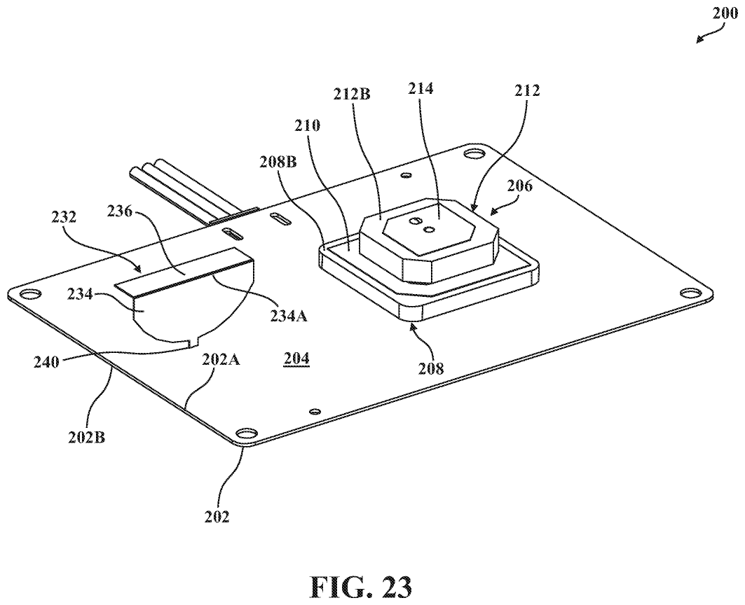

In one example, referring to FIG. 23, the monopole radiating element 232 further includes a second portion 236. If included, the second portion 236 is typically coupled to and extends from the first portion 234. For example, the second portion 236 may extend perpendicularly from the first portion 234, but other configurations are contemplated. The second portion 236 may be spaced from the ground plane 204. For example, the second portion may be coupled to a top edge 234A of the first portion 234 and extend parallel to the ground plane 204. Here, the second portion 236 may function to reduce the height of the monopole radiating element 232 and/or alter the radiation pattern of monopole radiating element 232 such that the monopole radiating element 232 has different linear polarization components (i.e., horizontal polarization components and vertical polarization components) and/or increased directionality. Other arrangements and configurations of the monopole radiating element 232 are contemplated.

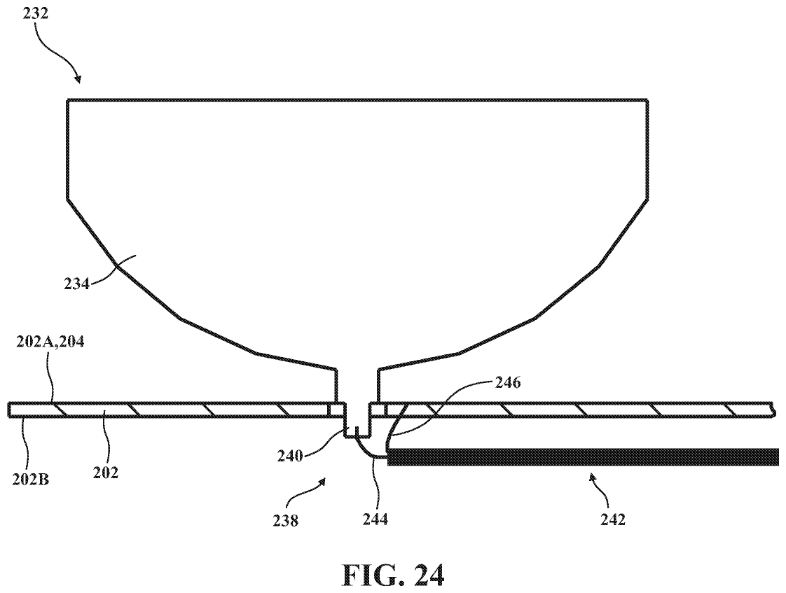

The antenna assembly 200 may also include a second feeding assembly 238 operatively connected to the monopole radiating element 232 at a third feeding point 240 for energizing the monopole radiating element 232 to transmit and/or receive radio frequency signals. In one example, referring to FIG. 24, the second feeding assembly 238 includes a coaxial cable 242. The coaxial cable 242 may include a central conductor 244 arranged in electrical communication with the monopole radiating element 232 at the third feeding point 240 and a ground shield 246 arranged in electrical communication with the ground plane 204 to energize the monopole radiating element 232 to transmit and/or receive radio frequency signals. Other configurations of the second feeding assembly 238 are contemplated. For example, the third feeding point 240 may be arranged in electrical communication with the one or more circuits of the PCB 202 to energize the monopole radiating element 232 to transmit and/or receive radio frequency signals. It is also contemplated that the second feeding assembly 238 may include capacitive coupling elements to energize the monopole radiating element 232 to transmit and/or receive radio frequency signals. It is further contemplated that the second feeding assembly 238 may include microstrip-type or lump-type impedance matching elements.

As best shown in FIG. 19, the patch antenna stack 206 and the monopole radiating element 232 may be arranged relative to each other on their common ground plane 204 such that there is minimal interference with each other. In this embodiment, it should be appreciated that the width W and the length L of the ground plane 204 are each independently at least λ₁/2 to ensure adequate gain and/or directionality of the first patch conductor 210 and the second patch conductor 214. In some examples, the width W and the length L may each be independently be greater than 70 mm, greater than 75 mm, greater than 80 mm, greater than 85 mm, greater than 90 mm, greater than 100 mm, greater than 105 mm, greater than 110 mm, greater than 115 mm, greater than 120 mm, or even greater than 125 mm. Additionally, in some configurations the patch antenna stack 206 is centered on the ground plane 204 in the lateral direction X such that the patch antenna stack 206 is arranged such that the first center plane CP1 bisects the patch antenna stack 206. Additionally, the first dielectric 208 may define a first longitudinal surface 208C transverse to the ground plane 204, and a second longitudinal surface 208D opposite the first longitudinal surface 208C. Here, the first longitudinal surface 208C may be coplanar with the second center plane CP2. To space the patch antenna stack 206 and the monopole radiating element 232 from each other, the monopole radiating element 232 may be arranged on a first lateral side LAS1 of the second center plane CP2, and the patch antenna stack 206 may be arranged on a second lateral side LAS2 of the second center plane CP2 opposite the first lateral side LAS1. To prevent interference, the first feeding point 218 and/or the second feeding point 220 may be spaced from the third feeding point 240 by at least λ₂/2 to ensure adequate isolation between the monopole radiating element 232 and the patch antenna stack 206. Also, in some examples, the monopole radiating element 232 is coplanar with the first center plane CP1.

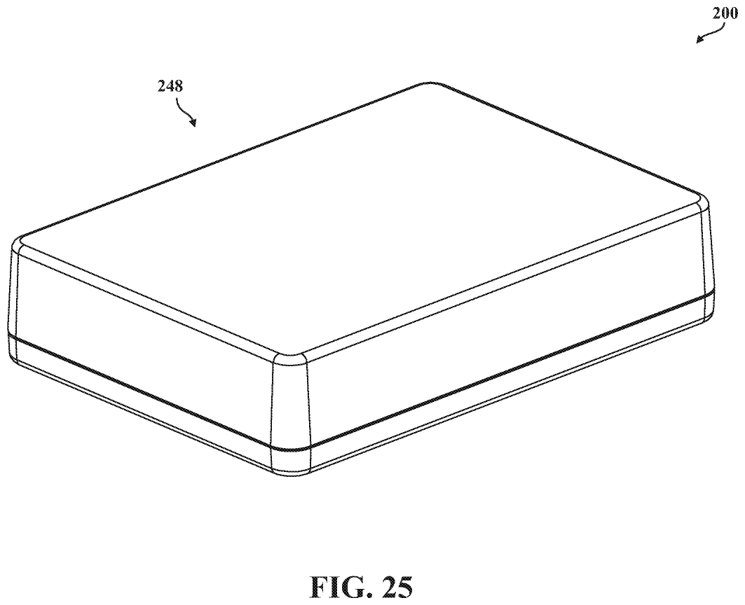

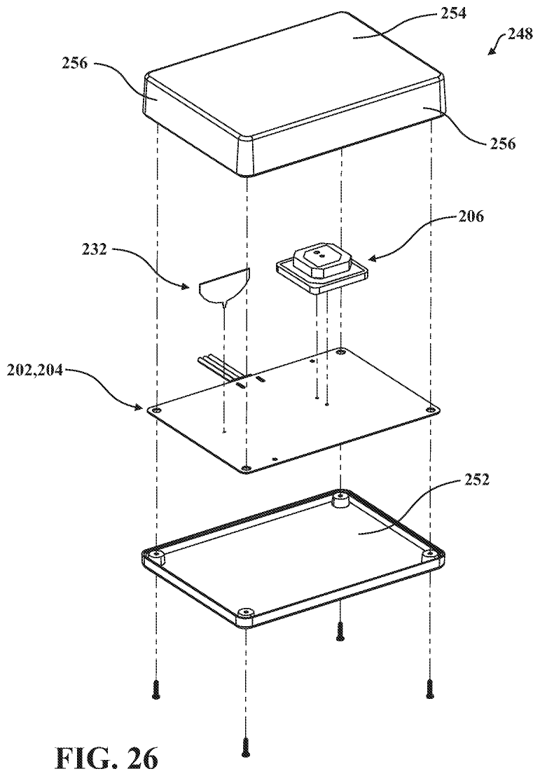

Referring to FIGS. 25-32, the antenna assembly 200 may further comprise a housing 248. The housing 248 defines a housing interior 250 bounded by a bottom wall 252, a top wall 254 parallel to and spaced from the bottom wall 252, and a plurality of side walls 256 extending between the bottom wall 252 and the top wall 254. As best shown in FIGS. 26 and 28, the antenna assembly 200 may be disposed within the housing interior 250 such that the top surface 202A of the PCB 202 faces the top wall 254 of the housing 248. The antenna assembly 200 may also be arranged within the housing interior 250 such that the second patch conductor 214 is spaced from the top wall 254 to define a gap 258 therebetween. The gap 258 may be filled with air or another dielectric material. The housing 248 may be made of a material having a low permittivity (ϵr). For example, the permittivity (ϵr) may range from greater than 1 to less than 4. Exemplary materials having low permittivity (ϵr) include, but are not limited to, plastics such as acrylonitrile styrene acrylate (ASA) and acrylonitrile butadiene styrene (ABS).

The housing 248 may be configured to be coupled to a vehicle 98. If included, the housing 248 should generally be arranged in a manner that a conductive member of a vehicle (e.g. a metal body panel) does not obstruct radio frequency signals from emanating upwards toward the sky. In one example, the housing 248 may be configured to be coupled to a nonconductive pane 260 of a vehicle 98. The term “nonconductive” refers to a material, such as an insulator or dielectric, that when placed between conductors at different potentials, permits only a small or negligible current in phase with the applied voltage to flow through material. Typically, nonconductive materials have conductivities on the order of nanosiemens/meter. In some examples, the nonconductive pane 260 is implemented as at least one pane of glass. Where the nonconductive pane 260 is implemented as glass, the nonconductive pane 260 may be comprised of any suitable glass composition including, but not limited to, soda-lime glass, aluminosilicate glass, borosilicate glass, boro-aluminosilicate glass, and the like. Of course, the nonconductive pane 260 may include more than one pane of glass. Those skilled in the art, however, realize that the nonconductive pane 260 may be formed from plastic, fiberglass, or other suitable nonconductive materials.

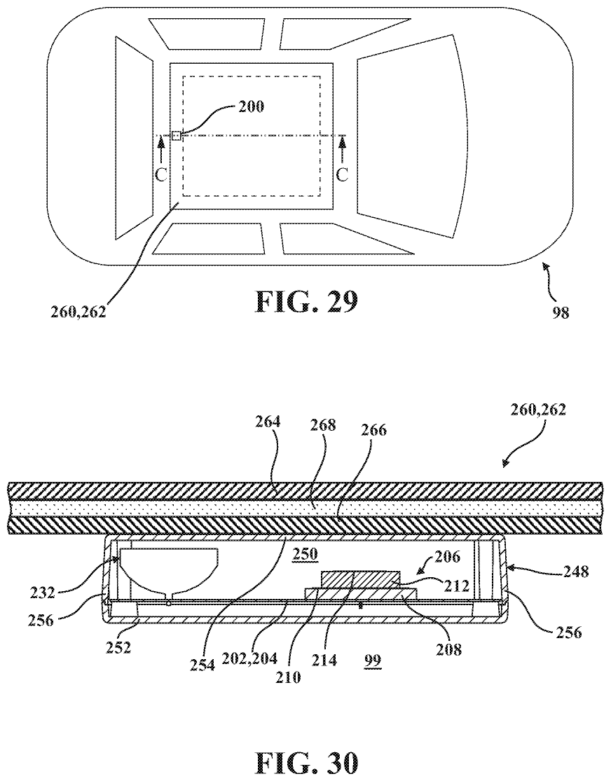

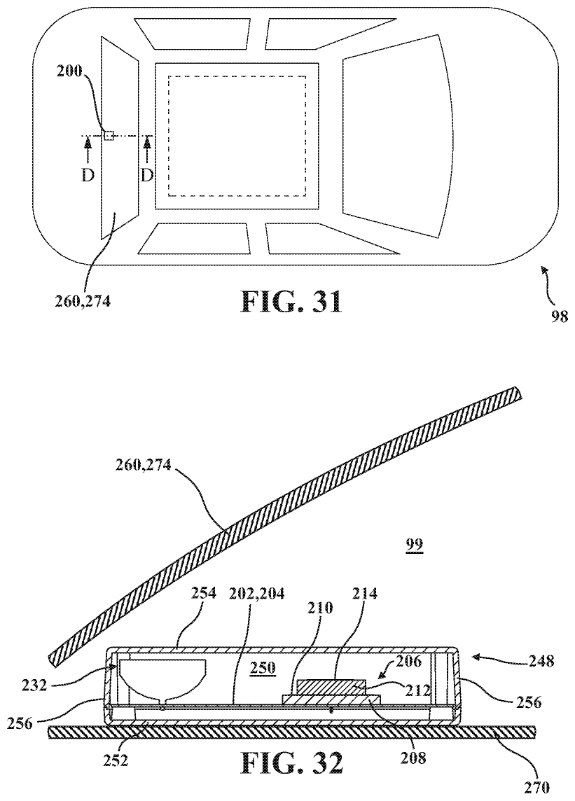

FIGS. 29 and 30 show the top wall 254 of the housing 248 coupled to a roof glass 262 of a vehicle 98 such that the antenna assembly 200 is arranged substantially horizontal (and thus facing the sky). Here, the roof glass 262 is a laminated glazing including an outer glass substrate 264 having an outer surface (P1) and an opposing inner surface (P2), an inner glass substrate 266 having an inner surface (P3) and an opposing outer surface (P4), and a polymeric interlayer 268 disposed between the P2 surface of the outer glass substrate 264 and the P3 surface of the inner glass substrate 266. In this case, the top wall 254 of the housing 248 is coupled (either directly or indirectly) to the P4 surface. It is also contemplated that the nonconductive pane 260 may be a single pane of glass (rather than a laminated glazing) such as a side window or a rear window of a vehicle. In these cases, the housing 248 may be configured to be coupled to the nonconductive pane 260 at an angle such that the antenna assembly 200 is still arranged substantially horizontal (and thus facing the sky). It is further contemplated that the housing 248 may be coupled to nonconductive panes other than glass, such as fiberglass or composite body panels (e.g. a trunk lids, mirror housings, fenders, quarter panels, spoilers, etc.). The housing 248 may also be configured to be arranged within an interior compartment 99 of a vehicle 98. Referring to FIGS. 31 and 32, in one example, the housing 248 may be arranged on a luggage rack 270 below the rear window 274 of the vehicle such that the antenna assembly 200 is arranged substantially horizontal (and thus facing the sky). Of course, other locations for arranging the housing 248 (and, thus, the antenna assembly 200) within an interior compartment 99 of a vehicle 98 are contemplated.

### Third Embodiment

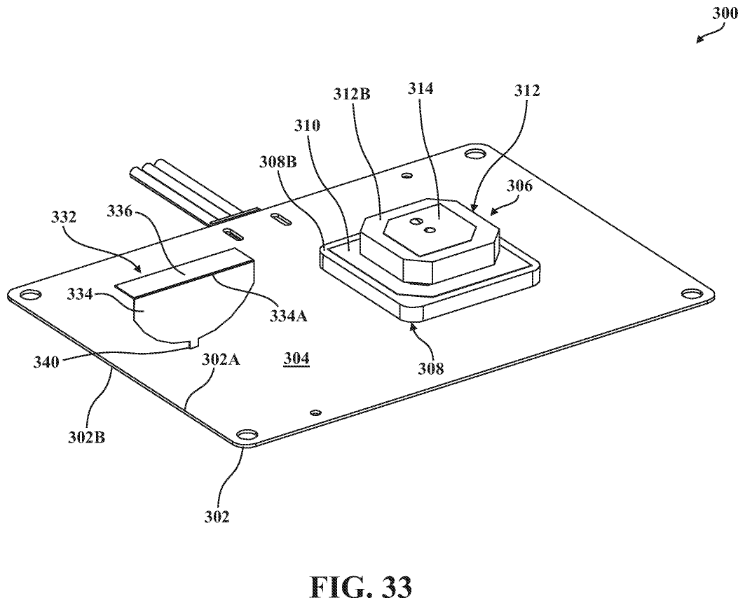

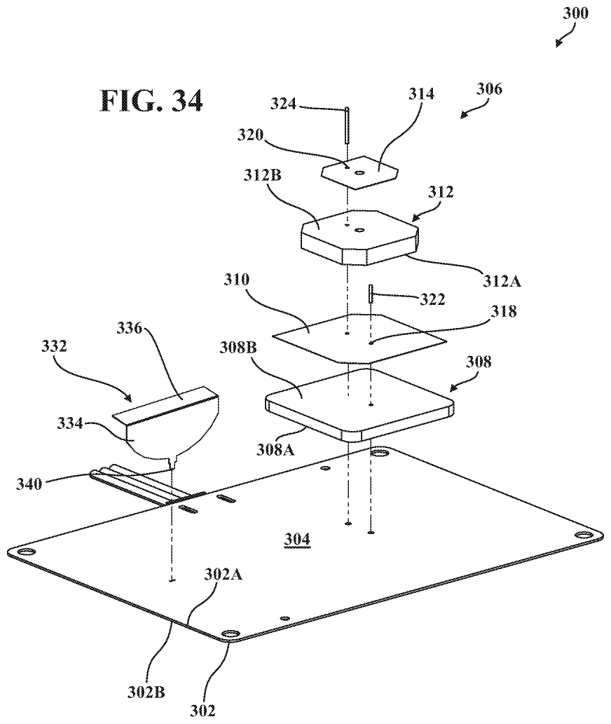

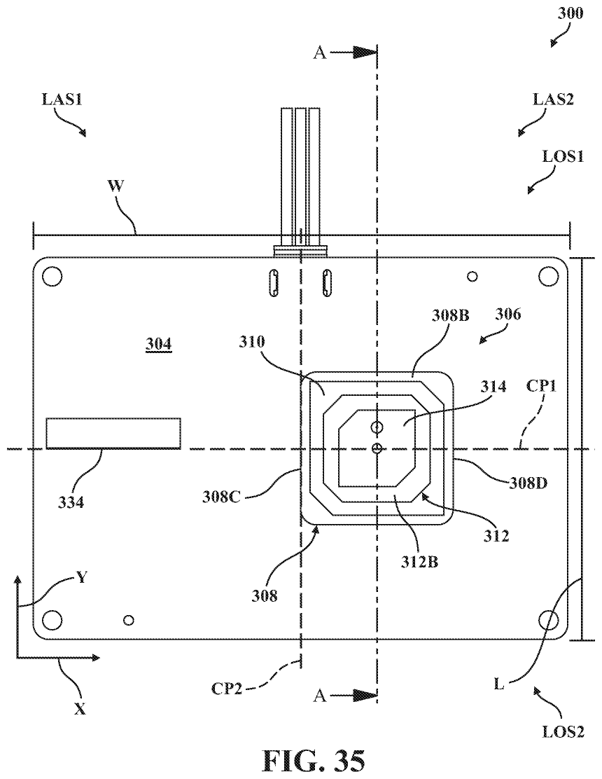

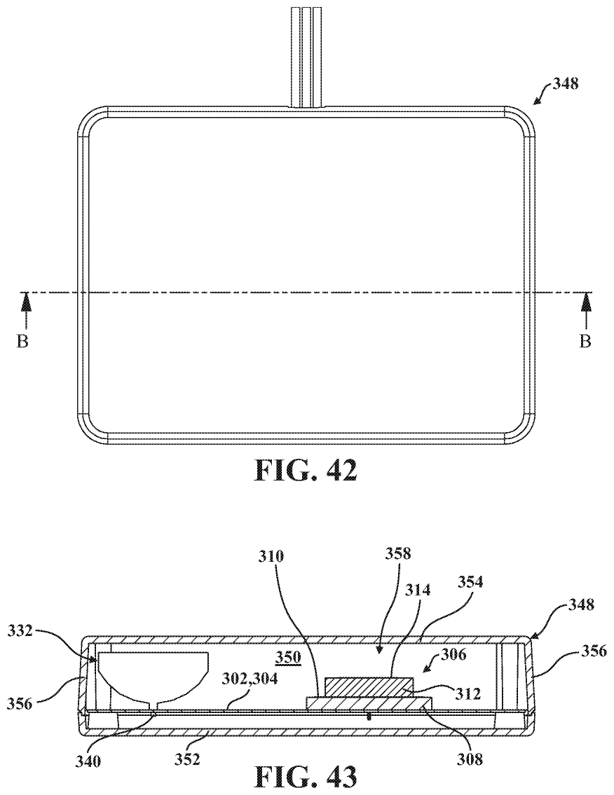

FIGS. 33-47 illustrate yet another embodiment of an antenna assembly 300 for a vehicle according to the present disclosure. Referring first to FIGS. 33-35, the antenna assembly 300 includes a PCB 302 including a top surface 302A and a bottom surface 302B opposite the top surface 302A. The PCB 302 typically includes one or more circuits configured to be arranged in electrical communication with the antenna assembly 300 to operate the antenna assembly 300 to transmit and/or receive radio frequency signals. The antenna assembly 300 also includes a ground plane 304 disposed on the top surface 302A of the PCB 302. Although not required, the ground plane 304 may comprise a metallization layer formed or disposed on the top surface 302A of the PCB 302. The metallization layer may comprise a copper foil or the like. The ground plane 304 may be generally rectangular in shape and have a width W in a lateral direction (X), and a length L in a longitudinal direction (Y) transverse to the lateral direction (X). Additionally, as best shown in FIG. 35, the ground plane 304 may define a first center plane CP1 bisecting the ground plane 304 in the lateral direction (X) and a second center plane CP2 bisecting the ground plane 304 in the longitudinal direction (Y).

As best shown in FIGS. 33-36, the antenna assembly 300 further includes a patch antenna stack 306. The patch antenna stack 306 includes a first dielectric 308 extending between a first dielectric surface 308A and a second dielectric surface 308B opposite the first dielectric surface 308A. The first dielectric surface 308A is operatively connected to the ground plane 304. For example, the first dielectric surface 308A may be operatively connected to the ground plane 304 by being directly or indirectly adhered or otherwise fixed to the ground plane 304. The first dielectric 308 may comprise a suitable dielectric material such as a ceramic material. The patch antenna stack 306 also includes a first patch conductor 310 operatively connected to the second dielectric surface 308B of the first dielectric 308. For example, first patch conductor 310 may be operatively connected to the second dielectric surface 308B by being directly or indirectly adhered or otherwise fixed to the second dielectric surface 308B. The first patch conductor 310 is configured to be energized to transmit and/or receive radio frequency signals having a first frequency with a first wavelength λ₁ and having circular polarization in a first direction. The first patch conductor 310 may comprise a conductive layer formed or disposed on the second dielectric surface 308B of the first dielectric 308. For example, the first patch conductor 310 may comprise a conductive foil. The first patch conductor 310 may be generally rectangular in shape with opposing corners cut to effect circular polarization, but other configurations are contemplated.

In some examples, the first frequency is from 1500 megahertz to 1650 megahertz. More specifically, the first frequency may be from 1550 megahertz to 1625 megahertz. Additionally, the first direction may be right-handed circular polarization (RHCP). Accordingly, the first patch conductor 310 may be configured to transmit and/or receive radio frequency signals on one or more Global Navigation Satellite Systems (GNSS) including, but not limited to, the United States's Global Positioning System (GPS), Russia's Global Navigation Satellite System (GLONASS), China's BeiDou Navigation Satellite System, the European Union's Galileo Satellite System, and Japan's Quasi-Zenith Satellite System (QZSS). Of course, left-handed circular polarization and/or other frequencies are contemplated.

With continued reference to FIGS. 33-36, the patch antenna stack 306 further includes a second dielectric 312 extending between a third dielectric surface 312A and a fourth dielectric surface 312B opposite the third dielectric surface 312A. The third dielectric surface 312A is operatively connected to the first patch conductor 310. For example, the third dielectric surface 312A may be operatively connected to the first patch conductor 310 by being directly or indirectly adhered or otherwise fixed to the first patch conductor 310. The second dielectric 312 may comprise a suitable dielectric material such as a ceramic material. The patch antenna stack 306 further includes a second patch conductor 314 operatively connected to the fourth dielectric surface 312B of the second dielectric 312. For example, the second patch conductor 314 may be operatively connected to the fourth dielectric surface 312B by being directly or indirectly adhered or otherwise fixed to the fourth dielectric surface 312B. The second patch conductor 314 is configured to be energized to transmit and/or receive radio frequency signals having a second frequency with a second wavelength λ₂, higher than the first frequency, and having circular polarization in a second direction opposite the first direction. The second patch conductor 314 may comprise a conductive layer formed or disposed on the fourth dielectric surface 312B of the second dielectric 312. For example, the second patch conductor 314 may comprise a conductive foil. The second patch conductor 314 may be generally rectangular in shape with opposing corners cut to effect circular polarization, but other configurations are contemplated.

In some examples, the second frequency is from 2250 megahertz to 2400 megahertz. More specifically, the second frequency may be from 2310 megahertz to 2360 megahertz. Even more specifically, the second frequency may be from 2320 megahertz to 2345 megahertz. Additionally, the first direction may be left-handed circular polarization (LHCP). Accordingly, the second patch conductor 314 may be configured to transmit and/or receive radio frequency signals on Satellite Digital Audio Radio Services (SDARS) including, but not limited to, Sirius Satellite Radio and XM Satellite Radio. Of course, right-handed circular polarization and/or other frequencies are contemplated.

Still referring to FIGS. 33-36, the antenna assembly 300 may additionally include a first feeding assembly 316 for energizing the first patch conductor 310 and the second patch conductor 314 to transmit and/or receive radio frequency signals. For example, the first feeding assembly 316 may arrange the first patch conductor 310 and the second patch conductor 314 in electrical communication with the one or more circuits of the PCB 302 to energize the first patch conductor 310 and the second patch conductor 314 to transmit and/or receive radio frequency signals. It should be appreciated that in other configurations the first feeding assembly 316 is arranged such that the first patch conductor 310 and the second patch conductor 314 are in electrical communication with other circuitry outside of the antenna assembly 300 to energize the first patch conductor 310 and the second patch conductor 314 to transmit and/or receive radio frequency signals. For example, each of the first patch conductor 310 and the second patch conductor 314 may be arranged in electrical communication with a central conductor of a respective coaxial cable, and a ground shield of each respective coaxial cable may be arranged in electrical communication with the ground plane 304. It is also contemplated that the first feeding assembly 316 may include capacitive coupling elements to energize the first patch conductor 310 and/or the second patch conductor 314. It is further contemplated that the first feeding assembly 316 may include microstrip-type or lump-type impedance matching elements.

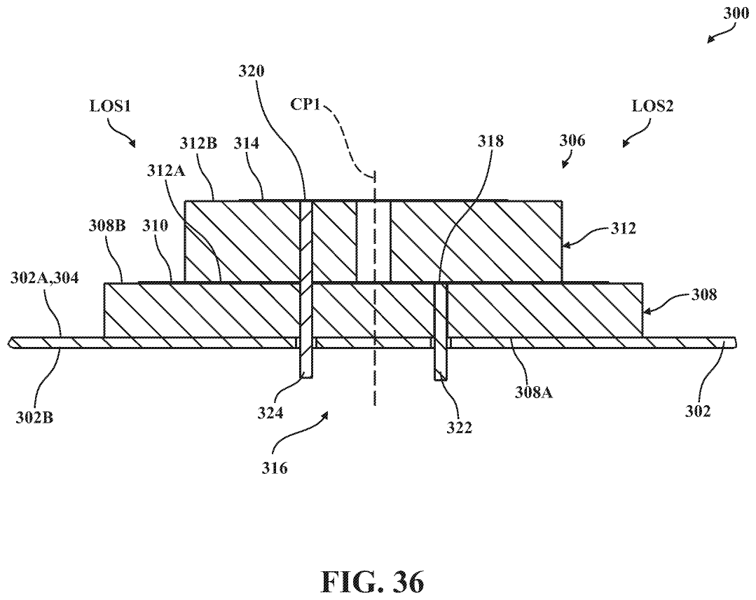

As best shown in FIG. 36, the first feeding assembly 316 may be operatively connected to the first patch conductor 310 at a first feeding point 318 and to the second patch conductor 314 at a second feeding point 320. In some examples, such as shown in FIG. 36, the first feeding point 318 is arranged on a first longitudinal side LOS1 of the first center plane CP1, and the second feeding point 320 is arranged on a second longitudinal side LOS2 of the first center plane CP1, opposite the first longitudinal side LOS1. In this configuration, the first feeding assembly 316 includes a first feeding member 322 extending through the ground plane 304 and the first dielectric 308 such that the first feeding member 322 is coupled to the first patch conductor 310 at the first feeding point 318 to energize the first patch conductor 310 to transmit and/or receive radio frequency signals having the first frequency and having circular polarization in the first direction. Additionally, this configuration also includes a second feeding member 324 extending through the ground plane 304, the first dielectric 308, the first patch conductor 310, and the second dielectric 312 such that the second feeding member 324 is coupled to the second patch conductor 314 at the second feeding point 320 point to energize the second patch conductor 314 to transmit and/or receive radio frequency signals having the second frequency and having circular polarization in the second direction.

Other configurations of operatively connecting the first feeding assembly 316 to the first patch conductor 310 at the first feeding point 318 and the second patch conductor 314 at the second feeding point 320 to energize the first patch conductor 310 and the second patch conductor 314 to transmit and/or receive radio frequency signals are contemplated.

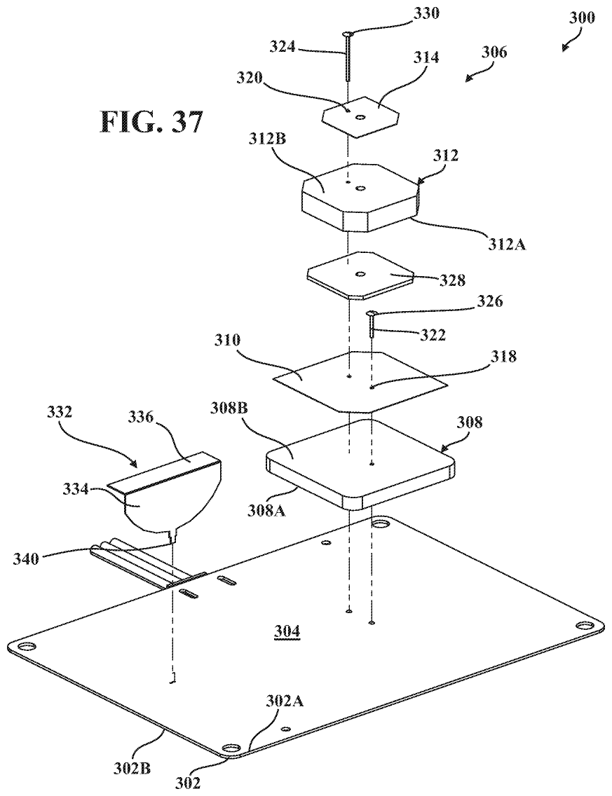

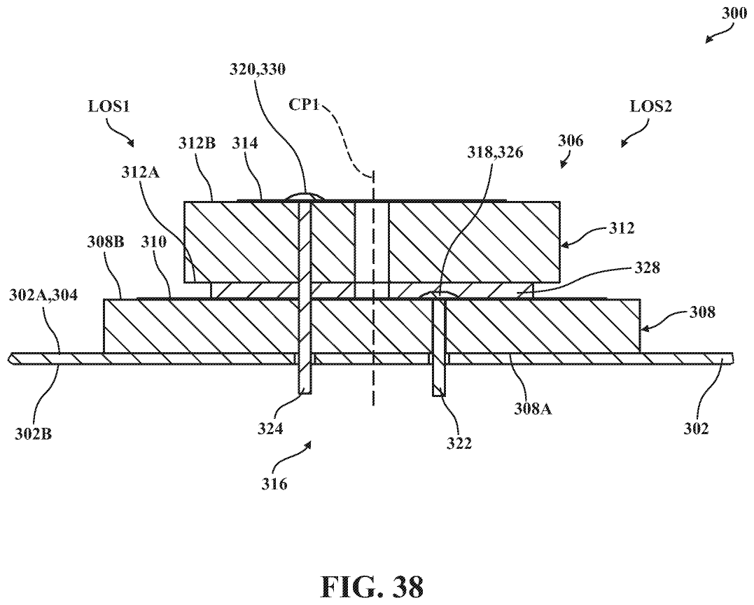

Referring to FIGS. 37 and 38, in some examples, the first feeding point 318 extends beyond the first patch conductor 310. For example, the first feeding point 318 as illustrated includes a first solder joint 326 operatively connecting the first feeding member 322 to the first patch conductor 310. In these examples, especially where the second dielectric 312 is a rigid material such as the ceramic material, the first solder joint 326 may cause the second dielectric 312 to be misaligned (i.e., not parallel) with the first patch conductor 310. Accordingly, the patch antenna stack 306 may further include a spacer 328 interposed between the first patch conductor 310 and the second dielectric 312. The spacer 328 is configured to deform (i.e., deflect) where the first feeding point 318 (particularly, the first solder joint 326) extends beyond the first patch conductor 310 such that the second dielectric 312 is arranged parallel to the first patch conductor 310. The spacer 328 may be comprised of a nonconductive material such as foam. The second feeding point 320 may similarly comprise a second solder joint 330 operatively connecting the second feeding member 324 to the second patch conductor 314. Other configurations of operatively connecting the first feeding member 322 to the first patch conductor 310 and the second feeding member 324 to the second patch conductor 314 are contemplated.

The antenna assembly 300 further includes a monopole radiating element 332. As best shown in FIG. 33, in the present embodiment, the monopole radiating element 332 includes a first portion 334 and a second portion 336. The first portion 334 extends perpendicularly from the ground plane 304. The second portion 336 is coupled to and extends from the first portion 334. For example, the second portion 336 may extend perpendicularly from the first portion 334, but other configurations are contemplated. The second portion 336 may be spaced from the ground plane 304. For example, the second portion 336 may be coupled to a top edge 334A of the first portion 334 and extend parallel to the ground plane 304. Here, the second portion 336 may function to reduce the height of the monopole radiating element 332 and/or alter the radiation pattern of monopole radiating element 332 such that the monopole radiating element 332 has different linear polarization components (i.e., horizontal polarization components and vertical polarization components) and/or increased directionality compared to a conventional monopole radiating element. The monopole radiating element 332 is configured to be energized to transmit and/or receive radio frequency signals having linear polarization. The monopole radiating element 332 may be configured to transmit and/or receive radio frequency signals having a frequency of from 600 megahertz to 6 gigahertz. Accordingly, the monopole radiating element 332 may be configured to transmit and/or receive radio frequency signals on 4G LTE, 5G sub-6 GHz networks, and any other current and future cellular networks falling within the 600 megahertz to 6 gigahertz frequency range. Other networks falling within the 600 megahertz to 6 gigahertz frequency range are also contemplated, such as V2X networks and Wi-Fi. The operative frequency of the monopole radiating element 332 may also be expressed as a third wavelength λ₃. In some examples, the monopole radiating element 332 has a height and/or width of less than of λ₃/4. To accommodate the large range of frequencies, the monopole radiating element 332 generally comprises a wideband monopole, such as a partially circular monopole. Other arrangements and configurations of the monopole radiating element 332 including the first portion 334 and the second portion 336 are contemplated. For example, the monopole radiating element 332 may include additional projections and/or define slots to achieve desired tuning.

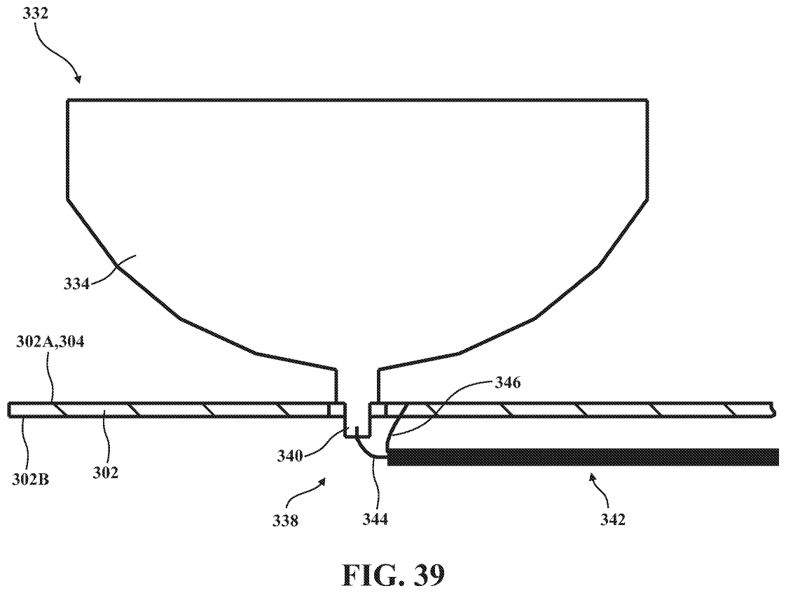

The antenna assembly 300 may also include a second feeding assembly 338 operatively connected to the monopole radiating element 332 at a third feeding point 340 for energizing the monopole radiating element 332 to transmit and/or receive radio frequency signals. In one example, referring to FIG. 39, the second feeding assembly 338 includes a coaxial cable 342. The coaxial cable 342 may include a central conductor 344 arranged in electrical communication with the monopole radiating element 332 at the third feeding point 340 and a ground shield 346 arranged in electrical communication with the ground plane 304 to energize the monopole radiating element 332 to transmit and/or receive radio frequency signals. Other configurations of the second feeding assembly 338 are contemplated. For example, the third feeding point 340 may be arranged in electrical communication with the one or more circuits of the PCB 302 to energize the monopole radiating element 332 to transmit and/or receive radio frequency signals. It is also contemplated that the second feeding assembly 338 may include capacitive coupling elements to energize the monopole radiating element 332 to transmit and/or receive radio frequency signals. It is further contemplated that the second feeding assembly 338 may include microstrip-type or lump-type impedance matching elements.

As best shown in FIG. 35, the patch antenna stack 306 and the monopole radiating element 332 may be arranged relative to each other on their common ground plane 304 such that there is minimal interference with each other. It should be appreciated that the width W and the length L of the ground plane 304 may each independently be at least λ₁/2 to ensure adequate gain and/or directionality of the first patch conductor 310 and the second patch conductor 314. In some examples, the width W and the length L may each be independently be greater than 70 mm, greater than 75 mm, greater than 80 mm, greater than 85 mm, greater than 90 mm, greater than 100 mm, greater than 105 mm, greater than 110 mm, greater than 115 mm, greater than 120 mm, or even greater than 125 mm. Additionally, in some configurations the patch antenna stack 306 is centered on the ground plane 304 in the lateral direction X such that the patch antenna stack 306 is arranged such that the first center plane CP1 bisects the patch antenna stack 306. Additionally, the first dielectric 308 may define a first longitudinal surface 308C transverse to the ground plane 304, and a second longitudinal surface 308D opposite the first longitudinal surface 308C. Here, the first longitudinal surface 308C may be coplanar with the second center plane CP2. To space the patch antenna stack 306 and the monopole radiating element 332 from each other, the monopole radiating element 332 may be arranged on a first lateral side LAS1 of the second center plane CP2, and the patch antenna stack 306 may be arranged on a second lateral side LAS2 of the second center plane CP2 opposite the first lateral side LAS1. The first feeding point 318 and/or the second feeding point 320 may be spaced from the third feeding point 340 by at least λ₂/2 to ensure adequate isolation between the monopole radiating element 332 and the patch antenna stack 306. Also, in some examples, the monopole radiating element 332 is coplanar with the first center plane CP1.

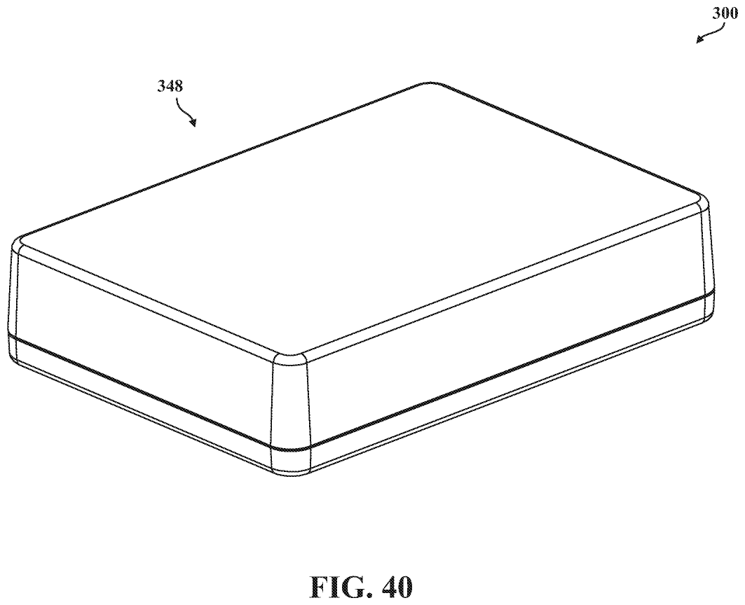

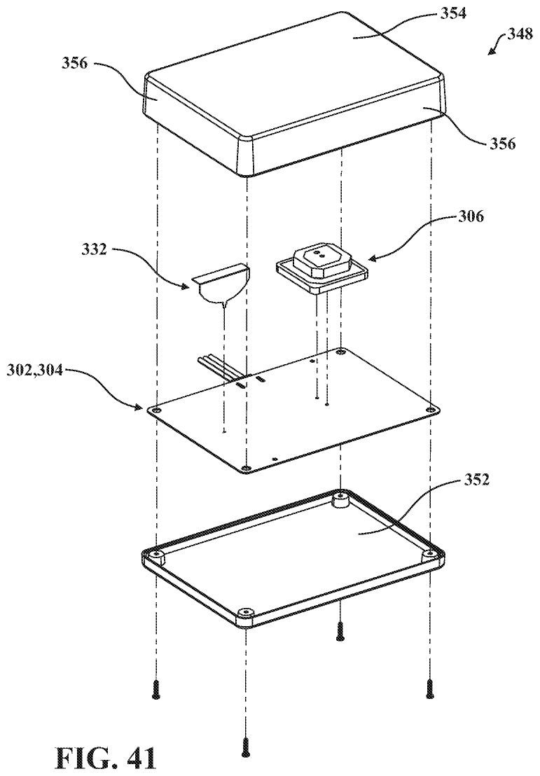

Referring to FIGS. 40-47, the antenna assembly 300 may further comprise a housing 348. The housing 348 defines a housing interior 350 bounded by a bottom wall 352, a top wall 354 parallel to and spaced from the bottom wall 352, and a plurality of side walls 356 extending between the bottom wall 352 and the top wall 354. As best shown in FIGS. 41 and 43, the antenna assembly 300 may be disposed within the housing interior 350 such that the top surface 302A of the PCB 302 faces the top wall 354 of the housing 348. The antenna assembly 300 may also be arranged within the housing interior 350 such that the second patch conductor 314 is spaced from the top wall 354 to define a gap 358 therebetween. The gap 358 may be filled with air or another dielectric material. The housing 348 may be made of a material having a low permittivity (ϵr). For example, the permittivity (ϵr) may range from greater than 1 to less than 4. Exemplary materials having low permittivity (ϵr) include, but are not limited to, plastics such as acrylonitrile styrene acrylate (ASA) and acrylonitrile butadiene styrene (ABS).

The housing 348 may be configured to be coupled to a vehicle 98. If included, the housing 348 should generally be arranged in a manner that a conductive member of a vehicle (e.g. a metal body panel) does not obstruct radio frequency signals from emanating upwards toward the sky. In one example, the housing 348 may be configured to be coupled to a nonconductive pane 360 of a vehicle 98. The term “nonconductive” refers to a material, such as an insulator or dielectric, that when placed between conductors at different potentials, permits only a small or negligible current in phase with the applied voltage to flow through material. Typically, nonconductive materials have conductivities on the order of nanosiemens/meter. In some examples, the nonconductive pane 360 is implemented as at least one pane of glass. Where the nonconductive pane 360 is implemented as glass, the nonconductive pane 360 may be comprised of any suitable glass composition including, but not limited to, soda-lime glass, aluminosilicate glass, borosilicate glass, boro-aluminosilicate glass, and the like. Of course, the nonconductive pane 360 may include more than one pane of glass. Those skilled in the art, however, realize that the nonconductive pane 360 may be formed from plastic, fiberglass, or other suitable nonconductive materials.

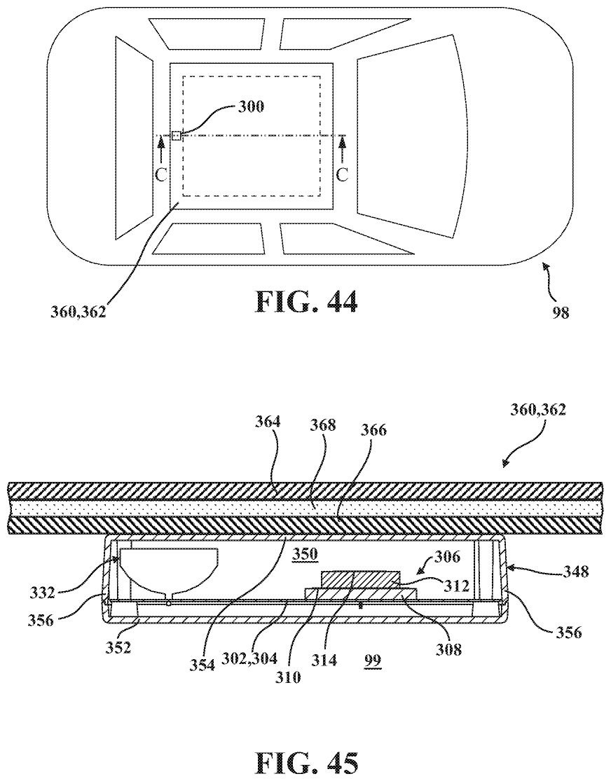

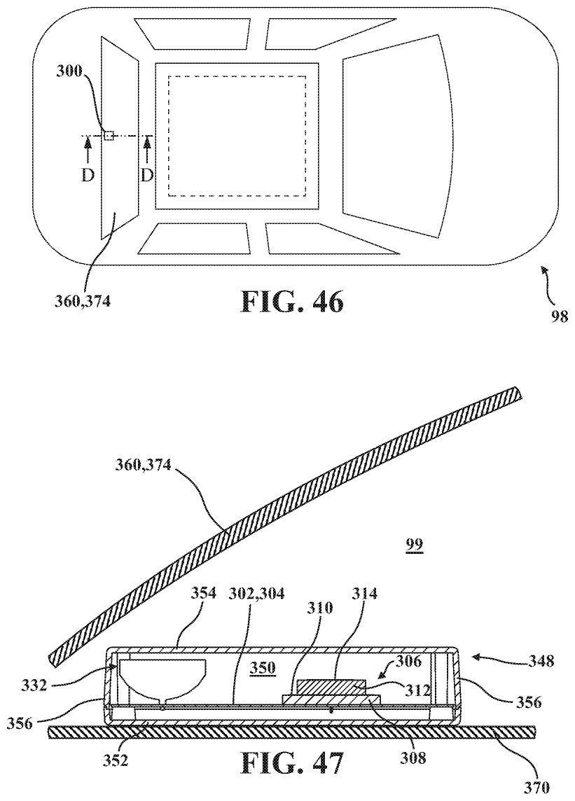

FIGS. 44 and 45 show the top wall 354 of the housing 348 coupled to a roof glass 362 of a vehicle 98 such that the antenna assembly 300 is arranged substantially horizontal (and thus facing the sky). Here, the roof glass 362 is a laminated glazing including an outer glass substrate 364 having an outer surface (P1) and an opposing inner surface (P2), an inner glass substrate 366 having an inner surface (P3) and an opposing outer surface (P4), and a polymeric interlayer 368 disposed between the P2 surface of the outer glass substrate 364 and the P3 surface of the inner glass substrate 366. In this case, the top wall 354 of the housing 348 is coupled (either directly or indirectly) to the P4 surface. It is also contemplated that the nonconductive pane 360 may be a single pane of glass (rather than a laminated glazing) such as a side window or a rear window of a vehicle. In these cases, the housing 348 may be configured to be coupled to the nonconductive pane 360 at an angle such that the antenna assembly 300 is still arranged substantially horizontal (and thus facing the sky). It is further contemplated that the housing 348 may be coupled to nonconductive panes other than glass, such as fiberglass or composite body panels (e.g. a trunk lids, mirror housings, fenders, quarter panels, spoilers, etc.). The housing 348 may also be configured to be arranged within an interior compartment 99 of a vehicle 98. Referring to FIGS. 46 and 47, in one example, the housing 348 may be arranged on a luggage rack 370 below the rear window 374 of the vehicle such that the antenna assembly 300 is arranged substantially horizontal (and thus facing the sky). Of course, other locations for arranging the housing 348 (and, thus, the antenna assembly 300) within an interior compartment 99 of a vehicle 98 are contemplated.

### Fourth Embodiment

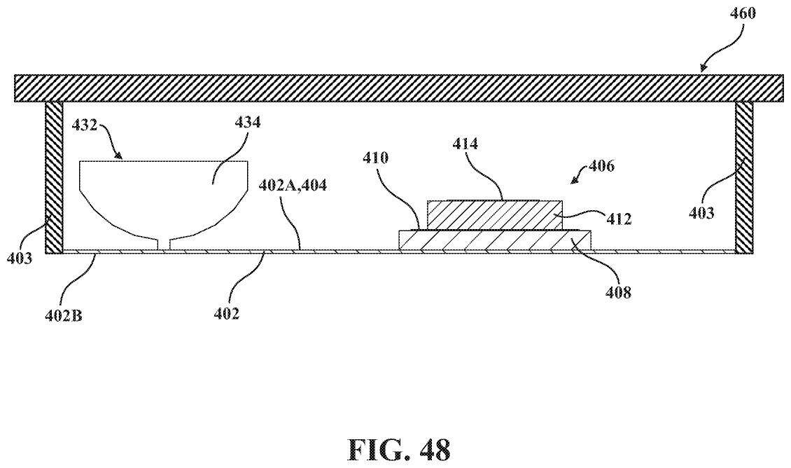

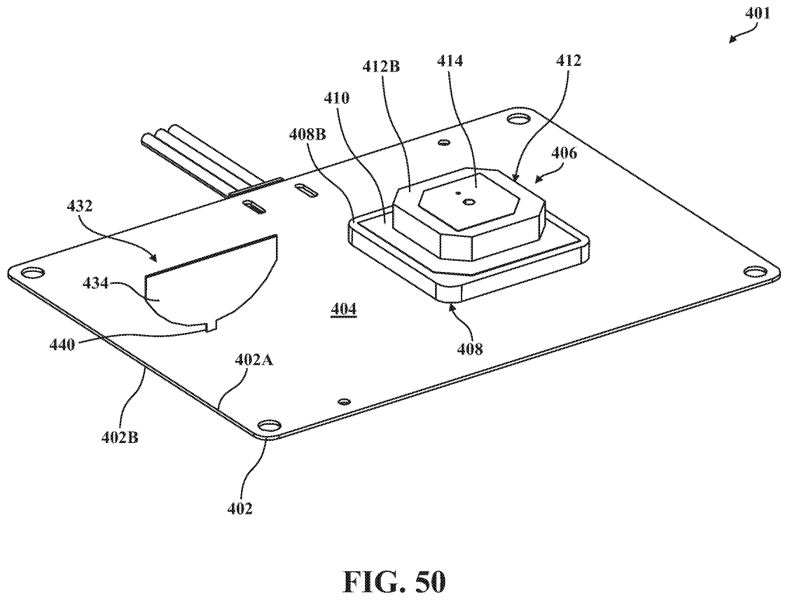

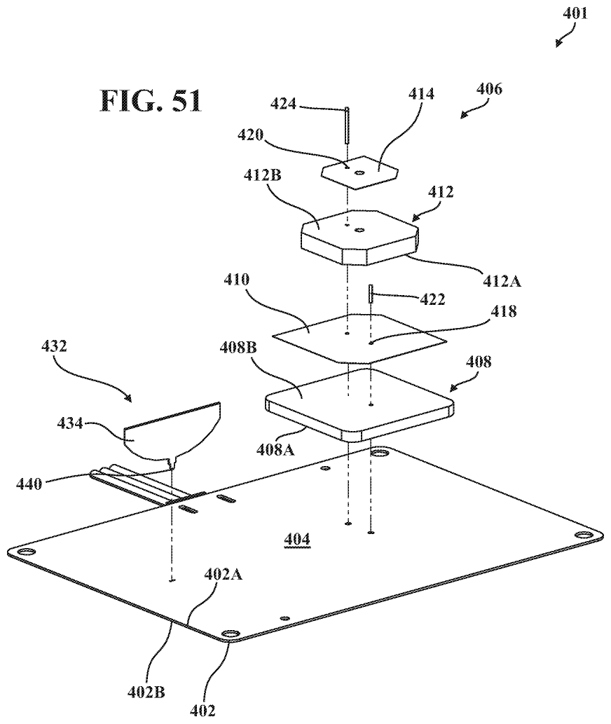

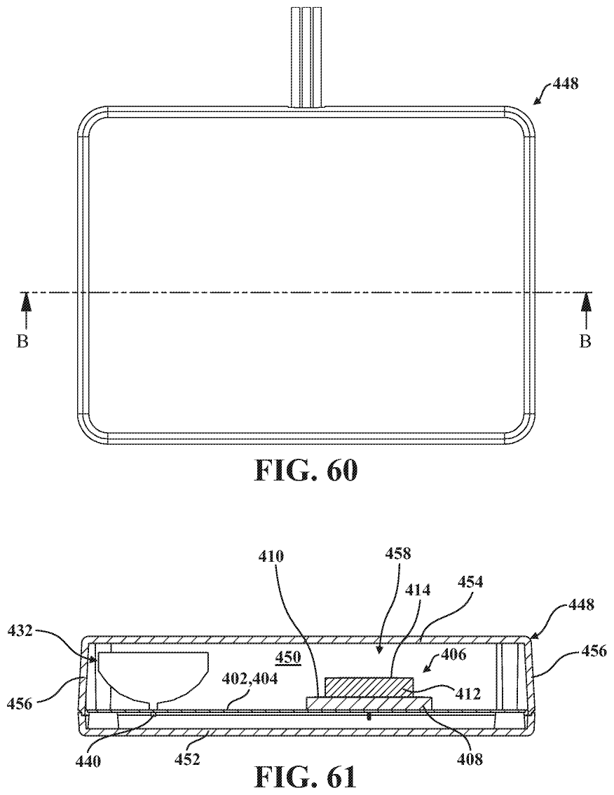

FIGS. 48-65 illustrate an embodiment of a window assembly 400 for a vehicle 98. The window assembly 400 may be used in an automotive context as a window for a vehicle 98, such as a windshield, side window, quarter window, rear window, roof window, and the like.

The window assembly 400 includes a nonconductive pane 460. The term “nonconductive” refers to a material, such as an insulator or dielectric, that when placed between conductors at different potentials, permits only a small or negligible current in phase with the applied voltage to flow through material. Typically, nonconductive materials have conductivities on the order of nanosiemens/meter.

In some examples, the nonconductive pane 460 is implemented as at least one pane of glass. Where the nonconductive pane 460 is implemented as glass, the nonconductive pane 460 may be comprised of any suitable glass composition including, but not limited to, soda-lime glass, aluminosilicate glass, borosilicate glass, boro-aluminosilicate glass, and the like. Those skilled in the art realize that the nonconductive pane 460 may be formed from polymeric materials such as polymethyl methacrylate, polycarbonate, polyvinyl butyral, or the like.

The nonconductive pane 460 may have a thickness T1. For example, the thickness T1 of the nonconductive pane 460 may be from about 0.3 mm to about 4.1 mm. More specifically, the thickness T1 may be about 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm. 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, 3.1 mm, 3.2 mm, 3.3 mm, 3.4 mm, 3.5 mm, 3.6 mm, 3.7 mm, 3.8 mm, 3.9 mm, 4.0 mm, or 4.1 mm.

In some examples, the nonconductive pane 460 is transparent. In this context, the term “transparent”, also referred to as “substantially transparent”, refers to a material that allows 70% or more of light transmission in a predefined visible light range to travel therethrough. Unless otherwise indicated, the predefined visible light range is the segment of the electromagnetic spectrum that the human eye can view. More simply, this range of wavelengths is called visible light. Typically, the human eye can detect wavelengths from about 380 to about 780 nanometers, and thus the predefined visible light range as defined herein refers to wavelengths of light from about 380 to about 780 nanometers unless otherwise indicated. In some examples, the nonconductive pane 460 may include various additives to alter the transmissivity of the nonconductive pane 460; for example, additives may provide various levels of tint or coloration while still maintaining the nonconductive pane 460 as “transparent” or “substantially transparent” as described above.

In other examples, the nonconductive pane 460 is not transparent as described above. For example, where the window assembly 400 is a privacy glass, the transparency of the nonconductive pane 460 may be substantially reduced, and thus the window assembly 400 allows less than 70% light transmission in a predefined wavelength range, such as from greater than 0 to 70% light transmission at the predefined wavelength range.

In some examples, the nonconductive pane 460 is formed as a laminated glazing, such as a roof glass 462, windshield, or the like. In these examples, the laminated nonconductive pane 460 includes an outer glass substrate 464 having an outer surface (P1) and an opposing inner surface (P2), an inner glass substrate 466 having an inner surface (P3) and an opposing outer surface (P4), and a polymeric interlayer 468 disposed between the P2 surface of the outer glass substrate 464 and the P3 surface of the inner glass substrate 466. The outer glass substrate 464 and the inner glass substrate 464 may be comprised of any suitable glass composition including, but not limited to, soda-lime glass, aluminosilicate glass, borosilicate glass, boro-aluminosilicate glass, and the like. It should be appreciated that the outer glass substrate 464 and the inner glass substrate 464 may be comprised of the same or different glass compositions.

The outer glass substrate 464 may have a thickness T1, and the inner glass substrate 466 may have a thickness T2. The thicknesses T1, T2 of the outer glass substrate 464 and the inner glass substrate 466, respectively, may be any suitable thickness for the application. For example, the thicknesses T1, T2 of the outer glass substrate 464 and the inner glass substrate 466, respectively, may be from about 0.3 mm to about 4.1 mm. More specifically, the thicknesses T1, T2, may each be about 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm. 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, 3.1 mm, 3.2 mm, 3.3 mm, 3.4 mm, 3.5 mm, 3.6 mm, 3.7 mm, 3.8 mm, 3.9 mm, 4.0 mm, or 4.1 mm. It should be appreciated that the thickness T1 and the thickness T2 can be the same or different. In one example, the outer glass substrate 464 and the inner glass substrate 466 have the same thickness (i.e., where T1 is equal to T2) such that the nonconductive pane 460 is considered a “symmetric” laminate. However, in another example, the outer glass substrate 464 and the inner glass substrate 466 have different thicknesses (i.e., where T1 is not equal to T2) such that the nonconductive pane 460 is considered an “asymmetric” laminate. All combinations of the example T1 and T2 values listed above and all fractional values therebetween are contemplated.

The polymeric interlayer 468 bonds the outer glass substrate 464 and the inner glass substrate 466 such that the polymeric interlayer 468 retains the outer glass substrate 464 and/or the inner glass substrate 466 in the event of impact or breakage of the nonconductive pane 460. The polymeric interlayer 468 includes a polymer or thermoplastic resin, such as polyvinyl butyral (PVB), ethylene-vinyl acetate (EVA), thermoplastic polyurethane (TPU), and the like. Other suitable materials for implementing the polymeric interlayer 468 may be utilized that provide the requisite performance characteristics regarding optical haze, adhesion to glass, and structural rigidity. Similar to the outer glass substrate 464 and the inner glass substrate 466, the polymeric interlayer 468 is also substantially transparent or otherwise transparent to light. Accordingly, the nonconductive pane 460 that includes the polymeric interlayer 468 between the outer glass substrate 464 and the inner glass substrate 466 is also substantially transparent or otherwise transparent to light. It should be appreciated that the polymeric interlayer 468 may be less transparent before being subjected to a lamination process to bond the polymeric interlayer 468 to each of the layers adjacent to the polymeric interlayer 468 to form the nonconductive pane 460.

The window assembly 400 according to the present embodiment also includes an antenna assembly 401 according to the present disclosure. Referring first to FIGS. 48-52, the antenna assembly 401 includes a PCB 402 including a top surface 402A and a bottom surface 402B opposite the top surface 402A. The PCB 402 typically includes one or more circuits configured to be arranged in electrical communication with the antenna assembly 401 to operate the antenna assembly 401 to transmit and/or receive radio frequency signals. The antenna assembly 401 also includes a ground plane 404 disposed on the top surface 402A of the PCB 402. Although not required, the ground plane 404 may comprise a metallization layer formed or disposed on the top surface 402A of the PCB 402. The metallization layer may comprise a copper foil or the like.

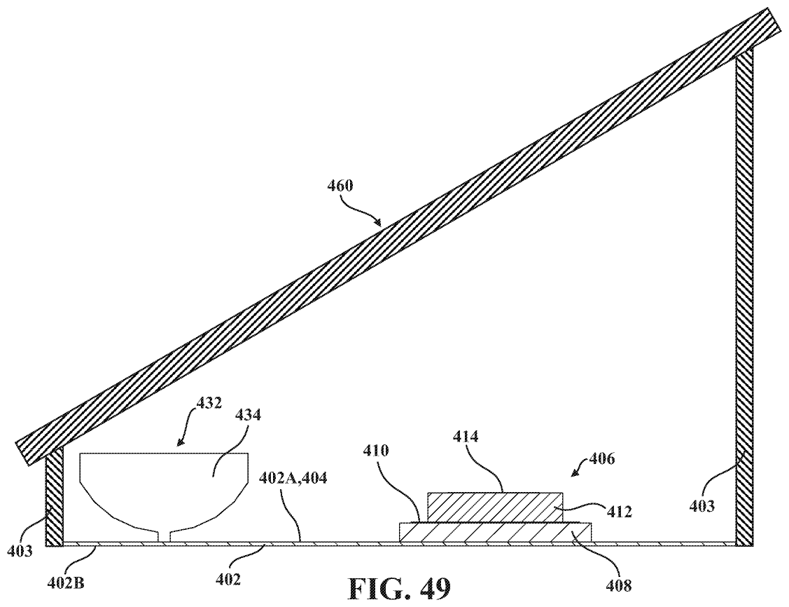

As shown in FIGS. 48 and 49, the PCB 402 is spaced from the nonconductive pane 460 and the top surface 402A of the PCB 402 is arranged to at least partially face the nonconductive pane 460. For example, as shown schematically in FIGS. 48 and 49, the PCB 402 may be coupled to the nonconductive pane 460 via coupling elements 403 extending between the nonconductive pane 460 and the PCB 402. Other arrangements of arranging the PCB 402 in a spaced relationship with the nonconductive pane are contemplated, including, but not limited to, the housing 448 described below. In any event, the antenna assembly 401 may be arranged substantially horizontal (and thus facing the sky) such that the antenna assembly 401 is configured to transmit and/or receive upwards towards/from the sky. The antenna assembly 401 should generally be arranged relative to the nonconductive pane 460 in a manner that a conductive member of a vehicle (e.g. a metal body panel) does not obstruct radio frequency signals transmitted and/or received by the antenna assembly 401 from emanating upwards toward the sky. Accordingly, the ground plane 404 may be arranged parallel to the nonconductive pane 460 (such as shown in FIG. 48, where the nonconductive pane 460 is substantially horizontal), or the ground plane 404 may be arranged non-parallel to the nonconductive pane 460 (such as shown in FIG. 49, where the nonconductive pane is not substantially horizontal).

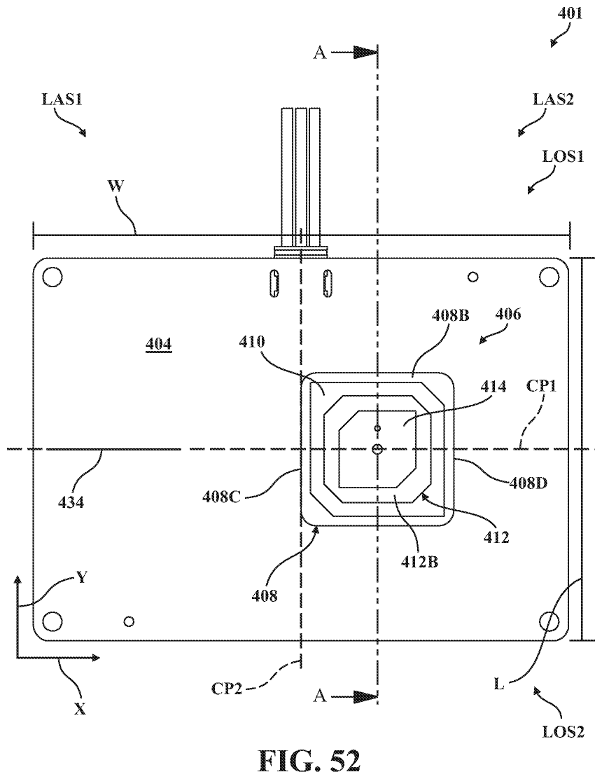

The ground plane 404 may be generally rectangular in shape and have a width W in a lateral direction (X), and a length L in a longitudinal direction (Y) transverse to the lateral direction (X). Additionally, as best shown in FIG. 52, the ground plane 404 may define a first center plane CP1 bisecting the ground plane 404 in the lateral direction (X) and a second center plane CP2 bisecting the ground plane 404 in the longitudinal direction (Y).

As best shown in FIGS. 48-53, the antenna assembly 401 further includes a patch antenna stack 406. The patch antenna stack 406 includes a first dielectric 408 extending between a first dielectric surface 408A and a second dielectric surface 408B opposite the first dielectric surface 408A. The first dielectric surface 408A is operatively connected to the ground plane 404. For example, the first dielectric surface 408A may be operatively connected to the ground plane 404 by being directly or indirectly adhered or otherwise fixed to the ground plane 404. The first dielectric 408 may comprise a suitable dielectric material such as a ceramic material. The patch antenna stack 406 also includes a first patch conductor 410 operatively connected to the second dielectric surface 408B of the first dielectric 408. For example, first patch conductor 410 may be operatively connected to the second dielectric surface 408B by being directly or indirectly adhered or otherwise fixed to the second dielectric surface 408B. The first patch conductor 410 is configured to be energized to transmit and/or receive radio frequency signals having a first frequency with a first wavelength λ₁ and having circular polarization in a first direction. The first patch conductor 410 may comprise a conductive layer formed or disposed on the second dielectric surface 408B of the first dielectric 408. For example, the first patch conductor 410 may comprise a conductive foil. The first patch conductor 410 may be generally rectangular in shape with opposing corners cut to effect circular polarization, but other configurations are contemplated.

In some examples, the first frequency is from 1500 megahertz to 1650 megahertz. More specifically, the first frequency may be from 1550 megahertz to 1625 megahertz. Additionally, the first direction may be right-handed circular polarization (RHCP). Accordingly, the first patch conductor 410 may be configured to transmit and/or receive radio frequency signals on one or more Global Navigation Satellite Systems (GNSS) including, but not limited to, the United States's Global Positioning System (GPS), Russia's Global Navigation Satellite System (GLONASS), China's BeiDou Navigation Satellite System, the European Union's Galileo Satellite System, and Japan's Quasi-Zenith Satellite System (QZSS). Of course, left-handed circular polarization and/or other frequencies are contemplated.

With continued reference to FIGS. 48-53, the patch antenna stack 406 further includes a second dielectric 412 extending between a third dielectric surface 412A and a fourth dielectric surface 412B opposite the third dielectric surface 412A. The third dielectric surface 412A is operatively connected to the first patch conductor 410. For example, the third dielectric surface 412A may be operatively connected to the first patch conductor 410 by being directly or indirectly adhered or otherwise fixed to the first patch conductor 410. The second dielectric 412 may comprise a suitable dielectric material such as a ceramic material. The patch antenna stack 406 further includes a second patch conductor 414 operatively connected to the fourth dielectric surface 412B of the second dielectric 312. For example, the second patch conductor 314 may be operatively connected to the fourth dielectric surface 412B by being directly or indirectly adhered or otherwise fixed to the fourth dielectric surface 412B. The second patch conductor 414 is configured to be energized to transmit and/or receive radio frequency signals having a second frequency with a second wavelength λ₂, higher than the first frequency, and having circular polarization in a second direction opposite the first direction. The second patch conductor 414 may comprise a conductive layer formed or disposed on the fourth dielectric surface 412B of the second dielectric 412. For example, the second patch conductor 414 may comprise a conductive foil. The second patch conductor 414 may be generally rectangular in shape with opposing corners cut to effect circular polarization, but other configurations are contemplated.

In some examples, the second frequency is from 2250 megahertz to 2400 megahertz. More specifically, the second frequency may be from 2310 megahertz to 2360 megahertz. Even more specifically, the second frequency may be from 2320 megahertz to 2345 megahertz. Additionally, the first direction may be left-handed circular polarization (LHCP). Accordingly, the second patch conductor 414 may be configured to transmit and/or receive radio frequency signals on Satellite Digital Audio Radio Services (SDARS) including, but not limited to, Sirius Satellite Radio and XM Satellite Radio. Of course, right-handed circular polarization and/or other frequencies are contemplated.

Still referring to FIGS. 48-53, the antenna assembly 401 may additionally include a first feeding assembly 416 for energizing the first patch conductor 410 and the second patch conductor 414 to transmit and/or receive radio frequency signals. For example, the first feeding assembly 416 may arrange the first patch conductor 410 and the second patch conductor 414 in electrical communication with the one or more circuits of the PCB 402 to energize the first patch conductor 410 and the second patch conductor 414 to transmit and/or receive radio frequency signals. It should be appreciated that in other configurations the first feeding assembly 416 is arranged such that the first patch conductor 410 and the second patch conductor 414 are in electrical communication with other circuitry outside of the antenna assembly 401 to energize the first patch conductor 410 and the second patch conductor 414 to transmit and/or receive radio frequency signals. For example, each of the first patch conductor 410 and the second patch conductor 414 may be arranged in electrical communication with a central conductor of a respective coaxial cable, and a ground shield of each respective coaxial cable may be arranged in electrical communication with the ground plane 404. It is also contemplated that the first feeding assembly 416 may include capacitive coupling elements to energize the first patch conductor 410 and/or the second patch conductor 414. It is further contemplated that the first feeding assembly 416 may include microstrip-type or lump-type impedance matching elements.

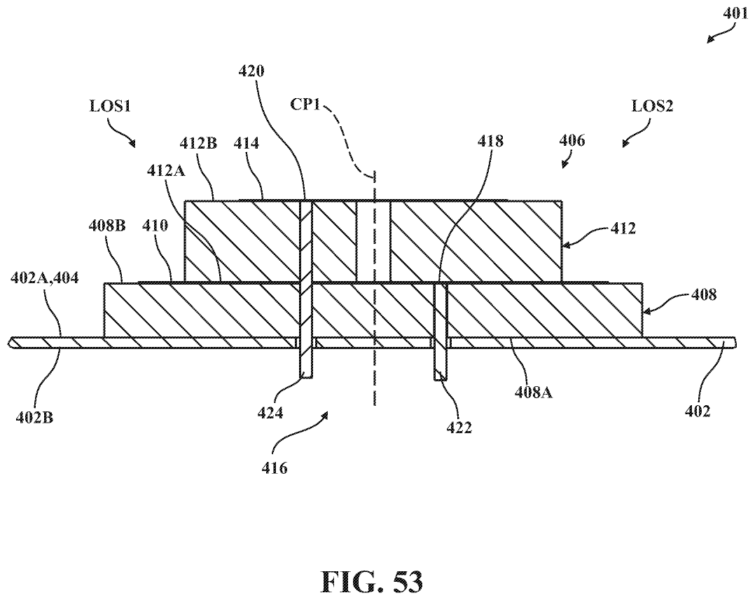

As best shown in FIG. 53, the first feeding assembly 416 may be operatively connected to the first patch conductor 410 at a first feeding point 418 and to the second patch conductor 414 at a second feeding point 420. In some examples, such as shown in FIG. 53, the first feeding point 418 is arranged on a first longitudinal side LOS1 of the first center plane CP1, and the second feeding point 420 is arranged on a second longitudinal side LOS2 of the first center plane CP1, opposite the first longitudinal side LOS1. In this configuration, the first feeding assembly 416 includes a first feeding member 422 extending through the ground plane 404 and the first dielectric 408 such that the first feeding member 422 is coupled to the first patch conductor 410 at the first feeding point 418 to energize the first patch conductor 410 to transmit and/or receive radio frequency signals having the first frequency and having circular polarization in the first direction. Additionally, this configuration also includes a second feeding member 424 extending through the ground plane 404, the first dielectric 408, the first patch conductor 410, and the second dielectric 412 such that the second feeding member 424 is coupled to the second patch conductor 414 at the second feeding point 420 point to energize the second patch conductor 414 to transmit and/or receive radio frequency signals having the second frequency and having circular polarization in the second direction.

Other configurations of operatively connecting the first feeding assembly 416 to the first patch conductor 410 at the first feeding point 418 and the second patch conductor 414 at the second feeding point 420 to energize the first patch conductor 410 and the second patch conductor 414 to transmit and/or receive radio frequency signals are contemplated.

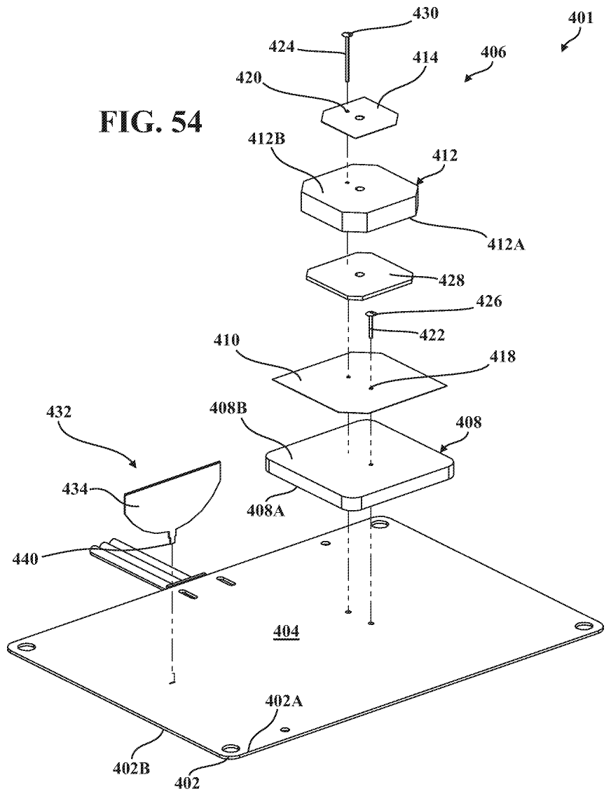

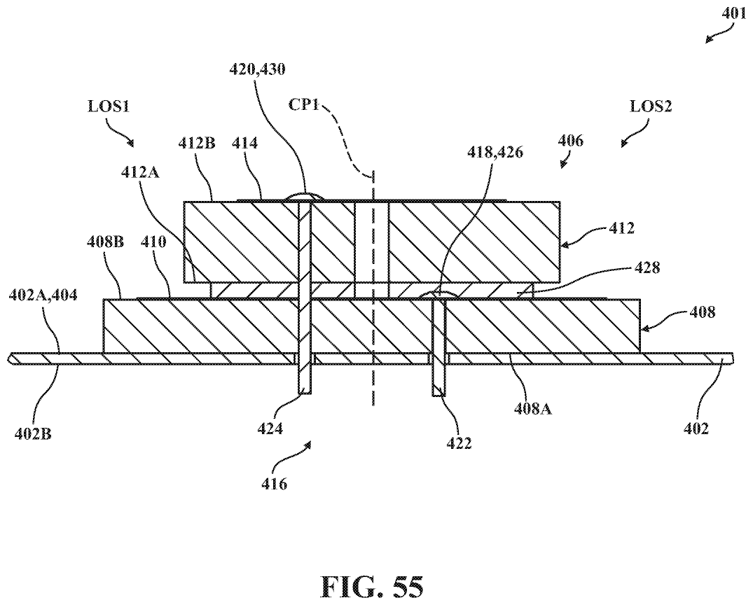

Referring to FIGS. 54 and 55, in some examples, the first feeding point 418 extends beyond the first patch conductor 410. For example, the first feeding point 418 as illustrated includes a first solder joint 426 operatively connecting the first feeding member 422 to the first patch conductor 410. In these examples, especially where the second dielectric 412 is a rigid material such as the ceramic material, the first solder joint 426 may cause the second dielectric 412 to be misaligned (i.e., not parallel) with the first patch conductor 410. Accordingly, the patch antenna stack 406 may further include a spacer 428 interposed between the first patch conductor 410 and the second dielectric 412. The spacer 428 is configured to deform (i.e., deflect) where the first feeding point 418 (particularly, the first solder joint 426) extends beyond the first patch conductor 410 such that the second dielectric 412 is arranged parallel to the first patch conductor 410. The spacer 428 may be comprised of a nonconductive material such as foam. The second feeding point 420 may similarly comprise a second solder joint 430 operatively connecting the second feeding member 424 to the second patch conductor 414. Other configurations of operatively connecting the first feeding member 422 to the first patch conductor 410 and the second feeding member 424 to the second patch conductor 414 are contemplated.

The antenna assembly 401 further includes a monopole radiating element 432 including a first portion 434 extending perpendicularly from the ground plane 404. The monopole radiating element 432 is configured to be energized to transmit and/or receive radio frequency signals having linear polarization. The monopole radiating element 432 may be configured to transmit and/or receive radio frequency signals having a frequency of from 600 megahertz to 6 gigahertz. Accordingly, the monopole radiating element 432 may be configured to transmit and/or receive radio frequency signals on 4G LTE, 5G sub-6 GHz networks, and any other current and future cellular networks falling within the 600 megahertz to 6 gigahertz frequency range. Other networks falling within the 600 megahertz to 6 gigahertz frequency range are also contemplated, such as V2X networks and Wi-Fi. The operative frequency of the monopole radiating element 432 may also be expressed as a third wavelength λ₃. In some examples, the monopole radiating element 432 has a height and/or width of less than of λ₃/4. To accommodate the large range of frequencies, the monopole radiating element 432 generally comprises a wideband monopole, such as a partially circular monopole. Other geometrical shapes of the monopole radiating element 432 are contemplated. Additionally, it is also contemplated that the monopole radiating element 432 may include additional projections and/or define slots to achieve desired tuning.

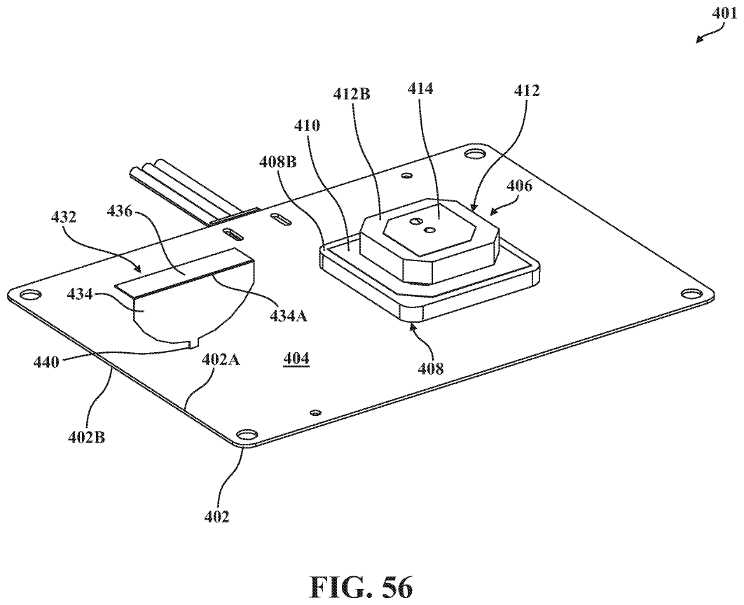

In one example, referring to FIG. 56, the monopole radiating element 432 further includes a second portion 436. If included, the second portion 436 is typically coupled to and extends from the first portion 434. For example, the second portion 436 may extend perpendicularly from the first portion 434, but other configurations are contemplated. The second portion 436 may be spaced from the ground plane 404. For example, the second portion 436 may be coupled to a top edge 434A of the first portion 434 and extend parallel to the ground plane 404. Here, the second portion 436 may function to reduce the height of the monopole radiating element 432 and/or alter the radiation pattern of monopole radiating element 432 such that the monopole radiating element 432 has different linear polarization components (i.e., horizontal polarization components and vertical polarization components) and/or increased directionality. Other arrangements and configurations of the monopole radiating element 432 are contemplated.

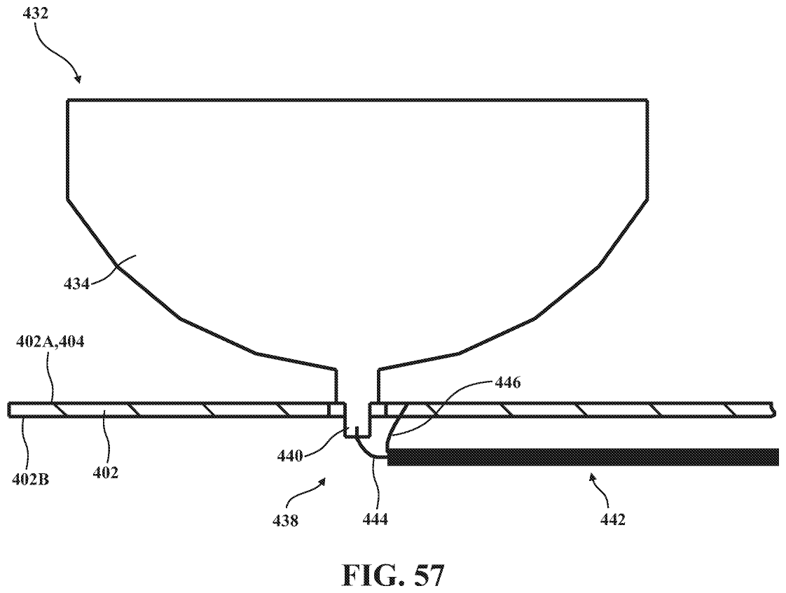

The antenna assembly 401 may also include a second feeding assembly 438 operatively connected to the monopole radiating element 432 at a third feeding point 440 for energizing the monopole radiating element 432 to transmit and/or receive radio frequency signals. In one example, referring to FIG. 57, the second feeding assembly 438 includes a coaxial cable 442. The coaxial cable 442 may include a central conductor 444 arranged in electrical communication with the monopole radiating element 432 at the third feeding point 440 and a ground shield 446 arranged in electrical communication with the ground plane 404 to energize the monopole radiating element 432 to transmit and/or receive radio frequency signals. Other configurations of the second feeding assembly 438 are contemplated. For example, the third feeding point 440 may be arranged in electrical communication with the one or more circuits of the PCB 402 to energize the monopole radiating element 432 to transmit and/or receive radio frequency signals. It is also contemplated that the second feeding assembly 438 may include capacitive coupling elements to energize the monopole radiating element 432 to transmit and/or receive radio frequency signals. It is further contemplated that the second feeding assembly 438 may include microstrip-type or lump-type impedance matching elements.

As best shown in FIG. 52, the patch antenna stack 406 and the monopole radiating element 432 may be arranged relative to each other on their common ground plane 404 such that there is minimal interference with each other. It should be appreciated that the width W and the length L of the ground plane 404 may each independently be at least λ₁/2 to ensure adequate gain and/or directionality of the first patch conductor 410 and the second patch conductor 414. In some examples, the width W and the length L may each independently be greater than 70 mm, greater than 75 mm, greater than 80 mm, greater than 85 mm, greater than 90 mm, greater than 100 mm, greater than 105 mm, greater than 110 mm, greater than 115 mm, greater than 120 mm, or even greater than 125 mm. Additionally, in some configurations the patch antenna stack 406 is centered on the ground plane 404 in the lateral direction X such that the patch antenna stack 406 is arranged such that the first center plane CP1 bisects the patch antenna stack 406. Additionally, the first dielectric 408 may define a first longitudinal surface 408C transverse to the ground plane 404, and a second longitudinal surface 408D opposite the first longitudinal surface 408C. Here, the first longitudinal surface 408C may be coplanar with the second center plane CP2. To space the patch antenna stack 406 and the monopole radiating element 432 from each other, the monopole radiating element 432 may be arranged on a first lateral side LAS1 of the second center plane CP2, and the patch antenna stack 406 may be arranged on a second lateral side LAS2 of the second center plane CP2 opposite the first lateral side LAS1. The first feeding point 418 and/or the second feeding point 420 may be spaced from the third feeding point 440 by at least λ₂/2 to ensure adequate isolation between the monopole radiating element 432 and the patch antenna stack 406. Also, in some examples, the monopole radiating element 432 is coplanar with the first center plane CP1.

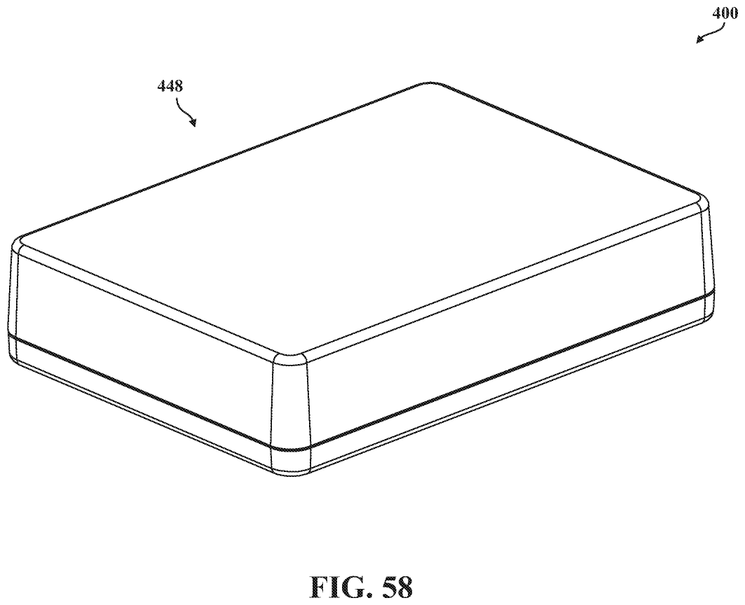

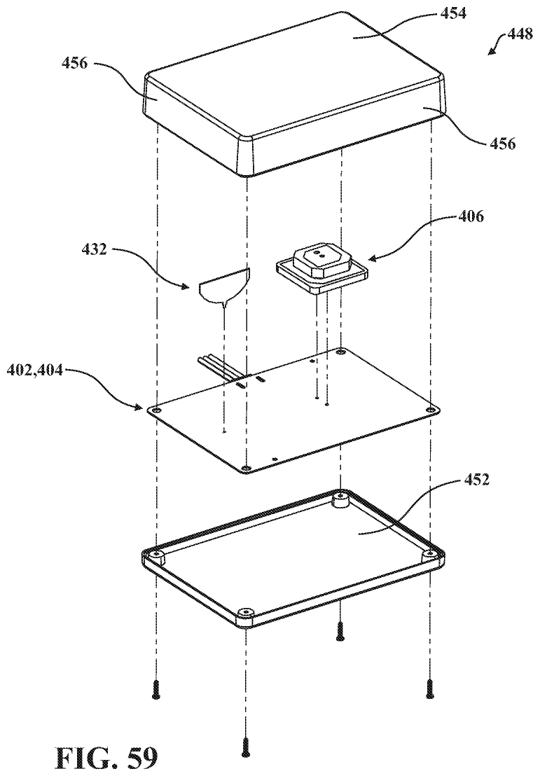

Referring to FIGS. 58-65, to arrange the antenna assembly 401 relative to the nonconductive pane 460, the window assembly 400 may further comprise a housing 448. The housing 448 defines a housing interior 450 bounded by a bottom wall 452, a top wall 454 parallel to and spaced from the bottom wall 452, and a plurality of side walls 456 extending between the bottom wall 452 and the top wall 454. As best shown in FIGS. 59 and 61, the antenna assembly 401 may be disposed within the housing interior 450 such that the top surface 402A of the PCB 402 faces the top wall 454 of the housing 448. The antenna assembly 401 may also be arranged within the housing interior 450 such that the second patch conductor 414 is spaced from the top wall 454 to define a gap 458 therebetween. The gap 458 may be filled with air or another dielectric material. The housing 448 may be made of a material having a low permittivity (ϵr). For example, the permittivity (ϵr) may range from greater than 1 to less than 4. Exemplary materials having low permittivity (ϵr) include, but are not limited to, plastics such as acrylonitrile styrene acrylate (ASA) and acrylonitrile butadiene styrene (ABS).

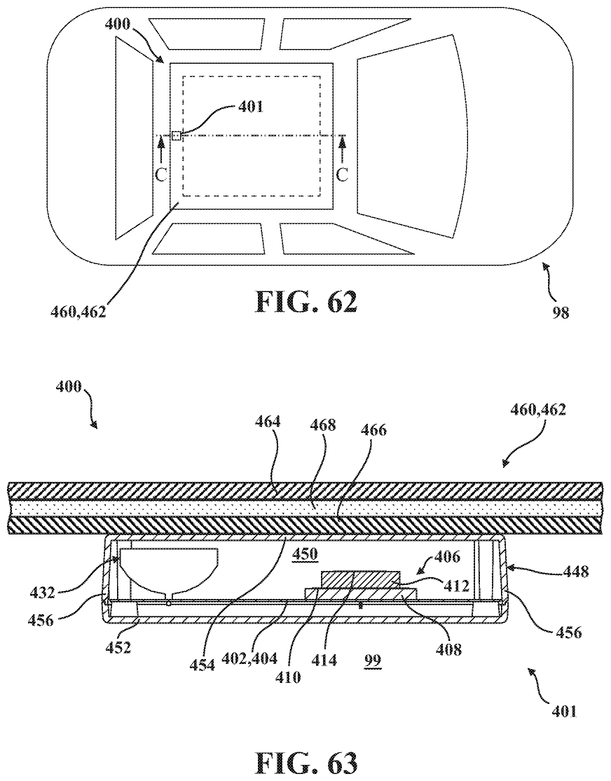

The housing 448 containing the antenna assembly 401 is configured to be coupled to the nonconductive pane 460. For example, FIGS. 62 and 63 show the top wall 454 of the housing 448 coupled to the nonconductive pane 460 (in this example, a roof glass 462) of a vehicle 98 such that the antenna assembly 401 is arranged substantially horizontal (and thus facing the sky). Here, the roof glass 462 is a laminated glazing (described above) and the top wall 454 of the housing 448 is coupled (either directly or indirectly) to the P4 surface of the inner glass substrate 466 such that the ground plane 404 is substantially parallel to the nonconductive pane 460.

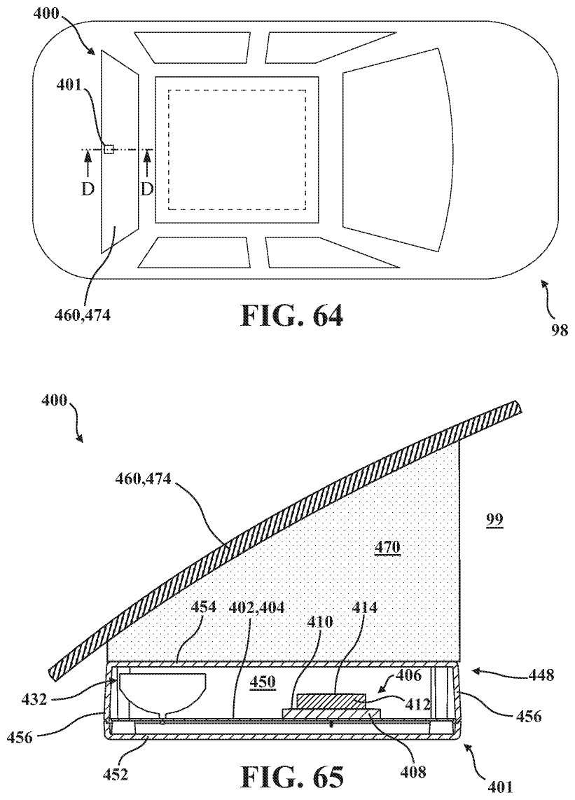

Referring to FIGS. 64 and 65, it is also contemplated that the nonconductive pane 460 may be a single pane of glass (rather than a laminated glazing) such as a side window or a rear window of a vehicle. In these cases, the housing 448 containing the antenna assembly 401 may be coupled to the nonconductive pane 460 at an angle such that the antenna assembly 401 is still arranged substantially horizontal (and thus facing the sky). In other words, the antenna assembly 401 may be arranged such that the top wall 454 of the housing 448 is spaced from the nonconductive pane 460 such that the ground plane 404 is not parallel to the nonconductive pane 460. In some cases, such as illustrated in FIG. 65, a third dielectric 470 may be arranged between the top wall 454 of the housing 448 and the nonconductive pane 460 to support the housing 448 relative to the nonconductive pane 460. Of course, other configurations for arranging the housing 448 containing the antenna assembly 401 relative to the nonconductive pane 460 are contemplated. Additionally, as described above, it should also be appreciated that the housing 448 (and thus, the antenna assembly 401) may be coupled to nonconductive panes 460 other than glass, such as fiberglass or composite body panels (e.g. a trunk lids, mirror housings, fenders, quarter panels, spoilers, etc.).

### Fifth Embodiment

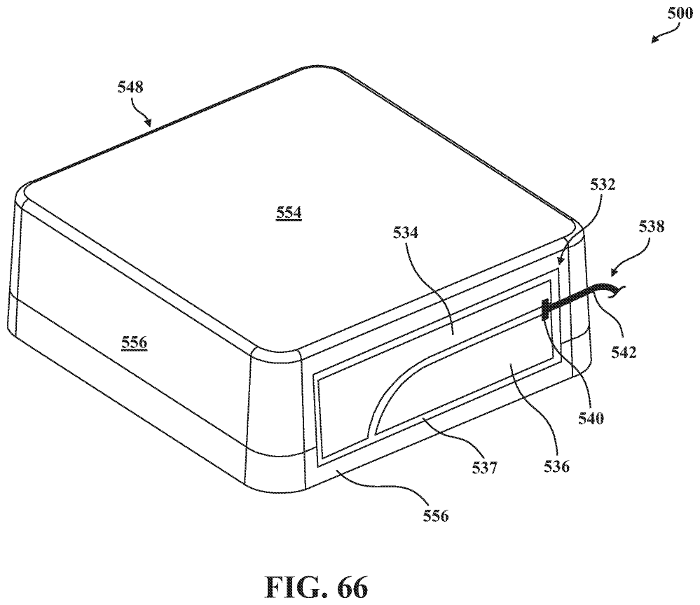

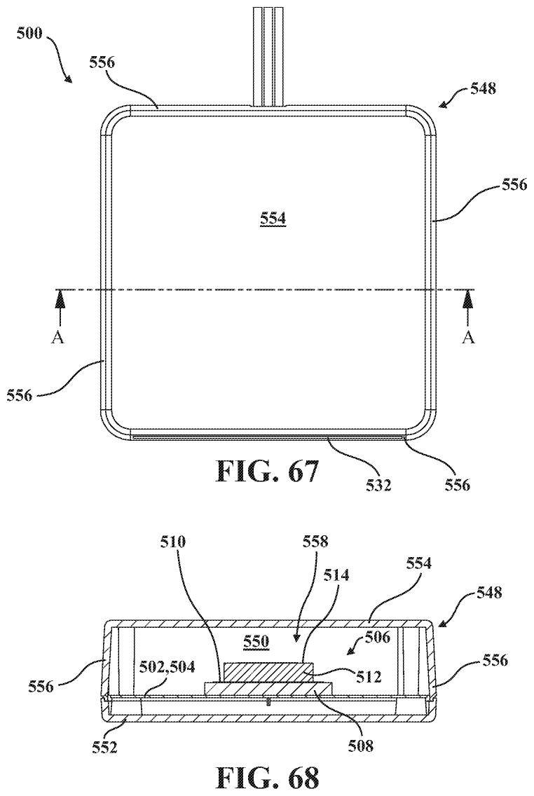

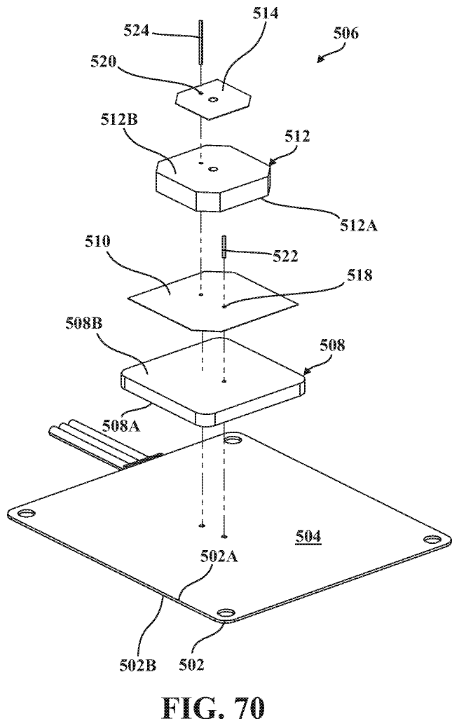

FIGS. 66-78 illustrate a further embodiment of an antenna assembly 500 for a vehicle according to the present disclosure. The antenna assembly 500 includes a housing 548. The housing 548 defines a housing interior 550 bounded by a bottom wall 552, a top wall 554 parallel to and spaced from the bottom wall 552, and a plurality of side walls 556 extending between the bottom wall 552 and the top wall 554. The housing 548 may be made of a material having a low permittivity (ϵr). For example, the permittivity (ϵr) may range from greater than 1 to less than 4. Exemplary materials having low permittivity (ϵr) include, but are not limited to, plastics such as acrylonitrile styrene acrylate (ASA) and acrylonitrile butadiene styrene (ABS).

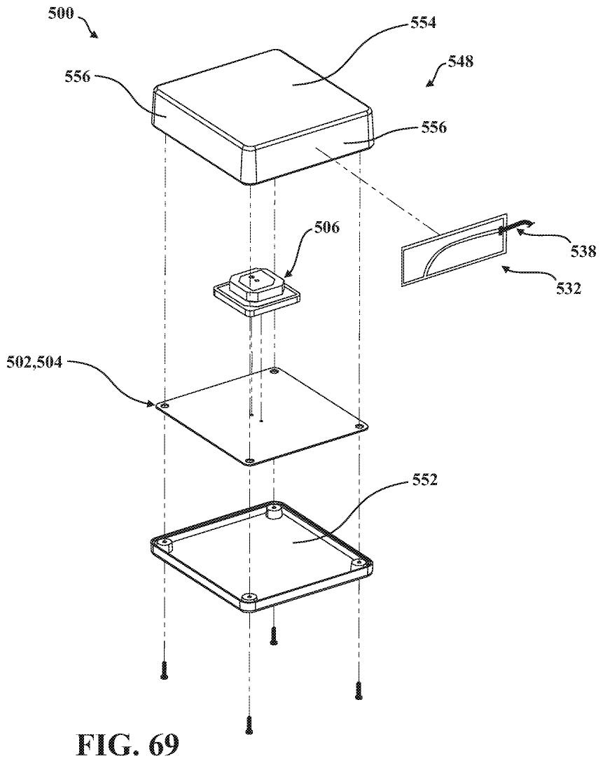

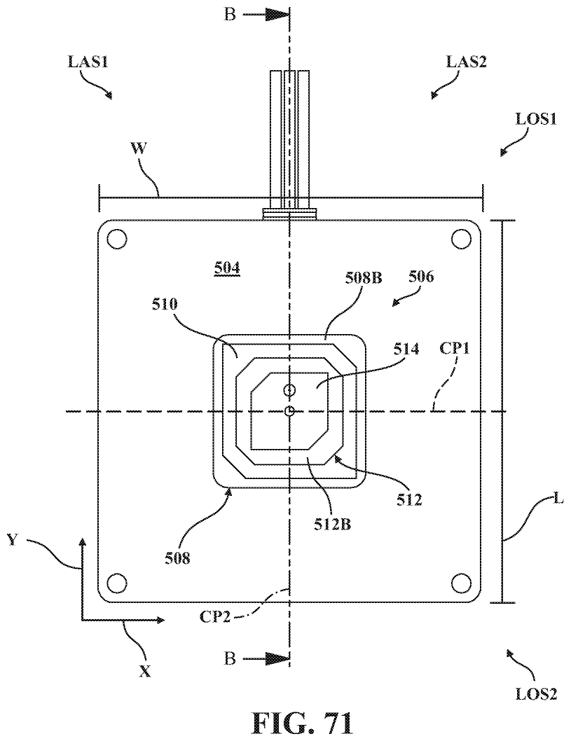

Referring first to FIGS. 69-72, the antenna assembly 500 also includes a PCB 502 including a top surface 502A and a bottom surface 502B opposite the top surface 502A. The PCB 502 is disposed within the housing interior 550 such that the top surface 502A of the PCB 502 at least partially faces the top wall 554 of the housing 548. The PCB 502 typically includes one or more circuits configured to be arranged in electrical communication with the antenna assembly 500 to operate the antenna assembly 500 to transmit and/or receive radio frequency signals. The antenna assembly 500 also includes a ground plane 504 disposed on the top surface 502A of the PCB 502. Although not required, the ground plane 504 may comprise a metallization layer formed or disposed on the top surface 302A of the PCB 302. The metallization layer may comprise a copper foil or the like. The ground plane 504 may be generally rectangular in shape and have a width W in a lateral direction (X), and a length L in a longitudinal direction (Y) transverse to the lateral direction (X). Additionally, as best shown in FIG. 71, the ground plane 504 may define a first center plane CP1 bisecting the ground plane 504 in the lateral direction (X) and a second center plane CP2 bisecting the ground plane 504 in the longitudinal direction (Y).

As best shown in FIGS. 69-72, the antenna assembly 500 further includes a patch antenna stack 506. The patch antenna stack 506 includes a first dielectric 508 extending between a first dielectric surface 508A and a second dielectric surface 508B opposite the first dielectric surface 508A. The first dielectric surface 508A is operatively connected to the ground plane 504. For example, the first dielectric surface 508A may be operatively connected to the ground plane 504 by being directly or indirectly adhered or otherwise fixed to the ground plane 504. The first dielectric 508 may comprise a suitable dielectric material such as a ceramic material. The patch antenna stack 506 also includes a first patch conductor 510 operatively connected to the second dielectric surface 508B of the first dielectric 508. For example, first patch conductor 510 may be operatively connected to the second dielectric surface 508B by being directly or indirectly adhered or otherwise fixed to the second dielectric surface 508B. The first patch conductor 510 is configured to be energized to transmit and/or receive radio frequency signals having a first frequency with a first wavelength λ₁ and having circular polarization in a first direction. The first patch conductor 510 may comprise a conductive layer formed or disposed on the second dielectric surface 508B of the first dielectric 508. For example, the first patch conductor 510 may comprise a conductive foil. The first patch conductor 510 may be generally rectangular in shape with opposing corners cut to effect circular polarization, but other configurations are contemplated.

In some examples, the first frequency is from 1500 megahertz to 1650 megahertz. More specifically, the first frequency may be from 1550 megahertz to 1625 megahertz. Additionally, the first direction may be right-handed circular polarization (RHCP). Accordingly, the first patch conductor 510 may be configured to transmit and/or receive radio frequency signals on one or more Global Navigation Satellite Systems (GNSS) including, but not limited to, the United States's Global Positioning System (GPS), Russia's Global Navigation Satellite System (GLONASS), China's BeiDou Navigation Satellite System, the European Union's Galileo Satellite System, and Japan's Quasi-Zenith Satellite System (QZSS). Of course, left-handed circular polarization and/or other frequencies are contemplated.

With continued reference to FIGS. 69-72, the patch antenna stack 506 further includes a second dielectric 512 extending between a third dielectric surface 512A and a fourth dielectric surface 512B opposite the third dielectric surface 512A. The third dielectric surface 512A is operatively connected to the first patch conductor 510. For example, the third dielectric surface 512A may be operatively connected to the first patch conductor 510 by being directly or indirectly adhered or otherwise fixed to the first patch conductor 510. The second dielectric 512 may comprise a suitable dielectric material such as a ceramic material. The patch antenna stack 506 further includes a second patch conductor 514 operatively connected to the fourth dielectric surface 512B of the second dielectric 512. For example, the second patch conductor 514 may be operatively connected to the fourth dielectric surface 512B by being directly or indirectly adhered or otherwise fixed to the fourth dielectric surface 512B. The second patch conductor 514 is configured to be energized to transmit and/or receive radio frequency signals having a second frequency with a second wavelength λ₂, higher than the first frequency, and having circular polarization in a second direction opposite the first direction. The second patch conductor 514 may comprise a conductive layer formed or disposed on the fourth dielectric surface 512B of the second dielectric 512. For example, the second patch conductor 514 may comprise a conductive foil. The second patch conductor 514 may be generally rectangular in shape with opposing corners cut to effect circular polarization, but other configurations are contemplated. The PCB 502 and the patch antenna stack 506 may be arranged within the housing interior 550 such that the second patch conductor 514 is spaced from the top wall 554 to define a gap 558 therebetween. The gap 558 may be filled with air or another dielectric material.

In some examples, the second frequency is from 2250 megahertz to 2400 megahertz. More specifically, the second frequency may be from 2310 megahertz to 2360 megahertz. Even more specifically, the second frequency may be from 2320 megahertz to 2345 megahertz. Additionally, the first direction may be left-handed circular polarization (LHCP). Accordingly, the second patch conductor 514 may be configured to transmit and/or receive radio frequency signals on Satellite Digital Audio Radio Services (SDARS) including, but not limited to, Sirius Satellite Radio and XM Satellite Radio. Of course, right-handed circular polarization and/or other frequencies are contemplated.

Still referring to FIGS. 69-72, the antenna assembly 500 may additionally include a first feeding assembly 516 for energizing the first patch conductor 510 and the second patch conductor 514 to transmit and/or receive radio frequency signals. For example, the first feeding assembly 516 may arrange the first patch conductor 510 and the second patch conductor 514 in electrical communication with the one or more circuits of the PCB 502 to energize the first patch conductor 510 and the second patch conductor 514 to transmit and/or receive radio frequency signals. It should be appreciated that in other configurations the first feeding assembly 516 is arranged such that the first patch conductor 510 and the second patch conductor 514 are in electrical communication with other circuitry outside of the antenna assembly 500 to energize the first patch conductor 510 and the second patch conductor 514 to transmit and/or receive radio frequency signals. For example, each of the first patch conductor 510 and the second patch conductor 514 may be arranged in electrical communication with a central conductor of a respective coaxial cable, and a ground shield of each respective coaxial cable may be arranged in electrical communication with the ground plane 504. It is also contemplated that the first feeding assembly 516 may include capacitive coupling elements to energize the first patch conductor 510 and/or the second patch conductor 514. It is further contemplated that the first feeding assembly 516 may include microstrip-type or lump-type impedance matching elements.

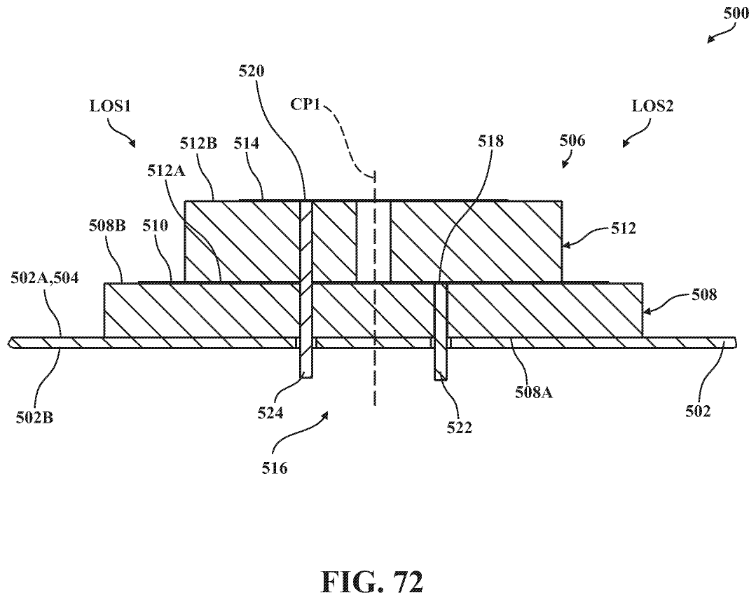

As best shown in FIG. 72, the first feeding assembly 516 may be operatively connected to the first patch conductor 510 at a first feeding point 518 and to the second patch conductor 514 at a second feeding point 520. In some examples, such as shown in FIG. 72, the first feeding point 518 is arranged on a first longitudinal side LOS1 of the first center plane CP1, and the second feeding point 320 is arranged on a second longitudinal side LOS2 of the first center plane CP1, opposite the first longitudinal side LOS1. In this configuration, the first feeding assembly 516 includes a first feeding member 522 extending through the ground plane 504 and the first dielectric 508 such that the first feeding member 522 is coupled to the first patch conductor 510 at the first feeding point 518 to energize the first patch conductor 510 to transmit and/or receive radio frequency signals having the first frequency and having circular polarization in the first direction. Additionally, this configuration also includes a second feeding member 524 extending through the ground plane 504, the first dielectric 508, the first patch conductor 510, and the second dielectric 512 such that the second feeding member 524 is coupled to the second patch conductor 514 at the second feeding point 520 point to energize the second patch conductor 514 to transmit and/or receive radio frequency signals having the second frequency and having circular polarization in the second direction.

Other configurations of operatively connecting the first feeding assembly 516 to the first patch conductor 510 at the first feeding point 518 and the second patch conductor 514 at the second feeding point 520 to energize the first patch conductor 510 and the second patch conductor 514 to transmit and/or receive radio frequency signals are contemplated.

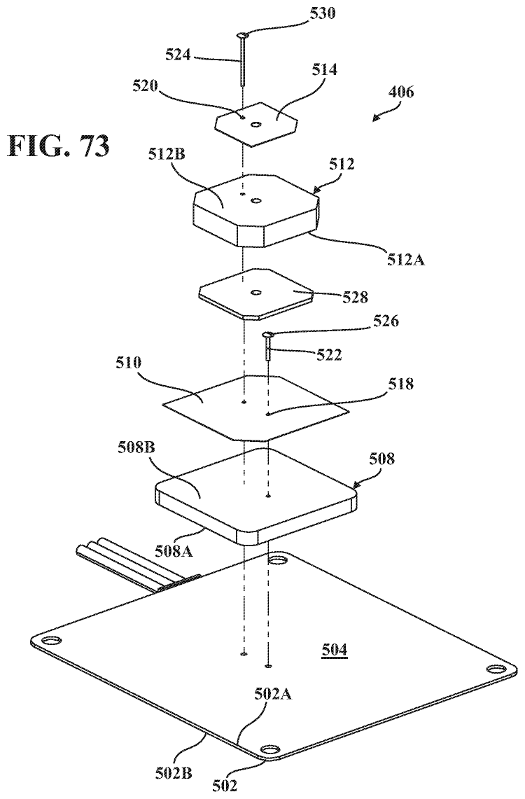

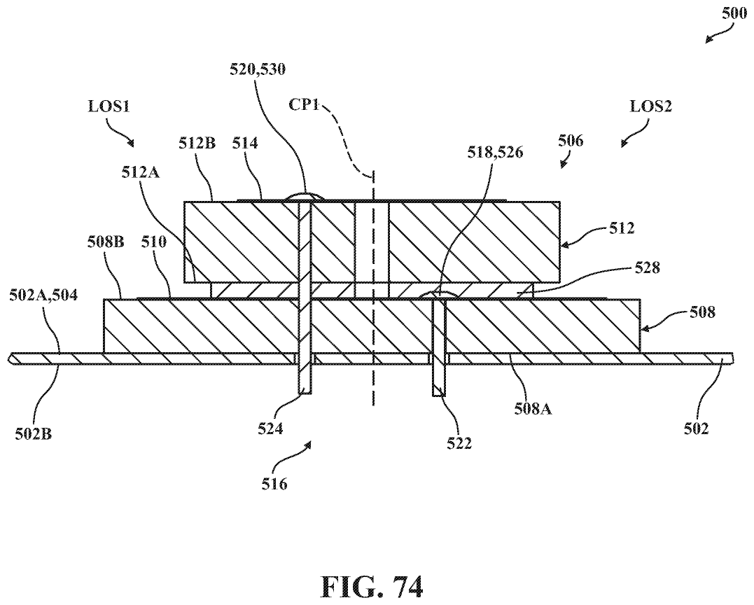

Referring to FIGS. 73 and 74, in some examples, the first feeding point 518 extends beyond the first patch conductor 510. For example, the first feeding point 518 as illustrated includes a first solder joint 526 operatively connecting the first feeding member 522 to the first patch conductor 510. In these examples, especially where the second dielectric 512 is a rigid material such as the ceramic material, the first solder joint 526 may cause the second dielectric 512 to be misaligned (i.e., not parallel) with the first patch conductor 510. Accordingly, the patch antenna stack 506 may further include a spacer 528 interposed between the first patch conductor 510 and the second dielectric 512. The spacer 528 is configured to deform (i.e., deflect) where the first feeding point 518 (particularly, the first solder joint 526) extends beyond the first patch conductor 510 such that the second dielectric 512 is arranged parallel to the first patch conductor 510. The spacer 528 may be comprised of a nonconductive material such as foam. The second feeding point 520 may similarly comprise a second solder joint 530 operatively connecting the second feeding member 524 to the second patch conductor 514. Other configurations of operatively connecting the first feeding member 522 to the first patch conductor 510 and the second feeding member 524 to the second patch conductor 514 are contemplated.

The antenna assembly 500 further includes a dipole radiating element 532. As best shown in FIGS. 66 and 69, in the present embodiment, the dipole radiating element 532 is coupled to one or more of the side walls 556 of the housing 548. Accordingly, in some examples, the dipole radiating element 532 may be arranged substantially perpendicular (e.g. +/−10 degrees from perpendicular) to the ground plane 504. The dipole radiating element 532 may be a planar radiating element including a first portion 534 and a second portion 536 disposed on a carrier substrate 537. The carrier substrate 537 may be directly or indirectly adhered or otherwise fixed to one or more of the side walls 556 of the housing 548. In some examples, the carrier substrate 537 is disposed on only one of the side walls 556 of the housing 548. However, in other examples, the carrier substrate 537 may be flexible such that the carrier substrate may be bent and be directly or indirectly adhered or otherwise fixed to more than one of the side walls 556 of the housing 548. The dipole radiating element 532 is configured to be energized to transmit and/or receive radio frequency signals having linear polarization. The dipole radiating element 532 may be configured to transmit and/or receive radio frequency signals having a frequency of from 600 megahertz to 6 gigahertz. Accordingly, the dipole radiating element 532 may be configured to transmit and/or receive radio frequency signals on 4G LTE, 5G sub-6 GHz networks, and any other current and future cellular networks falling within the 600 megahertz to 6 gigahertz frequency range. Other networks falling within the 600 megahertz to 6 gigahertz frequency range are also contemplated, such as V2X networks and Wi-Fi. To accommodate the large range of frequencies, the dipole radiating element 532 may generally comprise a wideband dipole. Other arrangements and configurations of the dipole radiating element 532 are contemplated. For example, the dipole radiating element 532 may include additional portions, projections, and/or define slots to achieve desired tuning.

The antenna assembly 500 may also include a second feeding assembly 538 operatively connected to the dipole radiating element 532 at a third feeding point 540 for energizing the dipole radiating element 532 to transmit and/or receive radio frequency signals. In one example, referring to FIGS. 66 and 69, the second feeding assembly 538 includes a coaxial cable 542 arranged in electrical communication with the dipole radiating element 532 at the third feeding point 540 to energize the dipole radiating element 532 to transmit and/or receive radio frequency signals. Other configurations of the second feeding assembly 538 are contemplated. For example, the third feeding point 540 may be arranged in electrical communication with the one or more circuits of the PCB 502 to energize the dipole radiating element 532 to transmit and/or receive radio frequency signals. It is also contemplated that the second feeding assembly 538 may include capacitive coupling elements to energize the dipole radiating element 532 to transmit and/or receive radio frequency signals. It is further contemplated that the second feeding assembly 538 may include microstrip-type or lump-type impedance matching elements.

As best shown in FIG. 68, the patch antenna stack 506 and the dipole radiating element 532 may be arranged relative to each other such that there is minimal interference with each other. It should be appreciated that the width W and the length L of the ground plane 504 may each independently be at least λ₁/2 to ensure adequate gain and/or directionality of the first patch conductor 510 and the second patch conductor 514. In some examples, the width W and the length L may each independently be greater than 70 mm, greater than 75 mm, greater than 80 mm, greater than 85 mm, greater than 90 mm, greater than 100 mm, greater than 105 mm, greater than 110 mm, greater than 115 mm, greater than 120 mm, or even greater than 125 mm. Additionally, in some configurations the patch antenna stack 506 is centered on the ground plane 504 in the lateral direction X such that the patch antenna stack 506 is arranged such that the first center plane CP1 bisects the patch antenna stack 506. The patch antenna stack 506 and the dipole radiating element 532 are from each other by nature of the dipole radiating element 532 being arranged on one of the side walls 556 of the housing 548. The first feeding point 518 and/or the second feeding point 520 may be spaced from the third feeding point 540 by at least λ₂/2 to ensure adequate isolation between the dipole radiating element 532 and the patch antenna stack 506.

The housing 548 may be configured to be coupled to a vehicle 98. The housing 548 should generally be arranged in a manner that a conductive member of a vehicle (e.g. a metal body panel) does not obstruct radio frequency signals from emanating upwards toward the sky. In one example, the housing 548 may be configured to be coupled to a nonconductive pane 560 of a vehicle 98. The term “nonconductive” refers to a material, such as an insulator or dielectric, that when placed between conductors at different potentials, permits only a small or negligible current in phase with the applied voltage to flow through material. Typically, nonconductive materials have conductivities on the order of nanosiemens/meter. In some examples, the nonconductive pane 560 is implemented as at least one pane of glass. Where the nonconductive pane 560 is implemented as glass, the nonconductive pane 560 may be comprised of any suitable glass composition including, but not limited to, soda-lime glass, aluminosilicate glass, borosilicate glass, boro-aluminosilicate glass, and the like. Of course, the nonconductive pane 560 may include more than one pane of glass. Those skilled in the art, however, realize that the nonconductive pane 560 may be formed from plastic, fiberglass, or other suitable nonconductive materials.

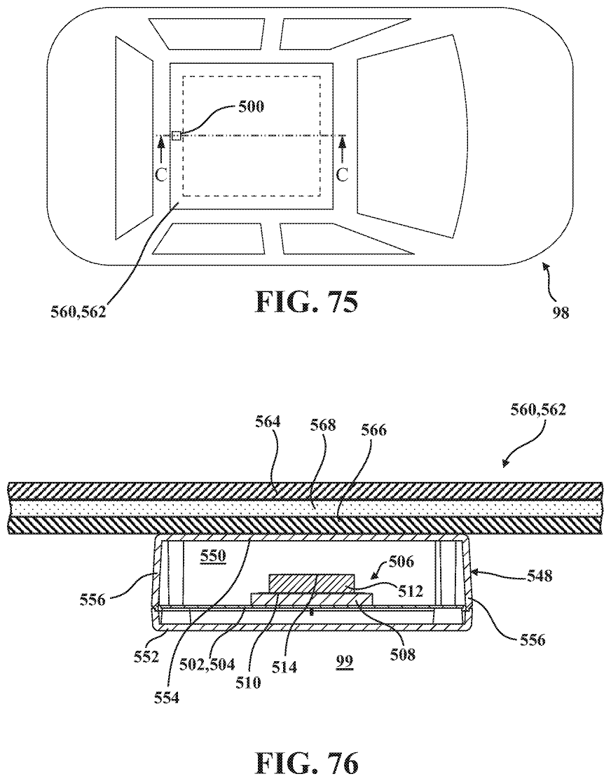

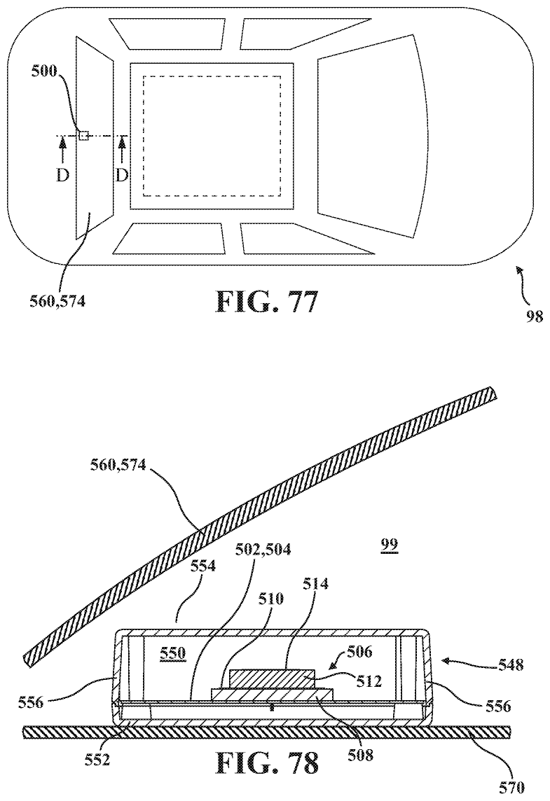

FIGS. 75 and 76 show the top wall 554 of the housing 548 coupled to a roof glass 562 of a vehicle 98 such that the PCB 502 and ground plane 504 are arranged substantially horizontal (and thus facing the sky). Here, the roof glass 562 is a laminated glazing including an outer glass substrate 564 having an outer surface (P1) and an opposing inner surface (P2), an inner glass substrate 566 having an inner surface (P3) and an opposing outer surface (P4), and a polymeric interlayer 568 disposed between the P2 surface of the outer glass substrate 564 and the P3 surface of the inner glass substrate 566. In this case, the top wall 554 of the housing 548 is coupled (either directly indirectly) to the P4 surface. It is also contemplated that the nonconductive pane 560 may be a single pane of glass (rather than a laminated glazing) such as a side window or a rear window of a vehicle. In these cases, the housing 548 may be configured to be coupled to the nonconductive pane 560 at an angle such that the PCB 502 and ground plane 504 are still arranged substantially horizontal (and thus facing the sky). It is further contemplated that the housing 548 may be coupled to nonconductive panes other than glass, such as fiberglass or composite body panels (e.g. a trunk lids, mirror housings, fenders, quarter panels, spoilers, etc.). The housing 548 may also be configured to be arranged within an interior compartment 99 of a vehicle 98. Referring to FIGS. 77 and 78, in one example, the housing 548 may be arranged on a luggage rack 570 below the rear window 574 of the vehicle 98 such that the PCB 502 and ground plane 504 are arranged substantially horizontal (and thus facing the sky). Of course, other locations for arranging the housing 548 containing within an interior compartment 99 of a vehicle 98 are contemplated.

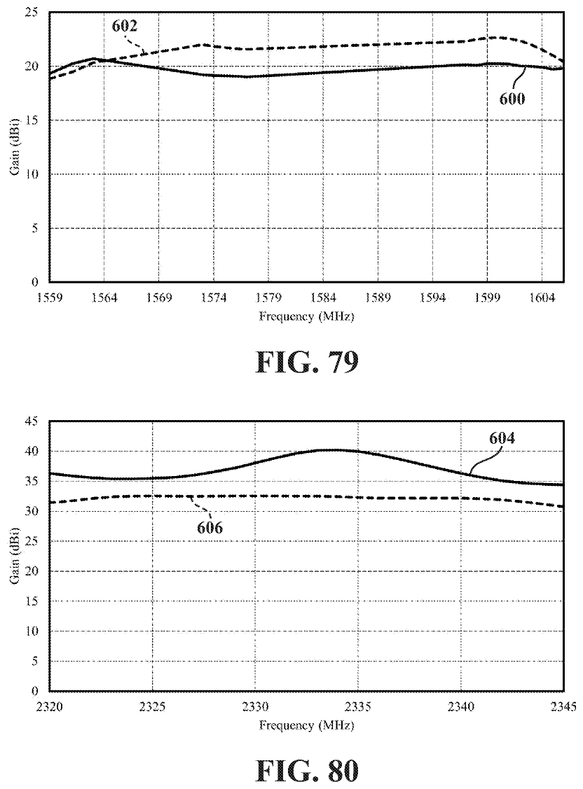

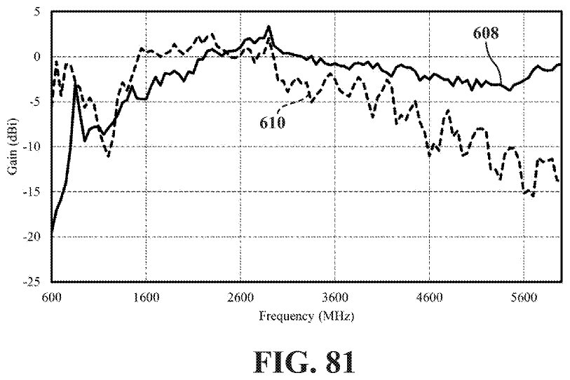

The antenna assemblies 100, 200, 300, 401, 500 according to the present disclosure exhibit improved or at least comparable antenna performance when compared to an industry standard shark fin antenna. Accordingly, the antenna assemblies 100, 200, 300, 401, 500 according to the present disclosure serve as suitable alternatives to conventional shark fin antenna assemblies. In FIGS. 79-81, the performance of the antenna assembly 300 from the third embodiment described herein is compared to an industry standard shark fin antenna. Although, it is to be appreciated that the antenna assemblies 100, 200, 401, 500 of the various other embodiments as described and as illustrated herein may exhibit such performance as the antenna assembly 300. FIG. 79 illustrates the gain performance the first patch conductor 310 (indicated by the solid line 600) between 1559-1606 MHz compared with the performance of an industry standard shark fin antenna assembly over the same frequency range (indicated by the dashed line 602). In FIG. 79, the first patch conductor 310 averages within about 2 dB of gain compared with the performance of an industry standard shark fin antenna assembly over the same frequency range. FIG. 80 illustrates the gain performance the second patch conductor 314 (indicated by the solid line 604) between 2320-2345 MHz compared with the performance of an industry standard shark fin antenna assembly over the same frequency range (indicated by the dashed line 606). In FIG. 80, the second patch conductor 314 averages about 5 dB of gain greater than the performance of an industry standard shark fin antenna assembly over the same frequency range. FIG. 81 illustrates the gain performance the radiating element 332 (indicated by the solid line 608) between 600-6000 MHz compared with the performance of an industry standard shark fin antenna assembly over the same frequency range (indicated by the dashed line 610). In FIG. 81, the radiating element 332 averages about 2 dB of gain greater than the performance of an industry standard shark fin antenna assembly over the same frequency range.

Several embodiments have been described in the foregoing description. However, the embodiments described herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

Various additional alterations and changes beyond those already mentioned herein can be made to the above-described embodiments. This disclosure is presented for illustrative purposes and should not be interpreted as an exhaustive description of all embodiments or to limit the scope of the claims to the specific elements illustrated or described in connection with these embodiments. For example, and without limitation, any individual element(s) of the described embodiments may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Any reference to claim elements in the singular, for example, using the articles “a,” “an,” “the” or “said,” is not to be construed as limiting the element to the singular. It will be further appreciated that the terms “include,” “includes,” and “including” have the same meaning as the terms “comprise,” “comprises,” and “comprising.”

The present disclosure also comprises the following clauses, with specific features laid out in dependent clauses, that may specifically be implemented as described in greater detail with reference to the configurations and drawings above.

### Clauses

I. An antenna assembly for a vehicle, said antenna assembly comprising:
   a PCB including a top surface and a bottom surface opposite the top surface;
   a ground plane disposed on the top surface of the PCB;
   a patch antenna stack comprising:
      a first dielectric extending between a first dielectric surface operatively connected to the ground plane and a second dielectric surface opposite the first dielectric surface;
      a first patch conductor operatively connected to the second dielectric surface of the first dielectric, the first patch conductor configured to be energized to transmit and/or receive radio frequency signals having a first frequency with a first wavelength λ₁ and having circular polarization in a first direction;
      a second dielectric extending between a third dielectric surface operatively connected to the first patch conductor and a fourth dielectric surface opposite the third dielectric surface; and
      a second patch conductor operatively connected to fourth dielectric surface of the second dielectric, the second patch conductor configured to be energized to transmit and/or receive radio frequency signals having a second frequency with a second wavelength λ₂, higher than the first frequency, and having circular polarization in a second direction opposite the first direction;
   a monopole radiating element including a first portion extending perpendicularly from the ground plane, the monopole radiating element configured to be energized to transmit and/or receive radio frequency signals having linear polarization;
   a first feeding assembly operatively connected to the first patch conductor at a first feeding point and the second patch conductor at a second feeding point for energizing the first patch conductor and the second patch conductor to transmit and/or receive radio frequency signals; and
   a second feeding assembly operatively connected to the monopole radiating element at a third feeding point for energizing the monopole radiating element to transmit and/or receive radio frequency signals;
   wherein the second feeding point is spaced from the third feeding point by at least λ₂/2.
II. The antenna assembly according to clause I, wherein the ground plane has a width W in a lateral direction (X), and a length L in a longitudinal direction (Y) transverse to the lateral direction (X), and
   wherein the ground plane defines a first center plane bisecting the ground plane in the lateral direction (X) and a second center plane bisecting the ground plane in the longitudinal direction (Y).
III. The antenna assembly according to clause II, wherein the width W and the length L are each independently at least λ₁/2.
IV. The antenna assembly according to one of clauses II or III, wherein the monopole radiating element further includes a second portion coupled to and extending from the first portion and spaced from the ground plane.
V. The antenna assembly according to clause IV, wherein the second portion of the monopole radiating element is parallel to the ground plane.
VI. The antenna assembly according to any one of clauses II to V, wherein the first portion of the monopole radiating element is coplanar with the first center plane.
VII. The antenna assembly according to any one of clauses II to VI, wherein the monopole radiating element is arranged on a first lateral side of the second center plane, and the patch antenna stack is arranged on a second lateral side of the second center plane opposite the first lateral side.
VIII. The antenna assembly according to any one of clauses II to VII, wherein the patch antenna stack is arranged such that the first center plane bisects the patch antenna stack.
IX. The antenna assembly according to any one of clauses II to VIII, wherein the first dielectric defines a first longitudinal surface transverse to the ground plane, and a second longitudinal surface opposite the first longitudinal surface, and
   wherein the first longitudinal surface is coplanar with the second center plane.
X. The antenna assembly according to any one of clauses II to IX, wherein the first feeding point is arranged on a first longitudinal side of the first center plane, and the second feeding point is arranged on a second longitudinal side of the first center plane opposite the first longitudinal side.
XI. The antenna assembly according to any one of clauses I to X, wherein at least one of the first dielectric and the second dielectric comprise a ceramic material.
XII. The antenna assembly according to any one of clauses I to XI, wherein the first feeding assembly comprises a first feeding member extending through the ground plane and the first dielectric, wherein the first feeding member is coupled to the first patch conductor at the first feeding point to energize the first patch conductor to transmit and/or receive radio frequency signals having the first frequency and having circular polarization in the first direction.
XIII. The antenna assembly according to any one of clauses I to XII, wherein the first feeding assembly comprises a second feeding member extending through the ground plane, the first dielectric, the first patch conductor, and the second dielectric, wherein the second feeding member is coupled to the second patch conductor at the second feeding point to energize the second patch conductor to transmit and/or receive radio frequency signals having the second frequency and having circular polarization in the second direction.
XIV. The antenna assembly according to any one of clauses I to XIII, wherein the patch antenna stack further comprises a spacer interposed between the first patch conductor and the second dielectric, wherein the spacer is configured to deform where the first feeding point extends beyond the first patch conductor such that the second dielectric is arranged parallel to the first patch conductor.
XV. The antenna assembly according to any one of clauses I to XV, wherein the first frequency is from 1500 megahertz to 1650 megahertz.
XVI. The antenna assembly according to clause XV, wherein the first patch conductor exhibits a gain of at least 18 dB from 1500 megahertz to 1650 megahertz.
XVII. The antenna assembly according to any one of clauses I to XVI, wherein the second frequency is from 2250 megahertz to 2400 megahertz.
XVIII. The antenna assembly according to clause XVII, wherein the second patch conductor exhibits a gain of at least 34 dB from 2250 megahertz to 2400 megahertz.
XIX. The antenna assembly according to any one of clauses I to XVIII, wherein the first direction is right-handed and the second direction is left-handed.
XX. The antenna assembly according to any one of clauses I to XIX, wherein the monopole radiating element is configured to transmit and/or receive radio frequency signals having a frequency of from 600 megahertz to 6 gigahertz.
XXI. The antenna assembly according to clause XX, wherein the monopole radiating element exhibits an average gain of −3 dB or greater from 600 megahertz to 6 gigahertz.
XXII. The antenna assembly according to any one of clauses I to XXI, further comprising a housing defining a housing interior bounded by a bottom wall, a top wall parallel to and spaced from the bottom wall, and a plurality of side walls extending between the bottom wall and the top wall;
   wherein the antenna assembly is disposed within the housing interior such that the top surface of the PCB faces the top wall of the housing.
XXIII. The antenna assembly according to clause XXII, wherein the antenna assembly is arranged within the housing interior such that the second patch conductor is spaced from the top wall to define a gap therebetween.
XXIV. The antenna assembly according to one of clauses XXII or XXIII, wherein the housing is configured to be coupled to a nonconductive pane of a vehicle.
XXV. The antenna assembly according to any one of clauses XXII to XXIV, wherein the housing is configured to be arranged within an interior compartment of a vehicle.
XXVI. An antenna assembly for a vehicle, said antenna assembly comprising:
   a PCB including a top surface and a bottom surface opposite the top surface;
   a ground plane disposed on the top surface of the PCB and having a width W and a length L;
   a patch antenna stack comprising:
      a first dielectric extending between a first dielectric surface operatively connected to the ground plane and a second dielectric surface opposite the first dielectric surface;
      a first patch conductor operatively connected to the second dielectric surface of the first dielectric, the first patch conductor configured to be energized to transmit and/or receive radio frequency signals having a first frequency with a first wavelength λ₁ and having a circular polarization in a first direction;
      a second dielectric extending between a third dielectric surface operatively connected to the first patch conductor and a fourth dielectric surface opposite the third dielectric surface; and
      a second patch conductor operatively connected to fourth dielectric surface of the second dielectric, the second patch conductor configured to be energized to transmit and/or receive radio frequency signals having a second frequency with a second wavelength λ₂, higher than the first frequency, and having a circular polarization in a second direction opposite the first direction; and
   a monopole radiating element including a first portion extending perpendicularly from the ground plane, the monopole radiating element configured to be energized to transmit and/or receive radio frequency signals having a linear polarization;
   wherein the width W and the length L are each independently at least λ₁/2.
XXVII. The antenna assembly according to clause XXVI, wherein the width W of the ground plane extends in a lateral direction (X), and the length L of the ground plane extends in a longitudinal direction (Y) transverse to the lateral direction (X), and
   wherein the ground plane defines a first center plane bisecting the ground plane in the lateral direction (X) and a second center plane bisecting the ground plane in the longitudinal direction (Y).
XXVIII. The antenna assembly according to clause XXVII, wherein the monopole radiating element further includes a second portion coupled to and extending from the first portion and spaced from the ground plane.
XXIX. The antenna assembly according to clause XXVIII, wherein the second portion of the monopole radiating element is parallel to the ground plane.
XXX. The antenna assembly according to any one of clauses XXVII to XXIX, wherein the first portion of the monopole radiating element is coplanar with the first center plane.
XXXI. The antenna assembly according to any one of clauses XXVII to XXX, wherein the monopole radiating element is arranged on a first lateral side of the second center plane, and the patch antenna stack is arranged on a second lateral side of the second center plane opposite the first lateral side.
XXXII. The antenna assembly according to any one of clauses XXVII to XXXI, wherein the patch antenna stack is arranged such that the first center plane bisects the patch antenna stack.
XXXIII. The antenna assembly according to any one of clauses XXVII to XXXII, wherein the first dielectric defines a first longitudinal surface transverse to the ground plane, and a second longitudinal surface opposite the first longitudinal surface, and
   wherein the first longitudinal surface is coplanar with the second center plane.
XXXIV. The antenna assembly according to any one of clauses XXVII to XXXIII, further comprising:
   a first feeding assembly operatively connected to the first patch conductor at a first feeding point and the second patch conductor at a second feeding point for energizing the first patch conductor and the second patch conductor to transmit and/or receive radio frequency signals; and
   a second feeding assembly operatively connected to the monopole radiating element at a third feeding point for energizing the monopole radiating element to transmit and/or receive radio frequency signals.
XXXV. The antenna assembly according to clause XXXIV, wherein the first feeding point is arranged on a first longitudinal side of the first center plane, and the second feeding point is arranged on a second longitudinal side of the first center plane opposite the first longitudinal side.
XXXVI. The antenna assembly according to one of clauses XXXIV or XXXV, wherein the second feeding point is spaced from the third feeding point by at least λ₁/2.
XXXVII. The antenna assembly according to any one of clauses XXXIV to XXXVI, wherein the first feeding assembly comprises a first feeding member extending through the ground plane and the first dielectric, wherein the first feeding member is coupled to the first patch conductor at the first feeding point to energize the first patch conductor to transmit and/or receive radio frequency signals having the first frequency and having circular polarization in the first direction.
XXXVIII. The antenna assembly according to any one of clauses XXXIV to XXXVII, wherein the first feeding assembly comprises a second feeding member extending through the ground plane, the first dielectric, the first patch conductor, and the second dielectric, wherein the second feeding member coupled to the second patch conductor at the second feeding point to energize the second patch conductor to transmit and/or receive radio frequency signals having the second frequency and having circular polarization in the second direction.
XXXIX. The antenna assembly according to any one of clauses XXVI to XXXVIII, wherein at least one of the first dielectric and the second dielectric comprise a ceramic material.
XL. The antenna assembly according to any one of clauses XXVI to XXXIX, wherein the patch antenna stack further comprises a spacer interposed between the first patch conductor and the second dielectric, wherein the spacer is configured to deform where the first feeding point extends beyond the first patch conductor such that the second dielectric is arranged parallel to the first patch conductor.
XLI. The antenna assembly according to any one of clauses XXVI to XL, wherein the first frequency is from 1500 megahertz to 1650 megahertz.
XLII. The antenna assembly according to clause XLI, wherein the first patch conductor exhibits a gain of at least 18 dB from 1500 megahertz to 1650 megahertz.
XLIII. The antenna assembly according to any one of clauses XXVI to XLII, wherein the second frequency is from 2250 megahertz to 2400 megahertz.
XLIV. The antenna assembly according to clause XLIII, wherein the second patch conductor exhibits a gain of at least 34 dB from 2250 megahertz to 2400 megahertz.
XLV. The antenna assembly according to any one of clauses XXVI to XLIV, wherein the first direction is right-handed and the second direction is left-handed.
XLVI. The antenna assembly according to any one of clauses XXVI to XLV, wherein the monopole radiating element is configured to transmit and/or receive radio frequency signals having a frequency of from 600 megahertz to 6 gigahertz.
XLVII. The antenna assembly according to clause XLVI, wherein the monopole radiating element exhibits an average gain of −3 dB or greater from 600 megahertz to 6 gigahertz.
XLVIII. The antenna assembly according to any one of clauses XXVI to XLVII, further comprising a housing defining a housing interior bounded by a bottom wall, a top wall parallel to and spaced from the bottom wall, and a plurality of side walls extending between the bottom wall and the top wall;
   wherein the antenna assembly is disposed within the housing interior such that the top surface of the PCB faces the top wall of the housing.
XLIX. The antenna assembly according to clause XLVIII, wherein the antenna assembly is arranged within the housing interior such that the second patch conductor is spaced from the top wall to define a gap therebetween.
L. The antenna assembly according to one of clauses XLVIII or XLIX, wherein the housing is configured to be coupled to a nonconductive pane of a vehicle.
LI. The antenna assembly according to any one of clauses XLVIII to L, wherein the housing is configured to be arranged within an interior compartment of a vehicle.
LII. An antenna assembly for a vehicle, said antenna assembly comprising:
   a PCB including a top surface and a bottom surface opposite the top surface;
   a ground plane disposed on the top surface of the PCB;
   a patch antenna stack comprising:
      a first dielectric extending between a first dielectric surface operatively connected to the ground plane and a second dielectric surface opposite the first dielectric surface;
      a first patch conductor operatively connected to the second dielectric surface of the first dielectric, the first patch conductor configured to be energized to transmit and/or receive radio frequency signals having a first frequency and having a circular polarization in a first direction;
      a second dielectric extending between a third dielectric surface operatively connected to the first patch conductor and a fourth dielectric surface opposite the third dielectric surface; and
      a second patch conductor operatively connected to fourth dielectric surface of the second dielectric, the second patch conductor configured to be energized to transmit and/or receive radio frequency signals having a second frequency, higher than the first frequency, and having a circular polarization in a second direction opposite the first direction; and
   a monopole radiating element including a first portion extending perpendicularly from the ground plane and a second portion coupled to and extending from the first portion and spaced from the ground plane, the monopole radiating element configured to be energized to transmit and/or receive radio frequency signals having a linear polarization.
LIII. The antenna assembly according to clause LII, wherein the second portion of the monopole radiating element is parallel to the ground plane.
LIV. The antenna assembly according to one of clauses LII or LIII, wherein the ground plane has a width W in a lateral direction (X), and a length L in a longitudinal direction (Y) transverse to the lateral direction (X), and
   wherein the ground plane defines a first center plane bisecting the ground plane in the lateral direction (X) and a second center plane bisecting the ground plane in the longitudinal direction (Y).
LV. The antenna assembly according to clause LIV, wherein the width W and the length L are each independently at least λ₁/2.
LVI. The antenna assembly according to one of clauses LIV or LV, wherein the first portion of the monopole radiating element is coplanar with the first center plane.
LVII. The antenna assembly according to any one of clauses LIV to LVI, wherein the monopole radiating element is arranged on a first lateral side of the second center plane, and the patch antenna stack is arranged on a second lateral side of the second center plane opposite the first lateral side.
LVIII. The antenna assembly according to any one of clauses LIV to LVII, wherein the patch antenna stack is arranged such that the first center plane bisects the patch antenna stack.
LIX. The antenna assembly according to any one of clauses LIV to LVIII, wherein the first dielectric defines a first longitudinal surface transverse to the ground plane, and a second longitudinal surface opposite the first longitudinal surface, and
   wherein the first longitudinal surface is coplanar with the second center plane.
LX. The antenna assembly according to any one of clauses LIV to LIX, further comprising:
   a first feeding assembly operatively connected to the first patch conductor at a first feeding point and the second patch conductor at a second feeding point for energizing the first patch conductor and the second patch conductor to transmit and/or receive radio frequency signals; and
   a second feeding assembly operatively connected to the monopole radiating element at a third feeding point for energizing the monopole radiating element to transmit and/or receive radio frequency signals.
LXI. The antenna assembly according to clause LX, wherein the first feeding point is arranged on a first longitudinal side of the first center plane, and the second feeding point is arranged on a second longitudinal side of the first center plane opposite the first longitudinal side.
LXII. The antenna assembly according to one of clauses LX or LXI, wherein the second feeding point is spaced from the third feeding point by at least λ₂/2.
LXIII. The antenna assembly according to any one of clauses LX to LXII, wherein the first feeding assembly comprises a first feeding member extending through the ground plane and the first dielectric, wherein the first feeding member is coupled to the first patch conductor at the first feeding point to energize the first patch conductor to transmit and/or receive radio frequency signals having the first frequency and having circular polarization in the first direction.
LXIV. The antenna assembly according to any one of clauses LX to LXIII, wherein the first feeding assembly comprises a second feeding member extending through the ground plane, the first dielectric, the first patch conductor, and the second dielectric, wherein the second feeding member is coupled to the second patch conductor at the second feeding point to energize the second patch conductor to transmit and/or receive radio frequency signals having the second frequency and having circular polarization in the second direction.
LXV. The antenna assembly according to any one of clauses LII to LXIV, wherein at least one of the first dielectric and the second dielectric comprise a ceramic material.
LXVI. The antenna assembly according to any one of clauses LII to LXV, wherein the patch antenna stack further comprises a spacer interposed between the first patch conductor and the second dielectric, wherein the spacer is configured to deform where the first feeding point extends beyond the first patch conductor such that the second dielectric is arranged parallel to the first patch conductor.
LXVII. The antenna assembly according to any one of clauses LII to LXVI, wherein the first frequency is from 1500 megahertz to 1650 megahertz.
LXVIII. The antenna assembly according to clause LXVII, wherein the first patch conductor exhibits a gain of at least 18 dB from 1500 megahertz to 1650 megahertz.
LXIX. The antenna assembly according to any one of clauses LII to LXVIII, wherein the second frequency is from 2250 megahertz to 2400 megahertz.
LXX. The antenna assembly according to clause LXIX, wherein the second patch conductor exhibits a gain of at least 34 dB from 2250 megahertz to 2400 megahertz.
LXXI. The antenna assembly according to any one of clauses LII to LXX, wherein the first direction is right-handed and the second direction is left-handed.
LXXII. The antenna assembly according to any one of clauses LII to LXXI, wherein the monopole radiating element is configured to transmit and/or receive radio frequency signals having a frequency of from 600 megahertz to 6 gigahertz.
LXXIII. The antenna assembly according to clause LXXII, wherein the monopole radiating element exhibits an average gain of −3 dB or greater from 600 megahertz to 6 gigahertz.
LXXIV. The antenna assembly according to any one of clauses LII to LXXIII, further comprising a housing defining a housing interior bounded by a bottom wall, a top wall parallel to and spaced from the bottom wall, and a plurality of side walls extending between the bottom wall and the top wall;
   wherein the antenna assembly is disposed within the housing interior such that the top surface of the PCB faces the top wall of the housing.
LXXV. The antenna assembly according to clause LXXIV, wherein the antenna assembly is arranged within the housing interior such that the second patch conductor is spaced from the top wall to define a gap therebetween.
LXXVI. The antenna assembly according to one of clauses LXXIV or LXXV, wherein the housing is configured to be coupled to a nonconductive pane of a vehicle.
LXXVII. The antenna assembly according to any one of clauses LXXIV to LXXVI, wherein the housing is configured to be arranged within an interior compartment of a vehicle.
LXXVIII. A window assembly for a vehicle, said window assembly comprising:
   a nonconductive pane; and
   an antenna assembly comprising:
      a PCB spaced from the nonconductive pane and including a top surface at least partially facing the nonconductive pane and a bottom surface opposite the top surface;
      a ground plane disposed on the top surface of the PCB;
      a patch antenna stack comprising:
         a first dielectric extending between a first dielectric surface operatively connected to the ground plane and a second dielectric surface opposite the first dielectric surface;
         a first patch conductor operatively connected to the second dielectric surface of the first dielectric, the first patch conductor configured to be energized to transmit and/or receive radio frequency signals having a first frequency and having a circular polarization in a first direction;
         a second dielectric extending between a third dielectric surface operatively connected to the first patch conductor and a fourth dielectric surface opposite the third dielectric surface; and
         a second patch conductor operatively connected to fourth dielectric surface of the second dielectric, the second patch conductor configured to be energized to transmit and/or receive radio frequency signals having a second frequency, higher than the first frequency, and having a circular polarization in a second direction opposite the first direction; and
      a monopole radiating element including a first portion extending perpendicularly from the ground plane toward the nonconductive pane, the monopole radiating element configured to be energized to transmit and/or receive radio frequency signals having a linear polarization.
LXXIX. The window assembly according to clause LXXVIII, wherein the ground plane has a width W in a lateral direction (X), and a length L in a longitudinal direction (Y) transverse to the lateral direction (X), and
   wherein the ground plane defines a first center plane bisecting the ground plane in the lateral direction (X) and a second center plane bisecting the ground plane in the longitudinal direction (Y).
LXXX. The window assembly according to clause LXXIX, wherein the width W and the length L are each independently at least λ₁/2.
LXXXI. The window assembly according to one of clauses LXXIX or LXXX, wherein the monopole radiating element further includes a second portion coupled to and extending from the first portion and spaced from the ground plane.
LXXXII. The window assembly according to clause LXXXI, wherein the second portion of the monopole radiating element is parallel to the ground plane.
LXXXIII. The window assembly according to any one of clauses LXXIX to LXXXII, wherein the first portion of the monopole radiating element is coplanar with the first center plane.
LXXXIV. The window assembly according to any one of clauses LXXIX to LXXXIII, wherein the monopole radiating element is arranged on a first lateral side of the second center plane, and the patch antenna stack is arranged on a second lateral side of the second center plane opposite the first lateral side.
LXXXV. The window assembly according to any one of clauses LXXIX to LXXXIV, wherein the patch antenna stack is arranged such that the first center plane bisects the patch antenna stack.
LXXXVI. The window assembly according to any one of clauses LXXIX to LXXXV, wherein the first dielectric defines a first longitudinal surface transverse to the ground plane, and a second longitudinal surface opposite the first longitudinal surface, and
   wherein the first longitudinal surface is coplanar with the second center plane.
LXXXVII. The window assembly according to any one of clauses LXXIX to LXXXVI, further comprising:
   a first feeding assembly operatively connected to the first patch conductor at a first feeding point and the second patch conductor at a second feeding point for energizing the first patch conductor and the second patch conductor to transmit and/or receive radio frequency signals; and
   a second feeding assembly operatively connected to the monopole radiating element at a third feeding point for energizing the monopole radiating element to transmit and/or receive radio frequency signals.
LXXXVIII. The window assembly according to clause LXXXVII, wherein the first feeding point is arranged on a first longitudinal side of the first center plane, and the second feeding point is arranged on a second longitudinal side of the first center plane opposite the first longitudinal side.
LXXXIX. The window assembly according to one of clauses LXXXVII or LXXXVIII, wherein the second feeding point is spaced from the third feeding point by at least λ₂/2.
XC. The window assembly according to any one of clauses LXXXVII to LXXXIX, wherein the first feeding assembly comprises a first feeding member extending through the ground plane and the first dielectric, wherein the first feeding member is coupled to the first patch conductor at the first feeding point to energize the first patch conductor to transmit and/or receive radio frequency signals having the first frequency and having circular polarization in the first direction.
XCI. The window assembly according to any one of clauses LXXXVII to XC, wherein the first feeding assembly comprises a second feeding member extending through the ground plane, the first dielectric, the first patch conductor, and the second dielectric, wherein the second feeding member is coupled to the second patch conductor at the second feeding point to energize the second patch conductor to transmit and/or receive radio frequency signals having the second frequency and having circular polarization in the second direction.
XCII. The window assembly according to any one of clauses LXXVIII to XCI, wherein at least one of the first dielectric and the second dielectric comprise a ceramic material.
XCIII. The window assembly according to any one of clauses LXXVIII to XCII, wherein the patch antenna stack further comprises a spacer interposed between the first patch conductor and the second dielectric, wherein the spacer is configured to deform where the first feeding point extends beyond the first patch conductor such that the second dielectric is arranged parallel to the first patch conductor.
XCIV. The window assembly according to any one of clauses LXXVIII to XCIII, wherein the first frequency is from 1500 megahertz to 1650 megahertz.
XCV. The window assembly according to clause XCIV, wherein the first patch conductor exhibits a gain of at least 18 dB from 1500 megahertz to 1650 megahertz.
XCVI. The window assembly according to any one of clauses LXXVIII to XCV, wherein the second frequency is from 2250 megahertz to 2400 megahertz.
XCVII. The window assembly according to clause XCVI, wherein the second patch conductor exhibits a gain of at least 34 dB from 2250 megahertz to 2400 megahertz.
XCVIII. The window assembly according to any one of clauses LXXVIII to XCVII, wherein the first direction is right-handed and the second direction is left-handed.
XCIX. The window assembly according to any one of clauses LXXVIII to XCVIII, wherein the monopole radiating element is configured to transmit and/or receive radio frequency signals having a frequency of from 600 megahertz to 6 gigahertz.
C. The window assembly according to clause XCIX, wherein the monopole radiating element exhibits an average gain of −3 dB or greater from 600 megahertz to 6 gigahertz.
CI. The window assembly according to any one of clauses LXXVIII to C, further comprising a housing defining a housing interior bounded by a bottom wall, a top wall parallel to and spaced from the bottom wall, and a plurality of side walls extending between the bottom wall and the top wall;
   wherein the antenna assembly is disposed within the housing such that the top surface of the PCB faces the top wall of the housing.
CII. The window assembly according to clause CI, wherein the antenna assembly is arranged within the housing interior such that the second patch conductor is spaced from the top wall to define a gap therebetween.
CIII. The window assembly according to one of clauses CI or CII, wherein the top wall of the housing is coupled to the nonconductive pane.
CIV. The window assembly according to one of clauses CI or CII, wherein the top wall of the housing is spaced from the nonconductive pane.
CV. The window assembly according to any one of clauses LXXVIII to CIV, wherein the ground plane is parallel to the nonconductive pane.
CVI. The window assembly according to any one of clauses LXXVIII to CV, wherein the ground plane is not parallel to the nonconductive pane.
CVII. The window assembly according to any one of clauses LXXVIII to CVI, wherein the nonconductive pane is one of a windshield, a side window, a rear window, and a roof glass.
CVIII. The window assembly according to any one of clauses LXXVIII to CVII, wherein the nonconductive pane is a laminated glazing comprising:
   an outer glass substrate having an outer surface (P1) and an opposing inner surface (P2);
   an inner glass substrate having an inner surface (P3) and an opposing outer surface (P4); and
   a polymeric interlayer disposed between the P2 surface of the outer glass substrate and the P3 surface of the inner glass substrate.
CIX. An antenna assembly for a vehicle, said antenna assembly comprising:
   a housing defining a housing interior bounded by a bottom wall, a top wall parallel to and spaced from the bottom wall, and a plurality of side walls extending between the bottom wall and the top wall;
   a PCB disposed within the housing interior and including a top surface at least partially facing the top wall of the housing and a bottom surface opposite the top surface;
   a ground plane disposed on the top surface of the PCB;
   a patch antenna stack comprising:
      a first dielectric extending between a first dielectric surface operatively connected to the ground plane and a second dielectric surface opposite the first dielectric surface;
      a first patch conductor operatively connected to the second dielectric surface of the first dielectric, the first patch conductor configured to be energized to transmit and/or receive radio frequency signals having a first frequency with a first wavelength λ₁ and having a circular polarization in a first direction;
      a second dielectric extending between a third dielectric surface operatively connected to the first patch conductor and a fourth dielectric surface opposite the third dielectric surface; and
      a second patch conductor operatively connected to fourth dielectric surface of the second dielectric, the second patch conductor configured to be energized to transmit and/or receive radio frequency signals having a second frequency with a second wavelength λ₂, higher than the first frequency, and having a circular polarization in a second direction opposite the first direction; and
   a dipole radiating element coupled to one or more of the side walls of the housing, the dipole radiating element configured to be energized to transmit and/or receive radio frequency signals having a linear polarization.
CX. The antenna assembly according to clause CIX, wherein the ground plane has a width W in a lateral direction (X), and a length L in a longitudinal direction (Y) transverse to the lateral direction (X), and
   wherein the ground plane defines a first center plane bisecting the ground plane in the lateral direction (X) and a second center plane bisecting the ground plane in the longitudinal direction (Y).
CXI. The antenna assembly according to clause CX, wherein the width W and the length L are each independently at least λ₁/2.
CXII. The antenna assembly according to one of clauses CX or CXI, further comprising a first feeding assembly operatively connected to the first patch conductor at a first feeding point and the second patch conductor at a second feeding point for energizing the first patch conductor and the second patch conductor to transmit and/or receive radio frequency signals.
CXIII. The antenna assembly according to clause CXII, wherein the first feeding point is arranged on a first longitudinal side of the first center plane, and the second feeding point is arranged on a second longitudinal side of the first center plane opposite the first longitudinal side.
CXIV. The antenna assembly according to one of clauses CXII or CXIII, wherein the first feeding assembly comprises a first feeding member extending through the ground plane and the first dielectric, wherein the first feeding member is coupled to the first patch conductor at the first feeding point to energize the first patch conductor to transmit and/or receive radio frequency signals having the first frequency and having circular polarization in the first direction.
CXV. The antenna assembly according to any one of clauses CXII to CXIV, wherein the first feeding assembly comprises a second feeding member extending through the ground plane, the first dielectric, the first patch conductor, and the second dielectric, wherein the second feeding member coupled to the second patch conductor at the second feeding point to energize the second patch conductor to transmit and/or receive radio frequency signals having the second frequency and having circular polarization in the second direction.
CXVI. The antenna assembly according to any one of clauses CIX to CXV, wherein at least one of the first dielectric and the second dielectric comprise a ceramic material.
CXVII. The antenna assembly according to any one of clauses CIX to CXVI, wherein the patch antenna stack further comprises a spacer interposed between the first patch conductor and the second dielectric, wherein the spacer is configured to deform where the first feeding point extends beyond the first patch conductor such that the second dielectric is arranged parallel to the first patch conductor.
CXVIII. The antenna assembly according to any one of clauses CIX to CXVII, wherein the first frequency is from 1500 megahertz to 1650 megahertz.
CXIX. The antenna assembly according to clause CXVIII, wherein the first patch conductor exhibits a gain of at least 18 dB from 1500 megahertz to 1650 megahertz.
CXX. The antenna assembly according to any one of clauses CIX to CXIX, wherein the second frequency is from 2250 megahertz to 2400 megahertz.
CXXI. The antenna assembly according to clause CXX, wherein the second patch conductor exhibits a gain of at least 34 dB from 2250 megahertz to 2400 megahertz.
CXXII. The antenna assembly according to any one of clauses CIX to CXXI, wherein the first direction is right-handed and the second direction is left-handed.
CXXIII. The antenna assembly according to any one of clauses CIX to CXXII, wherein the dipole radiating element is configured to transmit and/or receive radio frequency signals having a frequency of from 600 megahertz to 6 gigahertz.
CXXIV. The antenna assembly according to clause CXXIII, wherein the dipole radiating element exhibits an average gain of −3 dB or greater from 600 megahertz to 6 gigahertz.
CXXV. The antenna assembly according to any one of clauses CIX to CXXIV, wherein the housing is configured to be coupled to a nonconductive pane of a vehicle.
CXXVI. The antenna assembly according to any one of clauses CIX to CXXV, wherein the housing is configured to be arranged within an interior compartment of a vehicle.

What is claimed is:

1. An antenna assembly for a vehicle, said antenna assembly comprising:
a PCB including a top surface and a bottom surface opposite the top surface;
a ground plane disposed on the top surface of the PCB;
a patch antenna stack comprising:
a first dielectric extending between a first dielectric surface operatively connected to the ground plane and a second dielectric surface opposite the first dielectric surface;
a first patch conductor operatively connected to the second dielectric surface of the first dielectric, the first patch conductor configured to be energized to transmit and/or receive radio frequency signals having a first frequency with a first wavelength λ₁ and having circular polarization in a first direction;
a second dielectric extending between a third dielectric surface operatively connected to the first patch conductor and a fourth dielectric surface opposite the third dielectric surface; and
a second patch conductor operatively connected to fourth dielectric surface of the second dielectric, the second patch conductor configured to be energized to transmit and/or receive radio frequency signals having a second frequency with a second wavelength λ₂, higher than the first frequency, and having circular polarization in a second direction opposite the first direction;
a monopole radiating element including a first portion extending perpendicularly from the ground plane, the monopole radiating element configured to be energized to transmit and/or receive radio frequency signals having linear polarization;
a first feeding assembly operatively connected to the first patch conductor at a first feeding point and the second patch conductor at a second feeding point for energizing the first patch conductor and the second patch conductor to transmit and/or receive radio frequency signals; and
a second feeding assembly operatively connected to the monopole radiating element at a third feeding point for energizing the monopole radiating element to transmit and/or receive radio frequency signals;
wherein the second feeding point is spaced from the third feeding point by at least λ₂/2.

2. The antenna assembly according to claim 1, wherein the ground plane has a width W in a lateral direction (X), and a length L in a longitudinal direction (Y) transverse to the lateral direction (X),
wherein the ground plane defines a first center plane bisecting the ground plane in the lateral direction (X) and a second center plane bisecting the ground plane in the longitudinal direction (Y), and
wherein the monopole radiating element is arranged on a first lateral side of the second center plane, and the patch antenna stack is arranged on a second lateral side of the second center plane opposite the first lateral side.

3. The antenna assembly according to claim 2, wherein the first feeding point is arranged on a first longitudinal side of the first center plane, and the second feeding point is arranged on a second longitudinal side of the first center plane opposite the first longitudinal side.

4. The antenna assembly according to claim 1, wherein the first feeding assembly comprises at least one of:
a first feeding member extending through the ground plane and the first dielectric, wherein the first feeding member is coupled to the first patch conductor at the first feeding point to energize the first patch conductor to transmit and/or receive radio frequency signals having the first frequency and having circular polarization in the first direction; and
a second feeding member extending through the ground plane, the first dielectric, the first patch conductor, and the second dielectric, wherein the second feeding member is coupled to the second patch conductor at the second feeding point to energize the second patch conductor to transmit and/or receive radio frequency signals having the second frequency and having circular polarization in the second direction.

5. The antenna assembly according to claim 1, wherein the monopole radiating element further includes a second portion coupled to and extending from the first portion and spaced from the ground plane.

6. An antenna assembly for a vehicle, said antenna assembly comprising:
a PCB including a top surface and a bottom surface opposite the top surface;
a ground plane disposed on the top surface of the PCB and having a width W and a length L;
a patch antenna stack comprising:
a first dielectric extending between a first dielectric surface operatively connected to the ground plane and a second dielectric surface opposite the first dielectric surface;
a first patch conductor operatively connected to the second dielectric surface of the first dielectric, the first patch conductor configured to be energized to transmit and/or receive radio frequency signals having a first frequency with a first wavelength λ₁ and having a circular polarization in a first direction;
a second dielectric extending between a third dielectric surface operatively connected to the first patch conductor and a fourth dielectric surface opposite the third dielectric surface; and
a second patch conductor operatively connected to fourth dielectric surface of the second dielectric, the second patch conductor configured to be energized to transmit and/or receive radio frequency signals having a second frequency with a second wavelength λ₂, higher than the first frequency, and having a circular polarization in a second direction opposite the first direction; and
a monopole radiating element including a first portion extending perpendicularly from the ground plane, the monopole radiating element configured to be energized to transmit and/or receive radio frequency signals having a linear polarization;
wherein the width W and the length L are each independently at least λ₁/2.

7. The antenna assembly according to claim 6, wherein the width W of the ground plane extends in a lateral direction (X), and the length L of the ground plane extends in a longitudinal direction (Y) transverse to the lateral direction (X), and
wherein the ground plane defines a first center plane bisecting the ground plane in the lateral direction (X) and a second center plane bisecting the ground plane in the longitudinal direction (Y), and
wherein the patch antenna stack is arranged such that the first center plane bisects the patch antenna stack.

8. The antenna assembly according to claim 6, further comprising:
a first feeding assembly operatively connected to the first patch conductor at a first feeding point and the second patch conductor at a second feeding point for energizing the first patch conductor and the second patch conductor to transmit and/or receive radio frequency signals; and
a second feeding assembly operatively connected to the monopole radiating element at a third feeding point for energizing the monopole radiating element to transmit and/or receive radio frequency signals.

9. The antenna assembly according to claim 8, wherein the second feeding point is spaced from the third feeding point by at least λ₂/2.

10. The antenna assembly according to claim 6, wherein the monopole radiating element further includes a second portion coupled to and extending from the first portion and spaced from the ground plane.

11. A window assembly for a vehicle, said window assembly comprising:
a nonconductive pane; and
an antenna assembly comprising:
a PCB spaced from the nonconductive pane and including a top surface at least partially facing the nonconductive pane and a bottom surface opposite the top surface;
a ground plane disposed on the top surface of the PCB;
a patch antenna stack comprising:
a first dielectric extending between a first dielectric surface operatively connected to the ground plane and a second dielectric surface opposite the first dielectric surface;
a first patch conductor operatively connected to the second dielectric surface of the first dielectric, the first patch conductor configured to be energized to transmit and/or receive radio frequency signals having a first frequency and having a circular polarization in a first direction;
a second dielectric extending between a third dielectric surface operatively connected to the first patch conductor and a fourth dielectric surface opposite the third dielectric surface; and
a second patch conductor operatively connected to fourth dielectric surface of the second dielectric, the second patch conductor configured to be energized to transmit and/or receive radio frequency signals having a second frequency, higher than the first frequency, and having a circular polarization in a second direction opposite the first direction; and
a monopole radiating element including a first portion extending perpendicularly from the ground plane toward the nonconductive pane, the monopole radiating element configured to be energized to transmit and/or receive radio frequency signals having a linear polarization.

12. The window assembly according to claim 11, wherein the ground plane has a width W in a lateral direction (X), and a length L in a longitudinal direction (Y) transverse to the lateral direction (X), and
wherein the ground plane defines a first center plane bisecting the ground plane in the lateral direction (X) and a second center plane bisecting the ground plane in the longitudinal direction (Y).

13. The window assembly according to claim 12, wherein the width W and the length L are each independently at least λ₁/2.

14. The window assembly according to claim 12, wherein the monopole radiating element is arranged on a first lateral side of the second center plane, and the patch antenna stack is arranged on a second lateral side of the second center plane opposite the first lateral side.

15. The window assembly according to claim 12, wherein the patch antenna stack is arranged such that the first center plane bisects the patch antenna stack.

16. The window assembly according to claim 11, further comprising:
a first feeding assembly operatively connected to the first patch conductor at a first feeding point and the second patch conductor at a second feeding point for energizing the first patch conductor and the second patch conductor to transmit and/or receive radio frequency signals; and
a second feeding assembly operatively connected to the monopole radiating element at a third feeding point for energizing the monopole radiating element to transmit and/or receive radio frequency signals.

17. The window assembly according to claim 16, wherein the second feeding point is spaced from the third feeding point by at least λ₂/2.

18. The window assembly according to claim 11, wherein the monopole radiating element further includes a second portion coupled to and extending from the first portion and spaced from the ground plane.

19. The window assembly according to claim 11, further comprising a housing defining a housing interior bounded by a bottom wall, a top wall parallel to and spaced from the bottom wall, and a plurality of side walls extending between the bottom wall and the top wall;
wherein the antenna assembly is disposed within the housing such that the top surface of the PCB faces the top wall of the housing.

20. The window assembly according to claim 19, wherein the antenna assembly is arranged within the housing interior such that the second patch conductor is spaced from the top wall to define a gap therebetween.

21. The window assembly according to claim 19, wherein the top wall of the housing is coupled to the nonconductive pane.

22. The window assembly according to claim 19, wherein the top wall of the housing is spaced from the nonconductive pane.
